(19) United States
(12) Patent Application Publication
(10) Pub. No.: US 2013/0170029 A1
(43) Pub. Date: Jul. 4, 2013

(54) LENS UNIT

(71) Applicants: Tetsuya Morita, Osaka (JP); Akio Konishi, Hyogo (JP); Masakazu Ito, Osaka (JP)

(72) Inventors: Tetsuya Morita, Osaka (JP); Akio Konishi, Hyogo (JP); Masakazu Ito, Osaka (JP)

(73) Assignee: PANASONIC CORPORATION, Osaka (JP)

(21) Appl. No.: 13/812,036

(22) PCT Filed: Aug. 5, 2011
(86) PCT No.: PCT/JP11/04463

§ 371 Date: Jan. 24, 2013

(30) Foreign Application Priority Data
Aug. 6, 2010 (JP) 2010-177937

(51) Int. Cl. G02B 27/22

(52) U.S. Cl. CPC G02B 27/22
USPC 359/464

(57) ABSTRACT

A 3D adapter comprises a left-eye optical system (OL), a right-eye optical system (OR), an adjusting mechanism, and an exterior casing. The exterior casing accommodates the left-eye optical system (OL) and the right-eye optical system (OR), and can be mounted to a video camera. The adjusting mechanism is provided to adjust the position of a left-eye optical image QL1 and/or a right-eye optical image QR1 with respect to a CMOS image sensor from the outside of the exterior casing.

### TECHNICAL FIELD

The technology disclosed herein relates to a lens unit.

### BACKGROUND ART

Digital cameras such as digital still cameras and digital video cameras are known as imaging devices. A digital camera has a CCD (charge coupled device) image sensor, a CMOS (complementary metal oxide semiconductor) image sensor, or another such imaging element. The imaging element converts an optical image formed by an optical system into an image signal. This allows image data about a subject to be acquired.

### CITATION LIST

### Patent Literature

Patent Literature 1: Japanese Laid-Open Patent Application H7-274214

### SUMMARY

The development of imaging devices for capturing stereo images has been underway in recent years. A “stereo image” is an image used for three-dimensional display, and includes a left-eye image and a right-eye image having parallax. An imaging device of this type comprises a lens unit having a pair of left and right optical systems (see Patent Literature 1, for example).

### Technical Problem

To display a three-dimensional image properly, the left-eye image and right-eye image must be formed at the proper positions with respect to the imaging element. However, it is conceivable that individual differences between products may cause the positions of the left-eye image and right-eye image to deviate from the design positions, which can make it more difficult to obtain the proper stereo image.

It is a first object of the present invention to provide a lens unit with which the effect that individual differences between products have on a stereo image can be reduced relatively simply.

Also, to display a three-dimensional image properly, it is preferable to reduce relative offset in the up and down direction between the left-eye image and right-eye image in the stereo image (hereinafter also referred to as vertical relative offset). And to display a three-dimensional image properly, it is also preferable to set the convergence angle formed by the pair of left and right optical systems to the proper value. Furthermore, to display a three-dimensional image properly, it is preferable to match the focal states of the left-eye image and right-eye image formed by the pair of left and right optical systems. And, to display a three-dimensional image properly, it is preferable to set the capture range in the vertical or horizontal direction of the stereo image to a specific design position.

However, individual differences between products may cause the vertical relative offset to exceed the allowable range, or cause the convergence angle to deviate from the design value. Also, individual differences between products may cause the focal state of the left-eye image and right-eye image to deviate, or cause the capture range in the vertical or horizontal direction of the stereo image to deviate from a specific design position.

Meanwhile, a lens unit needs to be made more compact, but so far there has been no proposal for a compact, three-dimensional imaging-use lens unit that takes into account the above-mentioned effect of individual differences between products.

It is a second object of the present invention to provide a lens unit which is more compact and with which the effect that individual differences between products have on a stereo image can be reduced.

### Solution to Problem

The lens unit pertaining to a first aspect guides light to the imaging element of an imaging device. This lens unit comprises a first optical system, a second optical system, a support unit, and an adjusting unit. The first optical system is used to form a first optical image seen from a first viewpoint, and has a first optical axis. The second optical system is used to form a second optical image seen from a second viewpoint that is different from the first viewpoint, and has a second optical axis. The support unit accommodates the first and second optical systems and can be mounted to the imaging device. The adjusting unit adjusts the position of the first and/or second optical image with respect to the imaging element, from outside the support unit.

With this lens unit, since the adjusting unit can be used to adjust the position of the first and/or second optical image with respect to the imaging element, from outside the support unit, the effect that individual differences between products have on a stereo image can be reduced relatively simply.

The lens unit pertaining to a second aspect comprises a first optical system, a second optical system, and a support unit. The first optical system is used to form a first optical image seen from a first viewpoint, and has a first optical axis. The second optical system is used to form a second optical image seen from a second viewpoint that is different from the first viewpoint, and has a second optical axis. The support unit accommodates the first and second optical systems. The first optical system has a relative offset adjusting optical system disposed movably substantially in a first direction with respect to the support unit. The first direction is perpendicular to a reference plane that is substantially parallel to the first and second optical axes in a state in which the first and second optical axes are intersecting.

With this lens unit, since the first optical system has a relative offset adjusting optical system, the position of the first optical image in the vertical direction can be adjusted by moving the relative offset adjusting optical system in a first direction with respect to the support unit. This allows the vertical relative offset of the first and second optical images to be reduced, and also allows the effect that individual differences between products have on a stereo image to be reduced.

Also, since the first and second optical systems are accommodated in the support unit, the lens unit can be made more compact.

The above configuration allows a lens unit to be provided with which a more compact size can be obtained and the effect that individual differences between products have on stereo images can be reduced.

The lens unit pertaining to a third aspect comprises a first optical system, a second optical system, and a support unit. The first optical system is used to form a first optical image seen from a first viewpoint, and has a first optical axis. The second optical system is used to form a second optical image seen from a second viewpoint that is different from the first viewpoint, and has a second optical axis. The support unit accommodates the first and second optical systems. The second optical system has a convergence angle adjusting optical system disposed movably substantially in a first adjustment direction with respect to the support unit. The first adjustment direction is substantially perpendicular to the second optical axis and parallel to a reference plane that is substantially parallel to the first and second optical axes in a state in which the first and second optical axes are intersecting.

With this lens unit, since the second optical system has a convergence angle adjusting optical system, the convergence angle formed by the first and second optical axes can be adjusted by moving the convergence angle adjusting optical system in a first adjustment direction with respect to the support unit, and the effect that individual differences between products have on stereo images can be reduced.

Also, since the first and second optical systems are accommodated in the support unit, the lens unit can be easily made more compact.

The above configuration allows a lens unit to be provided with which a more compact size can be obtained and the effect that individual differences between products have on stereo images can be reduced.

The lens unit pertaining to a fourth aspect comprises a first optical system, a second optical system, and a support unit. The first optical system is used to form a first optical image seen from a first viewpoint, and has a first optical axis. The second optical system is used to form a second optical image seen from a second viewpoint that is different from the first viewpoint, and has a second optical axis. The support unit accommodates the first and second optical systems. The second optical system has a focus adjusting optical system disposed movably with respect to the support unit in a focus adjustment direction that is substantially parallel to the second optical axis.

With this lens unit, since the second optical system has a focus adjusting optical system, the focal state of the second optical image can be matched to the focal state of the first optical image by moving the focus adjusting optical system along the second optical axis, and this allows the effect that individual differences between products have on stereo images to be reduced.

Also, since the first and second optical systems are accommodated in the support unit, the lens unit can be easily made more compact.

The above configuration allows a lens unit to be provided with which a more compact size can be obtained and the effect that individual differences between products have on stereo images can be reduced.

The lens unit pertaining to a fifth aspect comprises a housing, a first optical system, a second optical system, and a main body frame. The first optical system is used to form a first optical image seen from a first viewpoint, and has a first optical axis. The first optical system is disposed inside the housing. The second optical system is used to form a second optical image seen from a second viewpoint that is different from the first viewpoint, and has a second optical axis. The second optical system is disposed inside the housing. The main body frame supports the first optical system and the second optical system and is disposed inside the housing and movably substantially in a first direction with respect to the housing. The first direction is perpendicular to a reference plane that is substantially parallel to the first and second optical axes.

With this lens unit, since the main body frame that supports the first and second optical systems is disposed movably substantially in a first direction with respect to the housing, the positions of the first and second optical images in the vertical direction with respect to the imaging element can be adjusted by moving the main body frame in the first direction with respect to the housing, which allows the capture range of stereo images in the vertical direction to be adjusted to a specific design position.

Also, since the first and second optical systems are disposed inside the housing, the lens unit can be easily made more compact.

The above configuration allows a lens unit to be provided with which a more compact size can be obtained and the effect that individual differences between products have on stereo images can be reduced.

This lens unit comprises a housing, a first optical system, a second optical system, and a main body frame. The first optical system is used to form a first optical image seen from a first viewpoint, and has a first optical axis. The first optical system is disposed inside the housing. The second optical system is used to form a second optical image seen from a second viewpoint that is different from the first viewpoint, and has a second optical axis. The second optical system is disposed inside the housing. The main body frame supports the first optical system and the second optical system and is disposed inside the housing and movably substantially in a first adjustment direction with respect to the housing. The first adjustment direction is substantially perpendicular to the second optical axis and parallel to a reference plane that is substantially parallel to the first and second optical axes in a state in which the first and second optical axes are intersecting.

With this lens unit, since the main body frame that supports the first and second optical systems is disposed movably in substantially the first adjustment direction with respect to the housing, the positions of the first and second optical images in the horizontal direction with respect to the imaging element can be adjusted by moving the main body frame in the first adjustment direction with respect to the housing, which allows the capture range of stereo images in the horizontal direction to be adjusted to a specific design position.

Also, since the first and second optical systems are disposed inside the housing, the lens unit can be easily made more compact.

The above configuration allows a lens unit to be provided with which a more compact size can be obtained and the effect that individual differences between products have on stereo images can be reduced.

### BRIEF DESCRIPTION OF DRAWINGS

FIG. 1 is an oblique view of a video camera unit;

FIG. 2 is an exploded oblique view of the video camera unit;

FIG. 3 is a diagram of the configuration of the optical system of the video camera unit;

FIG. 4 is a simplified diagram of the configuration of a video camera;

FIG. 5 is a block diagram of a video camera;

FIG. 6 is a diagram illustrating an effective image range;

FIG. 7 is a diagram illustrating a convergence angle and a stereo base;

FIG. 8 is an oblique view of a 3D adapter;

FIG. 9 is an oblique view of the 3D adapter;

FIG. 10 is a detail exploded oblique view of the 3D adapter;

FIG. 11 is an exploded oblique view of an upper case and a threaded ring unit 17;

FIG. 12 is an exploded oblique view of the 3D adapter;

FIG. 13 is an exploded oblique view of the 3D adapter;

FIG. 14 is an exploded oblique view of the 3D adapter;

FIG. 15 is an exploded oblique view of the 3D adapter;

FIG. 16 is an exploded oblique view of the 3D adapter;

FIG. 17 is an exploded oblique view of the 3D adapter and a cap;

FIG. 18 is a diagram illustrating the polarization angle of first and second prism groups;

FIG. 19 is an oblique view of the 3D adapter (when the exterior casing has been removed);

FIG. 20 is an exploded oblique view of the 3D adapter (when the exterior casing has been removed);

FIG. 21 is an oblique view of the 3D adapter (when the exterior casing and the front panel have been removed);

FIG. 22 is a front view of the 3D adapter (when the exterior casing and the front panel have been removed);

FIG. 23 is an oblique view of a main body frame;

FIG. 24 is an exploded oblique view of the main body frame;

FIG. 25 is an exploded oblique view of the main body frame;

FIG. 26 is an exploded oblique view of the area around an intermediate lens frame;

FIG. 27 is an exploded oblique view of the area around a prism support frame;

FIG. 28 is an exploded oblique view of the area around a first adjustment frame;

FIG. 29 is an oblique view of the first adjustment frame;

FIG. 30 is a configuration diagram of a first front support hole and a first rear support hole;

FIG. 31 is a front view of a first restricting mechanism;

FIG. 32 is an exploded oblique view of the area around a second adjustment frame;

FIG. 33 is an oblique view of the second adjustment frame;

FIG. 34 is a bottom view of the main body frame;

FIG. 35 is a configuration diagram of a second front support hole and a second rear support hole;

FIG. 36 is a front view of a second restricting mechanism;

FIG. 37 is an exploded oblique view of a third adjusting mechanism;

FIG. 38 is an exploded oblique view of the third adjusting mechanism;

FIG. 39 is an oblique view of the third adjusting mechanism (as seen from the bottom);

FIG. 40 is a bottom view of the third adjusting mechanism;

FIG. 41 is an exploded oblique view of a manipulation mechanism and its surrounding area;

FIG. 42 is a diagram illustrating an effective image region;

FIG. 43 is a diagram illustrating the effective image region;

FIG. 44 is a diagram illustrating the effective image region;

FIG. 45 is a configuration diagram of a left-eye optical system;

FIG. 46 is a configuration diagram of a right-eye optical system;

FIG. 47 is a configuration diagram of a left-eye optical image and a right-eye optical image;

FIG. 48 is a diagram illustrating the left- and right-eye optical images during vertical relative offset adjustment;

FIG. 49 is a flowchart;

FIG. 50 is a flowchart;

FIG. 51 is a diagram illustrating a method for supporting first and second rotary shafts;

FIG. 52 is a plan view of a light blocking sheet (another embodiment);

FIG. 53 is a diagram illustrating the left- and right-eye optical images during vertical relative offset adjustment (another embodiment);

FIG. 54 is a diagram corresponding to FIG. 53 during normal imaging (another embodiment);

FIG. 55A is an example of the configuration for adjusting vertical relative offset (another embodiment), and FIG. 55B is another example of the configuration for adjusting vertical relative offset (another embodiment); and

FIG. 56 is an example of the configuration for adjusting the convergence angle (another embodiment).

### DESCRIPTION OF PREFERRED EMBODIMENTS

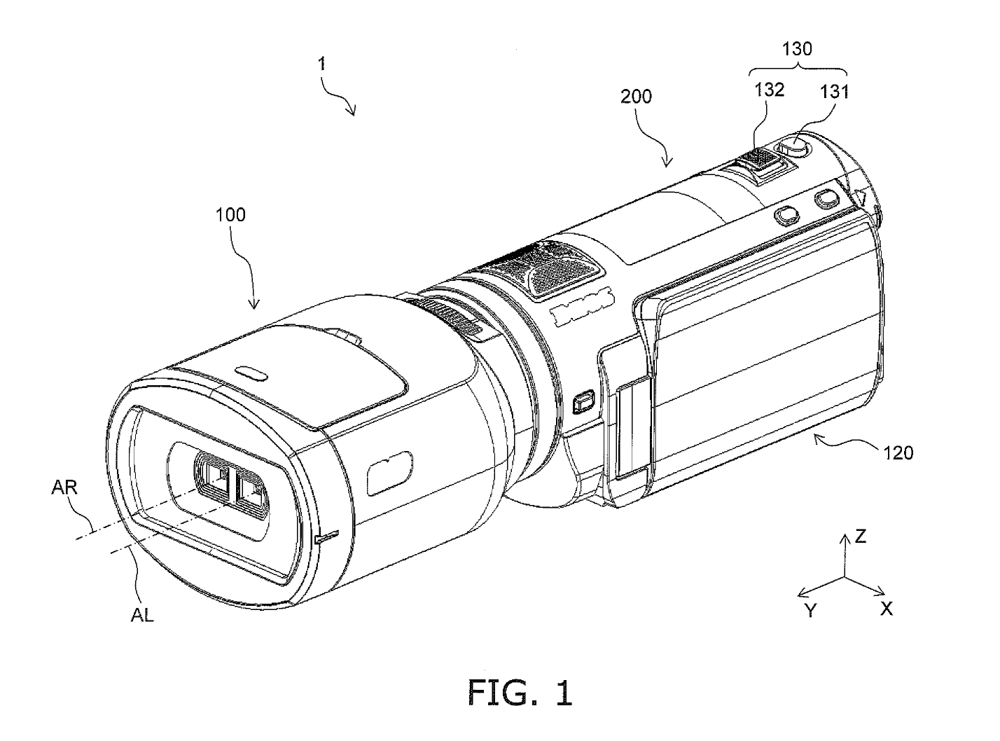

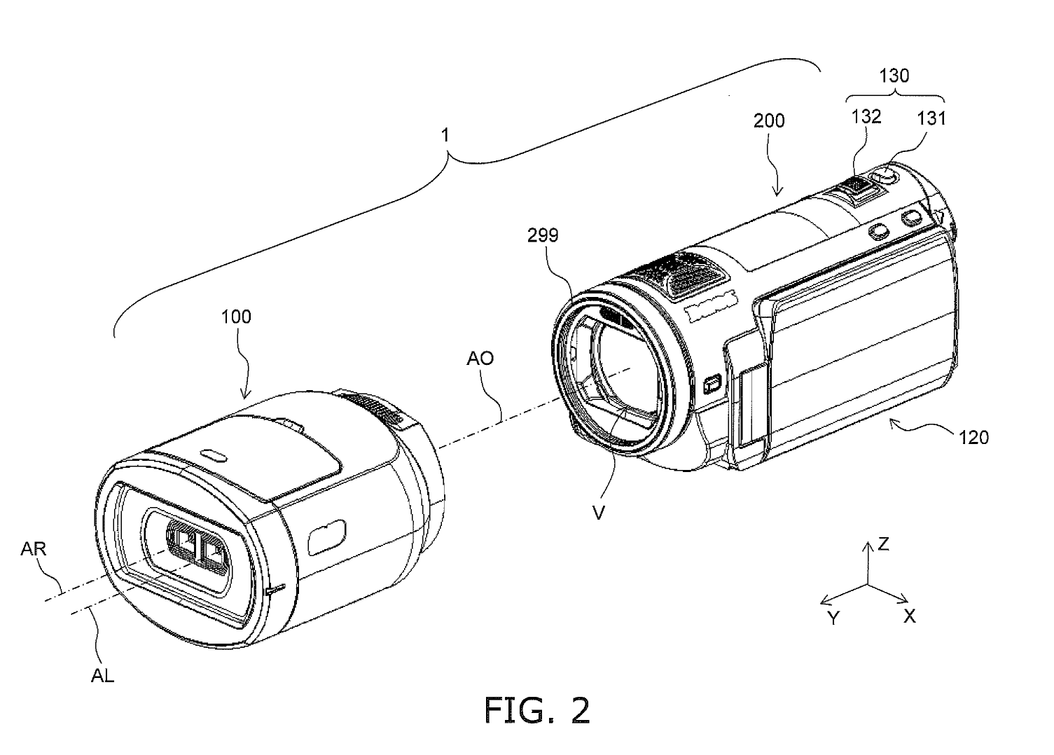

Overview of Video Camera Unit As shown in FIG. 1, a video camera unit 1 comprises a video camera 200 (an example of an imaging device) and a 3D adapter 100 (an example of a lens unit) that is mounted to the video camera 200. As shown in FIG. 2, the 3D adapter 100 is designed so that it can be mounted to and removed from the video camera 200. The video camera 200 has a uniaxial optical system V having an optical axis A0. Meanwhile, the 3D adapter 100 has a biaxial optical system having a left-eye optical axis AL (an example of a first optical axis or second optical axis) and a right-eye optical axis AR (an example of a first optical axis or second optical axis). When two-dimensional imaging is performed, it is performed with the video camera 200 alone, but when three-dimensional imaging is performed, it is performed by mounting the 3D adapter 100 to the video camera 200. In other words, the video camera 200 is compatible with both two-dimensional imaging and three-dimensional imaging.

For the purposes of this description, the subject side of the video camera unit 1 will be referred to as the front, the opposite side of the video camera unit 1 from the subject as the rear, the vertically upper side in the normal orientation of the video camera unit 1 (hereinafter also referred to as landscape orientation) as the top, and the vertically lower side as the bottom. The right and left sides when facing the subject in the normal orientation of the video camera unit 1 will be referred to as left and right.

In the following description, a three-dimensional perpendicular coordinate system is set for the 3D adapter 100 and the video camera 200. In the following description, the X axis direction is a direction parallel to the X axis, the Y axis direction is a direction parallel to the Y axis, and the Z axis direction is a direction parallel to the Z axis. As shown in FIG. 2, the Y axis is set to be parallel to the optical axis A0, so the left-eye optical axis AL and the right-eye optical axis AR are substantially parallel to the Y axis. Also, if we use as a reference plane an imaginary plane that is substantially parallel to the left-eye optical axis AL and the right-eye optical axis AR in a state in which the left-eye optical axis AL and the right-eye optical axis AR are intersecting, then the Z axis direction is perpendicular to the reference plane.

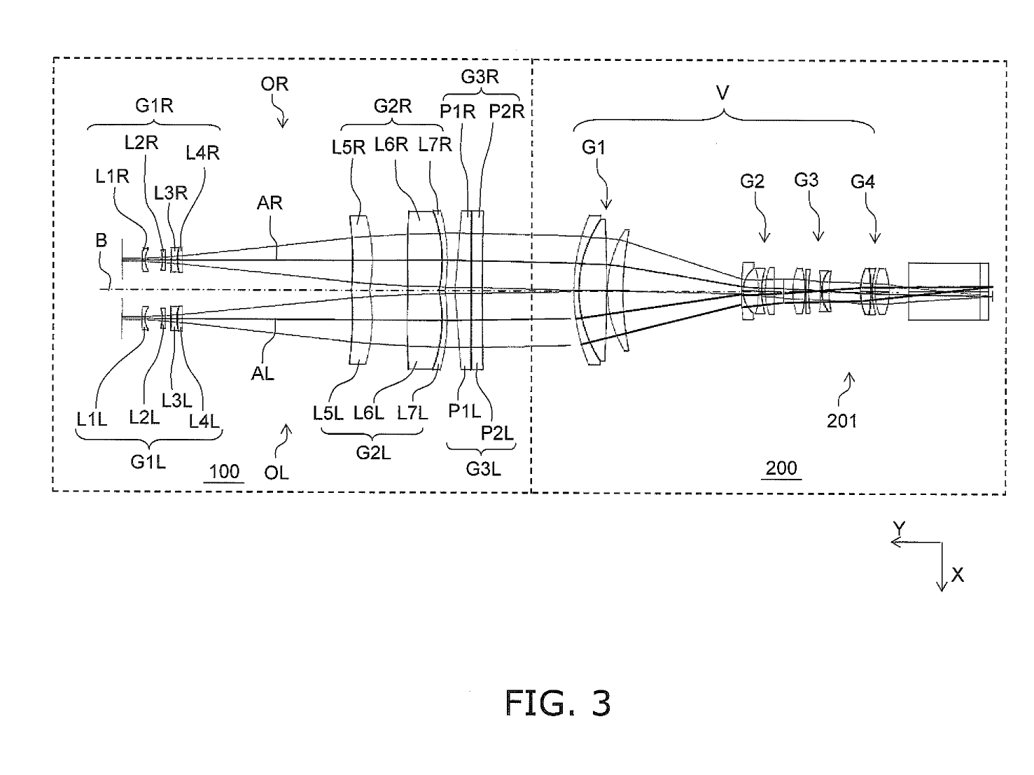

Furthermore, as shown in FIG. 3, in the following description, an imaginary plane that includes the Z axis and the optical axis A0 of the video camera 200 shall be termed the intermediate reference face B. The intermediate reference face B is disposed between a left-eye optical system OL and a right-eye optical system OR, and is defined as the center of the left-eye optical system OL and the right-eye optical system OR. The intermediate reference face B is disposed substantially parallel to the left-eye optical axis AL and the right-eye optical axis AR. The intermediate reference face B is perpendicular to the X axis direction. In other words, the left-eye optical system OL and the right-eye optical system OR are disposed at positions that are substantially in left and right symmetry with respect to the intermediate reference face B. Also, the intermediate reference face B is perpendicular to the above-mentioned reference plane. The reference plane can also be called an imaginary plane that is parallel to the paper plane in FIG. 3.

The Z axis direction is an example of a first direction and a second adjustment direction that are substantially perpendicular to the reference plane. The X axis direction is an example of a second direction and a first adjustment direction that are substantially perpendicular to the Z axis direction (first direction) and the right-eye optical axis AR. The Y axis direction is an example of a third adjustment direction. The third adjustment direction is substantially parallel to the Y axis direction. The terms “substantially perpendicular” and “substantially parallel” here mean that dimensional error, deviation, or the like corresponding to the convergence angle is permitted.

### Configuration of Video Camera

As shown in FIGS. 1 to 4, the video camera 200 has a video lens unit 201 and a video camera body 202.

### 1: Configuration of Video Lens Unit 201

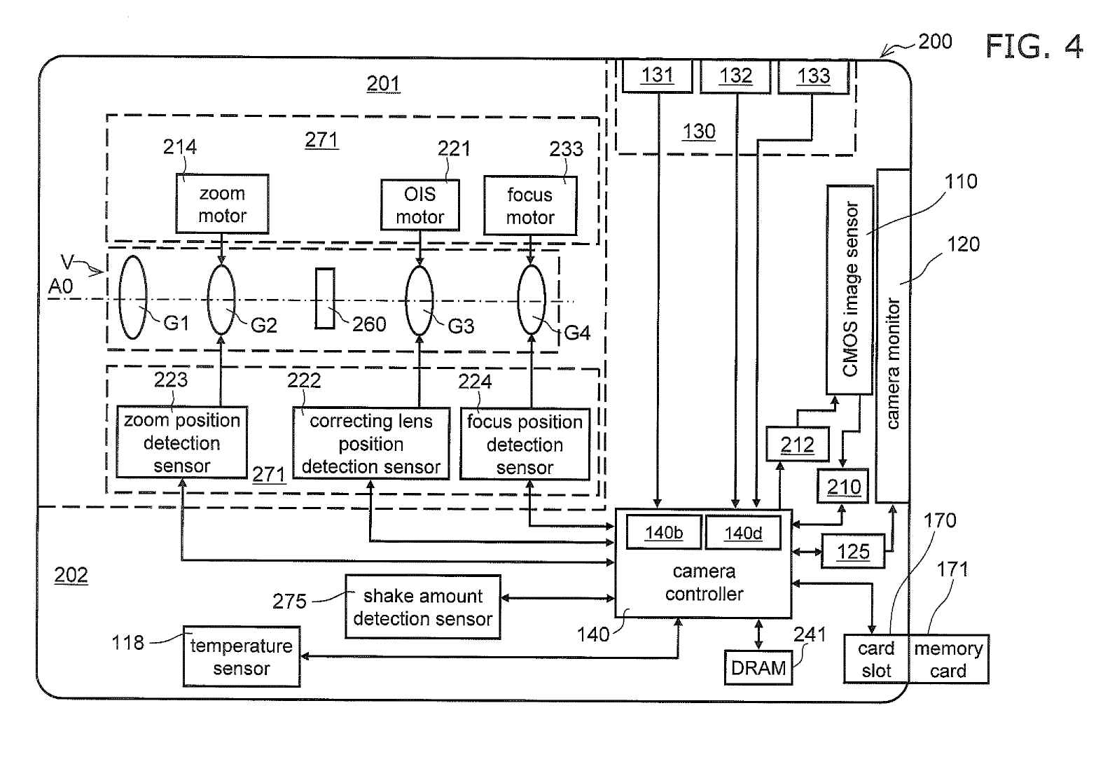

As shown in FIG. 4, the video lens unit 201 is provided to form an optical image of a subject, and has the optical system V and a drive unit 271.

(1) Optical System V

As shown in FIG. 3, the optical system V is a uniaxial optical system having the optical axis A0, and has a first lens group G1, a second lens group G2, a third lens group G3, and a fourth lens group G4.

The first lens group G1 is disposed in the optical system V at a position closest to the subject. The second lens group G2 (an example of a zoom adjusting lens group) is a lens group used for zoom adjustment, and is provided movably alone the optical axis A0. The third lens group G3 is a lens group used for correcting camera shake. The fourth lens group G4 (an example of a focus lens group) is a lens group used for focal adjustment, and is provided movably along the optical axis A0.

(2) Drive Unit 271

As shown in FIG. 4, the drive unit 271 is provided in order to adjust the state of the optical system V, and has a zoom motor 214, an OIS motor 221, a correction lens position detecting sensor 222, a zoom position detecting sensor 223, a focus position detecting sensor 224, and a focus motor 233.

The zoom motor 214 (an example of a zoom driver) drives the second lens group G2 in a direction parallel to the optical axis A0. The focal distance of the optical system V can be adjusted by moving the second lens group G2 in a direction parallel to the optical axis A0. The zoom motor 214 is controlled by a camera controller 140. In this embodiment, the zoom motor 214 is a stepping motor, but may instead be a DC motor, a servo motor, an ultrasonic motor, or another such actuator.

The OIS motor 221 drives the third lens group G3. The correction lens position detecting sensor 222 detects the position of a correction lens included in the third lens group G3.

The focus motor 233 (an example of a focus driver) drives the fourth lens group G4 in a direction parallel to the optical axis A0. The imaging distance (the distance from the video camera 200 to a subject that is in focus) can be adjusted by moving the fourth lens group G4 in a direction parallel to the optical axis A0. The focus motor 233 is controlled by a lens controller 240. In this embodiment, the focus motor 233 is a stepping motor, but may instead be a DC motor, a servo motor, an ultrasonic motor, or another such actuator.

### 2: Configuration of Video Camera Body 202

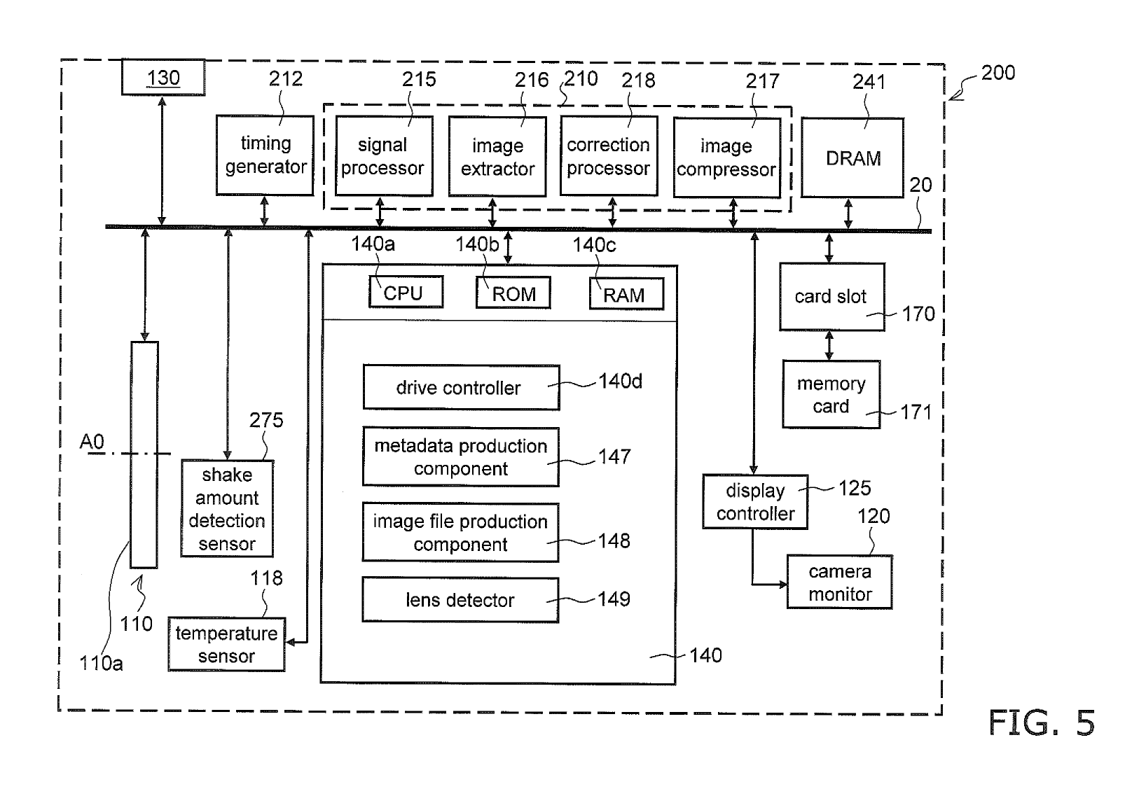

As shown in FIG. 4, the video camera body 202 comprises a CMOS image sensor 110, a camera monitor 120, a display controller 125, a manipulation component 130, a card slot 170, a DRAM 241, an image processor 210, a temperature sensor 118, a shake amount detection sensor 275, and the camera controller 140. As shown in FIG. 5, these components are connected to a bus 20, allowing data to be exchanged between them via the bus 20.

(1) CMOS Image Sensor 110

As shown in FIG. 4, the CMOS image sensor 110 (an example of an imaging element) converts an optical image of a subject (hereinafter also referred to as a subject image) formed by the video lens unit 201 into an image signal. The CMOS image sensor 110 outputs an image signal on the basis of a timing signal produced by a timing generator 112. The image signal produced by the CMOS image sensor 110 is digitized and converted into image data by the image processor 210. The CMOS image sensor 110 can acquire still picture data and moving picture data. The acquired moving picture data is also used for the display of a through-image.

The “through-image” referred to here is an image, out of the moving picture data, that is not recorded to a memory card 171. The through-image is mainly a moving picture, and is displayed on the camera monitor 120 in order to compose a moving picture or still picture.

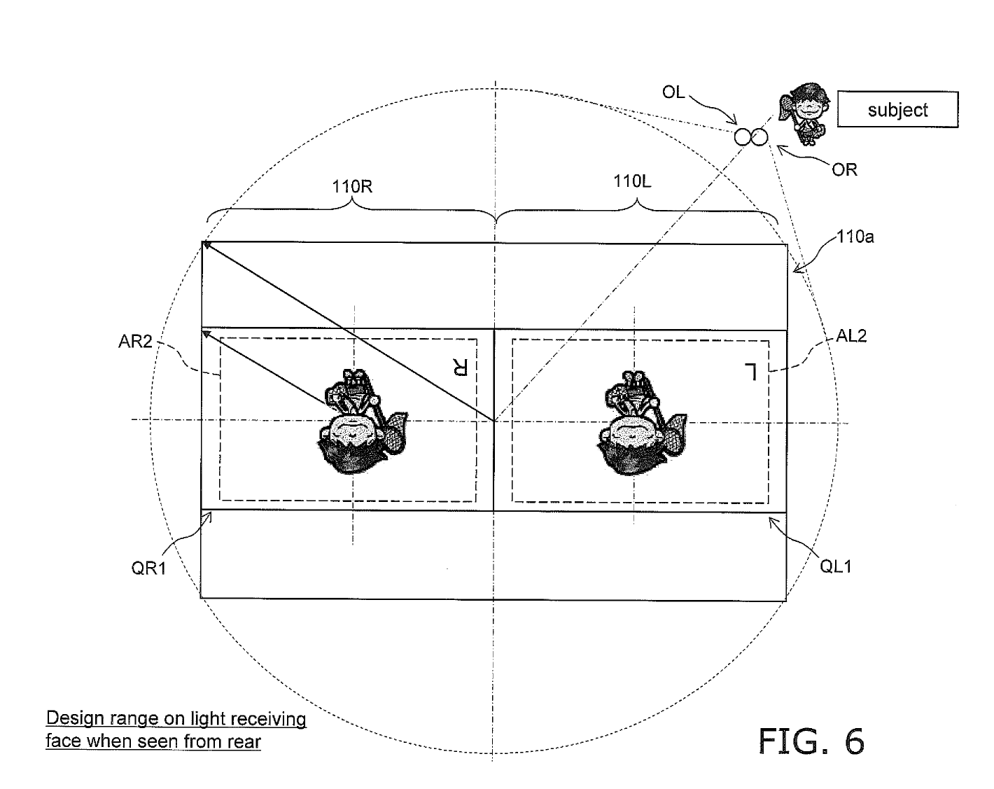

As shown in FIG. 5, the CMOS image sensor 110 has a light receiving face 110a that receives light that has passed through the video lens unit 201. An optical image of the subject is formed on the light receiving face 110a. As shown in FIG. 6, when viewed from the rear face side of the video camera body 202, a first light receiving face 110L accounts for the left half of the light receiving face 110a, while a second light receiving face 110R accounts for the right half. The surface area is the same for the first light receiving face 110L and the second light receiving face 110R. When imaging is performed with the 3D adapter 100 mounted to the interchangeable lens unit 200, a left-eye optical image QL1 is formed on the first light receiving face 110L, and a right-eye optical image QR1 is formed on the second light receiving face 110R.

The CMOS image sensor 110 is an example of an imaging element that converts an optical image of a subject into an electrical image signal. “Imaging element” is a concept that encompasses the CMOS image sensor 110 as well as a CCD image sensor or other such opto-electric conversion element.

(2) Camera Monitor 120

The camera monitor 120 shown in FIG. 5 is a liquid crystal display, for example, and displays display-use image data as an image. This display-use image data is image data that has undergone image processing, data for displaying the imaging conditions, operating menu, and so forth of the digital camera 1, or the like as an image, and is produced by the camera controller 140. The camera monitor 120 is capable of selectively displaying both moving and still pictures. As shown in FIGS. 1 and 2, in this embodiment the camera monitor 120 is disposed on the side face of the video camera body 202, but the camera monitor 120 may be disposed anywhere on the video camera body 202.

The camera monitor 120 is an example of a display component provided to the video camera body 202. The display component could also be an organic electroluminescence component, an inorganic electroluminescence component, a plasma display panel, or another such device that allows images to be displayed.

(3) Manipulation Component 130

As shown in FIG. 4, the manipulation component 130 has a record button 131, a zoom lever 132, and an adjustment mode button 133. The record button 131 is operated by the user. The zoom lever 132 is a lever switch provided to the top face of the video camera body 202, and is used for zoom adjustment. The adjustment mode button 133 is provided to switch the video camera 200 to an adjustment mode for performing various kinds of position adjustment of the left and right images during three-dimensional imaging. The manipulation component 130 can encompass a button, lever, dial, touch panel, or any of various other such manipulation systems, so long as it can be operated by the user.

(4) Card Slot 170

As shown in FIG. 4, the card slot 170 allows the memory card 171 to be inserted. The card slot 170 controls the memory card 171 on the basis of control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 by image processing. For instance, the memory card 171 can store uncompressed raw image data or compressed JPEG image data. Furthermore, the memory card 171 can store stereo image data in multi-picture format (MPF).

Also, still picture data that has been internally stored ahead of time can be outputted from the memory card 171 via the card slot 170. The still picture data outputted from the memory card 171 is subjected to image processing by the camera controller 140. For example, the camera controller 140 produces display-use still picture data by subjecting the still picture data acquired from the memory card 171 to expansion processing.

The memory card 171 is further able to store moving picture data produced by the camera controller 140 by image processing. For instance, the memory card 171 can store moving picture data compressed according to H.264/AVC, which is a moving picture compression standard. The moving picture data that has been internally stored ahead of time can be outputted from the memory card 171 via the card slot 170. The moving picture data outputted from the memory card 171 is subjected to image processing by the camera controller 140. For example, the camera controller 140 subjects the moving picture data acquired from the memory card 171 to expansion processing and produces display-use moving picture data.

(5) Camera Controller 140

The camera controller 140 controls the entire video camera body 202. The camera controller 140 is electrically connected to the manipulation component 130. Manipulation signals from the manipulation component 130 are inputted to the camera controller 140. The camera controller 140 uses a DRAM 241 as a working memory during control operation or image processing operation.

Also, the camera controller 140 sends signals for controlling the video lens unit 201 through a body mount 150 and a lens mount 250 to the lens controller 240, and indirectly controls the various components of the video lens unit 201. The camera controller 140 also receives various kinds of signals from the lens controller 240 via the body mount 150 and the lens mount 250.

The camera controller 140 has a CPU (central processing unit) 140a, a ROM (read only memory) 140b, and a RAM (random access memory) 140c, and can perform various functions by reading the programs stored in the ROM 140b into the CPU 140a.

The camera controller 140 has a reproduction mode, a two-dimensional imaging mode, and a three-dimensional imaging mode. The camera controller 140 can switch the operating mode between two-dimensional imaging mode and three-dimensional imaging mode when the above-mentioned three-dimensional imaging button 133 is pressed.

The camera controller 140 further has a drive controller 140d. The drive controller 140d controls the zoom motor 214 in two-dimensional imaging mode and three-dimensional imaging mode on the basis of indicator data (discussed below) that indicates individual differences between products, and drives the second lens group G2 to the desired position. Consequently, even though there may be individual differences between products, the fourth lens group G4 (focus lens group) can be disposed at the designed reference position. The indicator data is data that indicates individual differences of the optical system V, for example, and indicator data is calculated for each product during manufacture or shipping. This indicator data can be converted into a focal distance, for example, and more specifically, data indicating the how the focal distance differs from the design value is possible as indicator data. This indicator data is stored in the ROM 140b, for example.

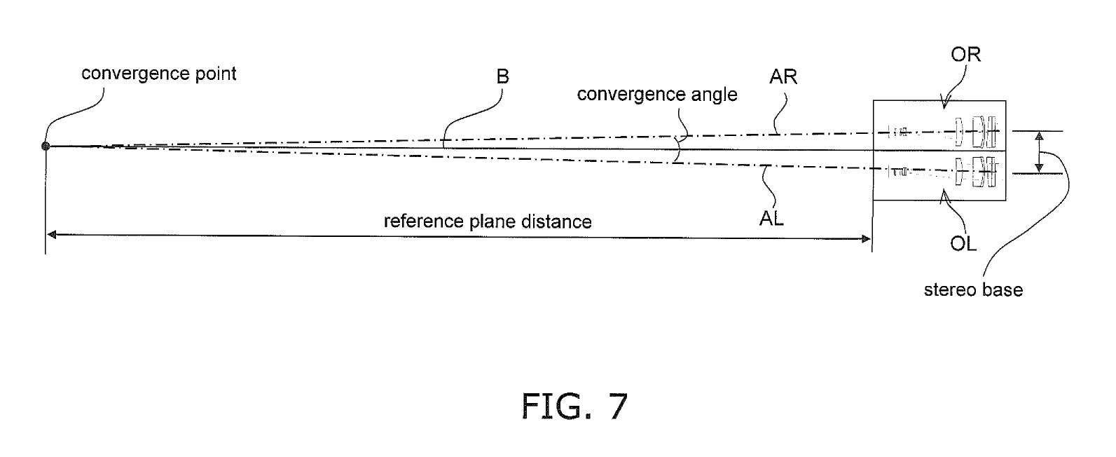

A metadata production component 147 produces metadata including a stereo base and a convergence angle. Here, as shown in FIG. 7, the term “stereo base” refers to the distance between the left-eye optical system OL and the right-eye optical system OR. The term “convergence angle” refers to the angle formed by the left-eye optical axis AL and the right-eye optical axis AR. The stereo base and convergence angle are used in displaying a stereo image. The convergence angle refers to the intersection point between the left-eye optical axis AL and the right-eye optical axis AR.

An image file production component 148 produces MPF stereo image files by combining metadata with left- and right-eye image data compressed by an image compressor 217 (discussed below). The image files thus produced are sent to the card slot 170 and stored on the memory card 171, for example.

(6) Image Processor 210

As shown in FIG. 5, the image processor 210 has a signal processor 215, an image extractor 216, a correction processor 218, and the image compressor 217.

The signal processor 215 digitizes the image signal produced by the CMOS image sensor 110, and produces basic image data for the optical image formed on the CMOS image sensor 110. More specifically, the signal processor 215 converts the image signal outputted from the CMOS image sensor 110 into a digital signal, and subjects this digital signal to digital signal processing such as noise elimination or contour enhancement. The image data produced by the signal processor 215 is temporarily stored as raw data in the DRAM 141. Here, image data produced by the signal processor 215 is called basic image data.

The image extractor 216 extracts left-eye image data and right-eye image data from the basic image data produced by the signal processor 215. The left-eye image data corresponds to the part of the left-eye optical image QL1 formed by the left-eye optical system OL (see FIG. 6). The right-eye image data corresponds to the part of the right-eye optical image QR1 formed by the right-eye optical system OR (see FIG. 6). The image extractor 216 extracts left-eye image data and right-eye image data from the basic image data held in the DRAM 241, on the basis of a first extraction region AL2 and a second extraction region AR2 that have been set in advance (see FIG. 6). The left-eye image data and right-eye image data extracted by the image extractor 216 are temporarily stored in the DRAM 241.

The correction processor 218 performs distortion correction, shading correction, and other such correction processing on the extracted left-eye image data and right-eye image data. After this correction processing, the left-eye image data and right-eye image data are temporarily stored in the DRAM 241.

The image compressor 217 performs compression processing on the corrected left- and right-eye image data recorded to the DRAM 241, on the basis of a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 241.

(7) Temperature Sensor 118

The temperature sensor 118 shown in FIG. 5 (an example of a temperature detector) detects the ambient temperature of the video camera 200. The temperature sensor 118 is disposed at a position where it can detect the temperature around the optical system V. The temperature sensor 118 is a thermocouple, but may instead be any sensor that can detect the ambient temperature of the video camera 200. The temperature detected by the temperature sensor 118 is used in the correction of deviation of the reference face distance by the drive controller 140d of the camera controller 140.

### Configuration of 3D Adapter

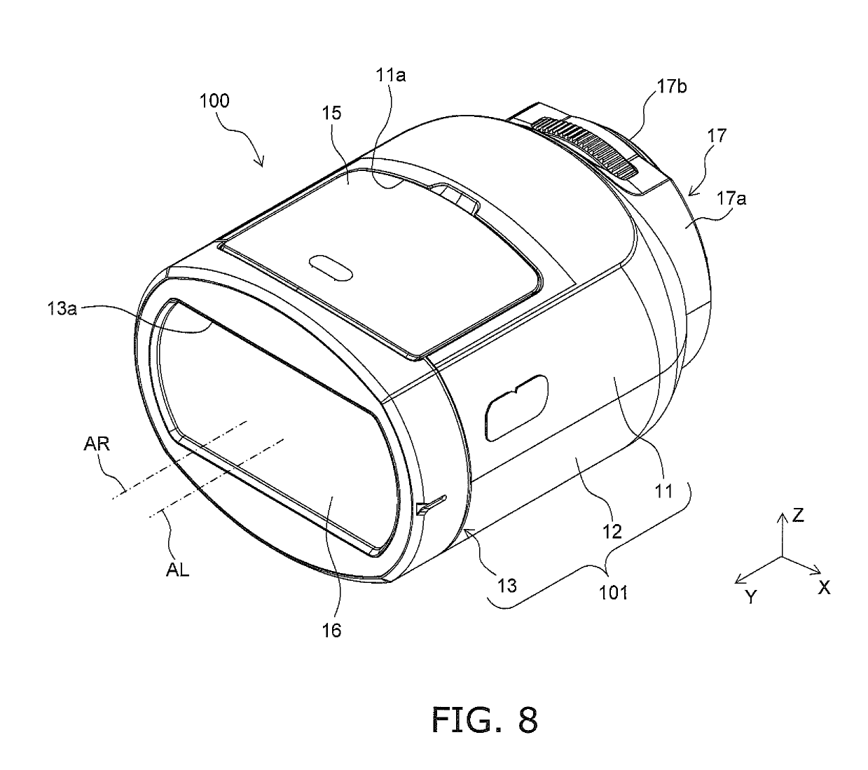

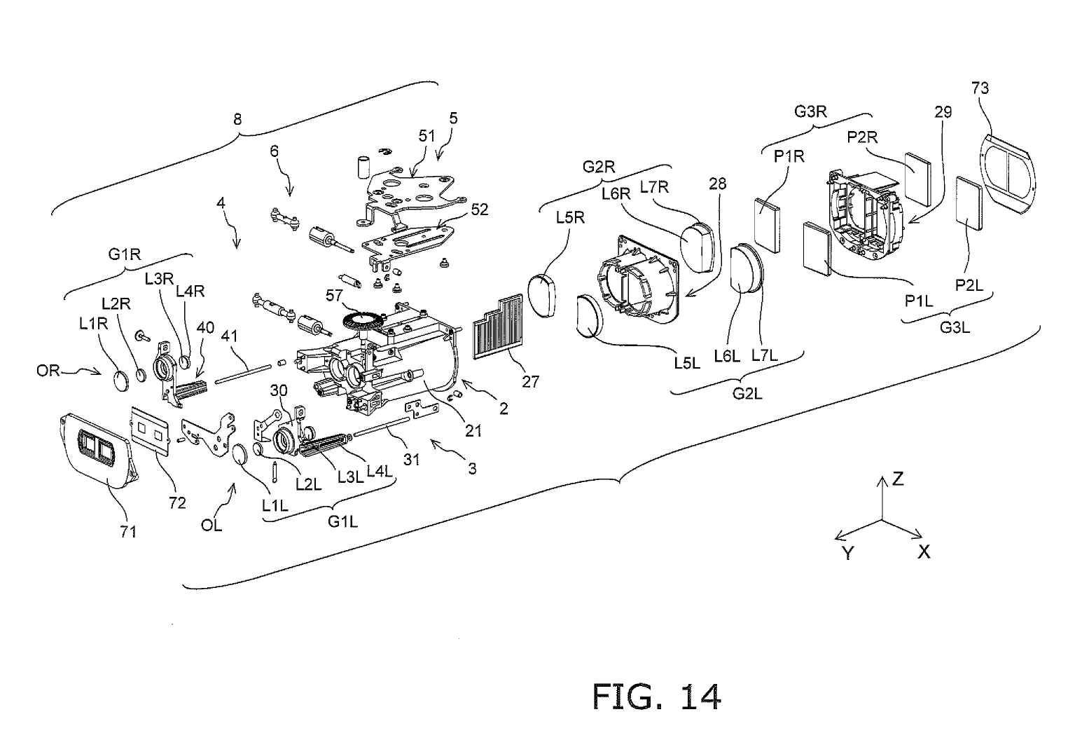

As shown in FIGS. 8 and 14, the 3D adapter 100 has an exterior casing 101 (an example of a housing), the left-eye optical system OL, the right-eye optical system OR, a main body frame 2, an adjusting mechanism 8, and a manipulation mechanism 6. The exterior casing 101 and the main body frame 2 make up a support unit that accommodates first and second optical systems and can be mounted to an imaging device. As shown in FIG. 14, the adjusting mechanism 8 supports the left-eye optical system OL and the right-eye optical system OR so that the left-eye optical axis AL and the right-eye optical axis AR can move with respect to the optical axis A0 of the optical system V. The adjusting mechanism 8 (an example of an adjusting unit) has a first adjusting mechanism 3 (an example of a relative offset adjusting mechanism), a second adjusting mechanism 4 (an example of a convergence angle adjusting mechanism), and a third adjusting mechanism 5 (an example of a main body frame adjusting mechanism, and an example of a position adjusting mechanism).

The “left-eye optical system” here is an optical system corresponding to a viewpoint on the left side, or more specifically refers to an optical system in which the optical element disposed the closest to the subject side (the front side) is disposed on the left side toward the subject (the front side) is facing the subject. Similarly, the “right-eye optical system” is an optical system corresponding to a viewpoint on the right side, or more specifically refers to an optical system in which the optical element disposed the closest to the subject side (the front side) is disposed on the right side toward the subject.

The term “optical element” here refers to an optical element having positive or negative refractive power, and does not include simple glass (such as the glass 16 discussed below).

(1) Exterior Casing 101

As shown in FIG. 8, the exterior casing 101 (an example of a housing) has an upper case 11, a lower case 12, a front case 13, a cover 15, and a threaded ring unit 17. The lower case 12 is fixed to the upper case 11 with screws. The front case 13 is fixed to the upper case 11 and the lower case 12 with screws. The cover 15 is openably and closeably mounted to the upper case 11. The upper case 11 has a recess 11a. The cover 15 is fitted into the recess 11a when the cover 15 is closed.

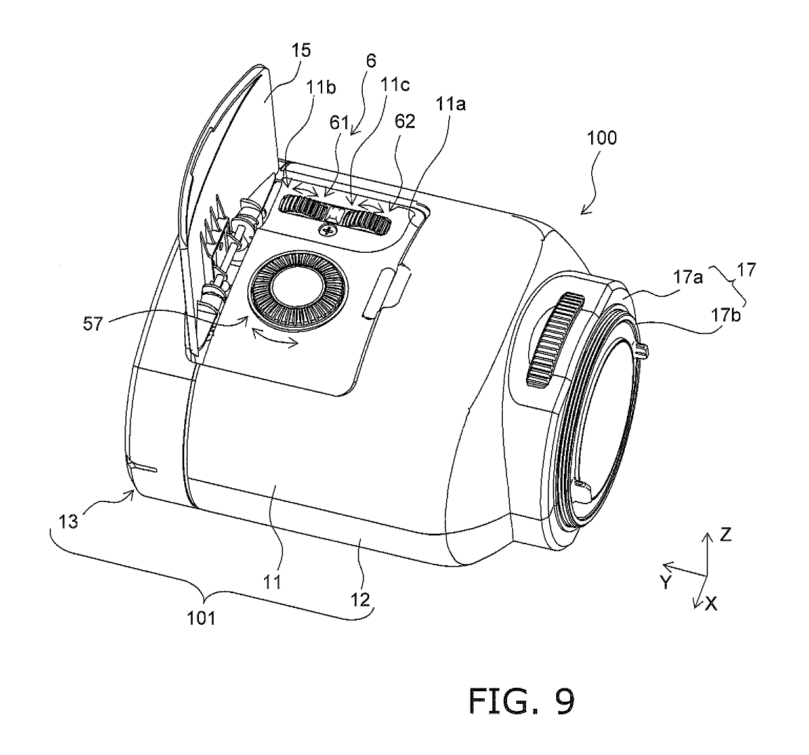

As shown in FIG. 9, the upper case 11 is configured such that a vertical position adjustment dial 57, a relative offset adjustment dial 61, and a horizontal position adjustment dial 62 of the manipulation mechanism 6 are exposed when the cover 15 is open. The vertical position adjustment dial 57, the relative offset adjustment dial 61, and the horizontal position adjustment dial 62 are disposed inside the recess 11a. The cover 15 is openably and closeably mounted to the upper case 11. When the cover 15 is opened, the vertical position adjustment dial 57, the relative offset adjustment dial 61, and the horizontal position adjustment dial 62 can be operated.

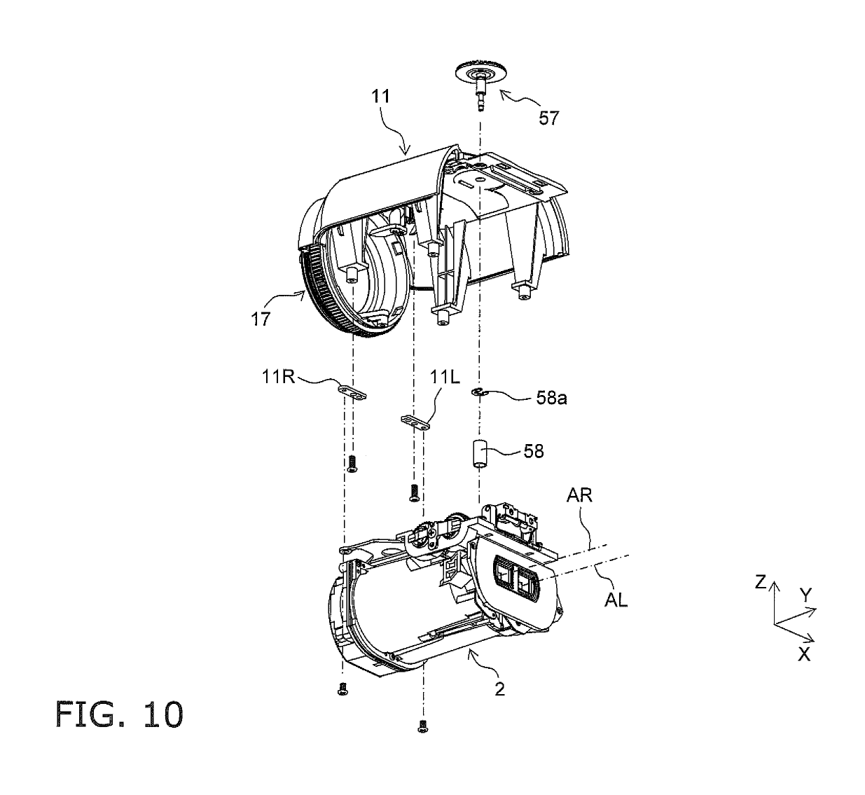

As shown in FIG. 10, the upper case 11 is mounted on the top side of the main body frame 2. The upper case 11 supports the main body frame 2 movably in the Z axis direction and the X axis direction.

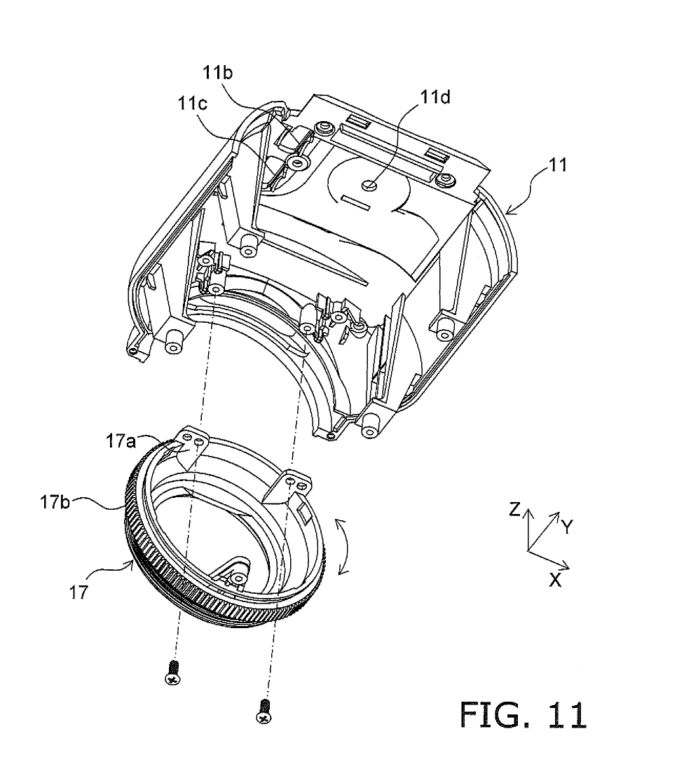

As shown in FIG. 11, the threaded ring unit 17 has a rear case 17a mounted to the upper case 11 and the lower case 12, and a threaded ring 17b for mounting the 3D adapter 100 to a front frame 299 (see FIG. 2). The rear case 17a rotatably supports the threaded ring 17b. The 3D adapter 100 can be mounted to the video camera 200 by connecting the threaded ring 17b to the front frame 299 of the video camera 200.

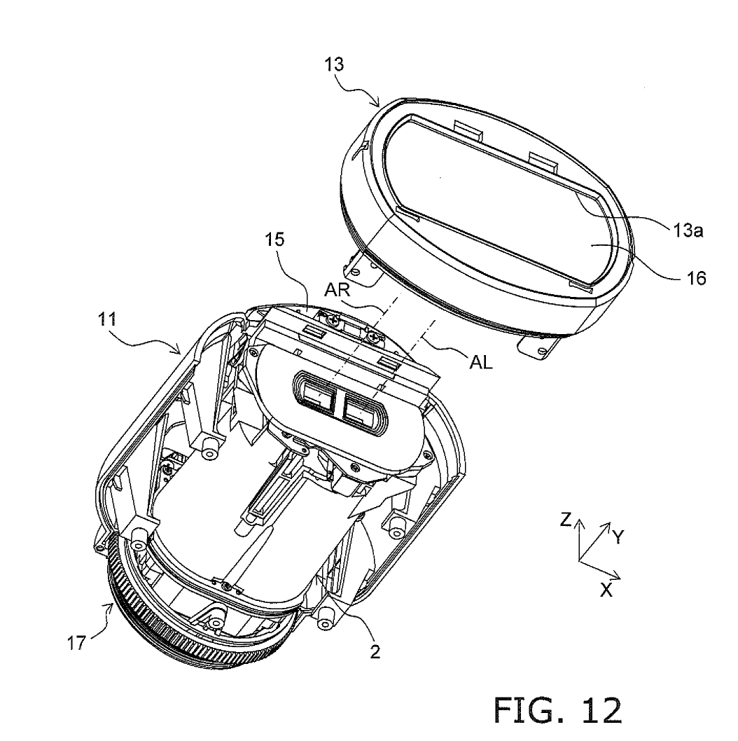

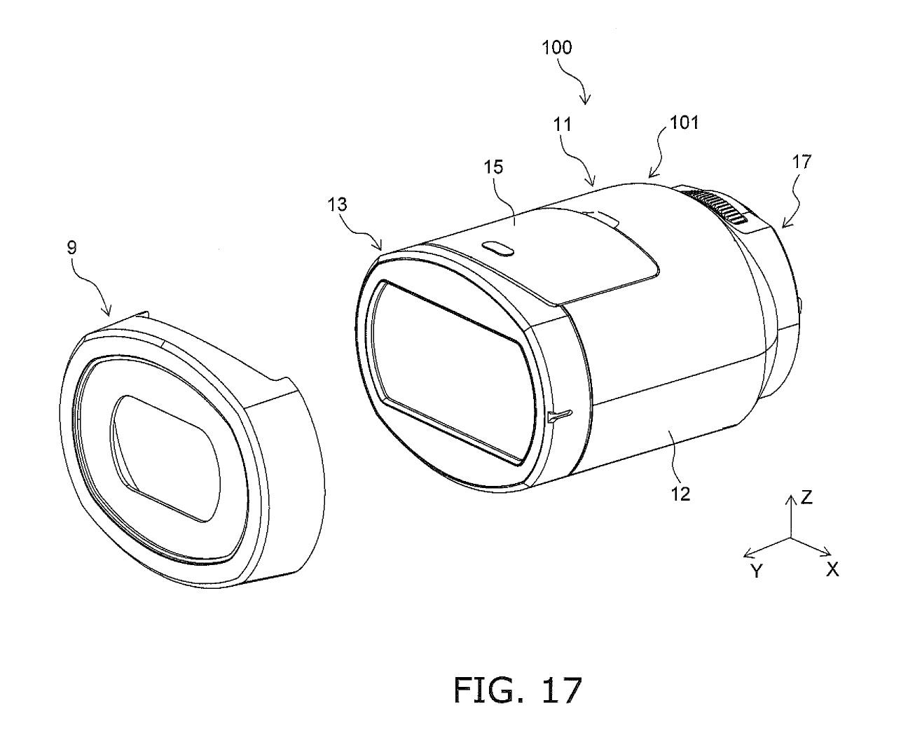

As shown in FIG. 12, the front case 13 is mounted to the front side of the main body frame 2 (the side closer to the subject). The front case 13 has an opening 13a and a glass 16 mounted in the opening 13a. As shown in FIG. 17, a cap 9 can be mounted to the front case 13. The cap 9 is mounted to protect the glass 16, or to adjust relative offset.

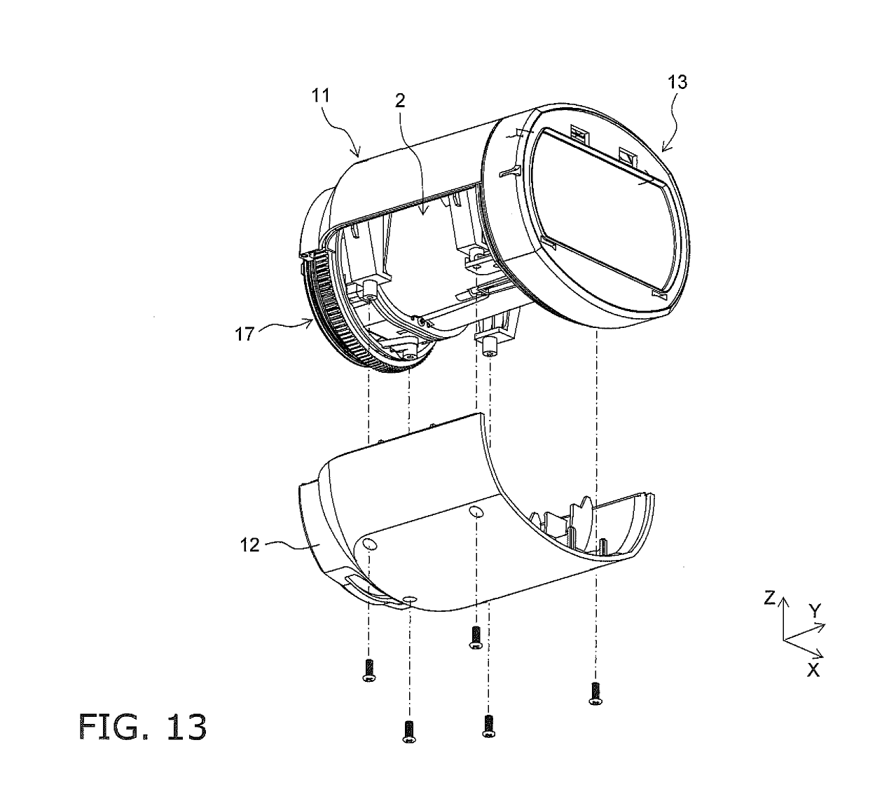

As shown in FIG. 13, the lower case 12 covers the bottom side of the main body frame 2, and is mounted to the upper case 11. A gap is maintained between the lower case 12 and the main body frame 2 so that the main body frame 2 will be able to move in the Z axis direction and the X axis direction within the exterior casing 101. The exterior casing 101 covers the main body frame 2.

(2) Left-Eye Optical System OL

As shown in FIG. 3, the left-eye optical system OL is used to form a left-eye optical image (an example of a first optical image or second optical image) seen from a left viewpoint (an example of a first viewpoint or second viewpoint), and has a left-eye negative lens group G1L, a left-eye positive lens group G2L, and a left-eye prism group G3L. The left-eye optical system OL is a substantially afocal optical system. For example, the focal distance of the left-eye optical system OL is preferably at least 1000 mm or no more than −1000 mm.

The left-eye negative lens group G1L (an example of a focus adjusting optical system, and an example of a first negative lens group or a second negative lens group) has an overall negative focal distance (also called a negative refractive power), and has a first lens L1L, a second lens L2L, a third lens L3L, and a fourth lens L4L. The left-eye negative lens group G1L is disposed on the side closest to the subject (on the closest position to the subject) in the left-eye optical system OL. The first lens L1L has a negative focal distance. The second lens L2L has a negative focal distance. The third lens L3L has a positive focal distance (also called a positive refractive power). The fourth lens L4L has a negative focal distance, and is joined to the third lens L3L. The combined focal distance of the left-eye negative lens group G1L is negative. The effective diameter of the left-eye negative lens group G1L is smaller than the effective diameter of the left-eye positive lens group G2L.

The left-eye positive lens group G2L (an example of a first positive lens group or a second positive lens group) is a lens group that receives light transmitted by the left-eye negative lens group G1L, and is disposed on the opposite side of the left-eye negative lens group G1L from the subject. The left-eye positive lens group G2L is disposed between the left-eye negative lens group G1L and the left-eye prism group G3L.

The left-eye positive lens group G2L has a fifth lens L5L, a sixth lens L6L, and a seventh lens L7L. The fifth lens L5L has a positive focal distance. The sixth lens L6L has a positive focal distance. The seventh lens L7L has a negative focal distance, and is joined to the sixth lens L6L.

Since the transmitted light of the left-eye negative lens group G1L scatters, the optically effective region of the incident face of the left-eye positive lens group G2L is larger than the optically effective region of the emission face of the left-eye negative lens group G1L. Therefore, the effective diameter of the left-eye positive lens group G2L is larger than the effective diameter of the left-eye negative lens group G1L. Also, the left-eye positive lens group G2L has a substantially semicircular shape in order to move the left-eye optical axis AL and right-eye optical axis AR closer together. More specifically, the inside of the left-eye positive lens group G2L (the right-eye optical axis AR side, and the intermediate reference face B side) is cut straight (see FIG. 14). Consequently, the left-eye positive lens group G2L and a right-eye positive lens group G2R can be disposed closer together, and the stereo base can be smaller. This makes it easier for the convergence angle formed by the left-eye optical axis AL and right-eye optical axis AR to be set to the proper value.

The left-eye optical axis AL is defined by the left-eye negative lens group G1L and the left-eye positive lens group G2L. More specifically, the left-eye optical axis AL is defined by a line that passes through the principal point of the left-eye negative lens group G1L and the principal point of the left-eye positive lens group G2L. The left-eye optical axis AL and the right-eye optical axis AR are disposed so as to move apart as they go from the subject side toward the CMOS image sensor 110 side.

The left-eye prism group G3L (an example of a first prism group or a second prism group) is a lens group that receives light transmitted by the left-eye positive lens group G2L, and has a first front prism P1L and a first rear prism P2L. The first front prism P1L and the first rear prism P2L are refractory wedge prisms. The left-eye prism group G3L refracts light transmitted by the left-eye positive lens group G2L so that light transmitted by the left-eye positive lens group G2L is guided to the optical system V (an example of a uniaxial optical system) of the video camera 200. More specifically, light transmitted by the left-eye positive lens group G2L is refracted inward (so as to move closer to the intermediate reference face B) by the left-eye prism group G3L. The first front prism P1L refracts light transmitted by the left-eye positive lens group G2L inward (so as to move closer to the intermediate reference face B). The first rear prism P2L refracts light transmitted by the first front prism P1L outward (so as to move away from the intermediate reference face B). The main function of the first front prism P1L is to refract light transmitted by the left-eye positive lens group G2L inward, while the main function of the first rear prism P2L is to correct color dispersion caused by refraction. The combined polarization angle of the left-eye prism group G3L is approximately 1.7 degrees.

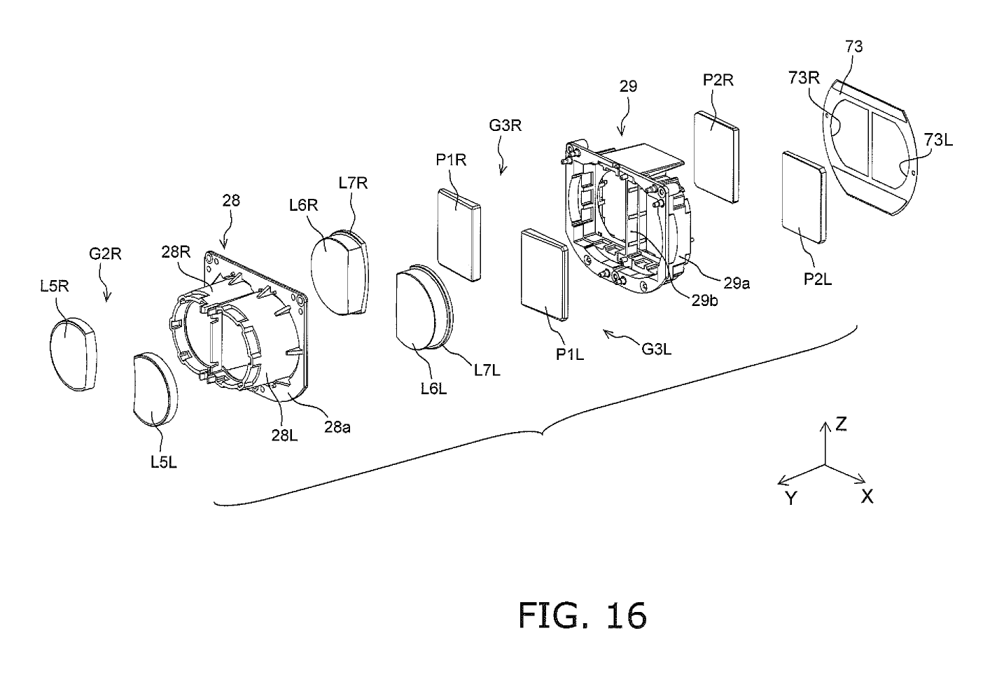

As shown in FIG. 14, the left-eye negative lens group G1L is fixed to a first adjustment frame 30 (discussed below) of the first adjusting mechanism 3, and is disposed movably substantially in the Z axis direction with respect to the left-eye positive lens group G2L, the left-eye prism group G3L, and the main body frame 2. As shown in FIG. 16, the left-eye positive lens group G2L is fixed to an intermediate lens frame 28 (discussed below). The left-eye prism group G3L is fixed to a prism support frame 29 (discussed below).

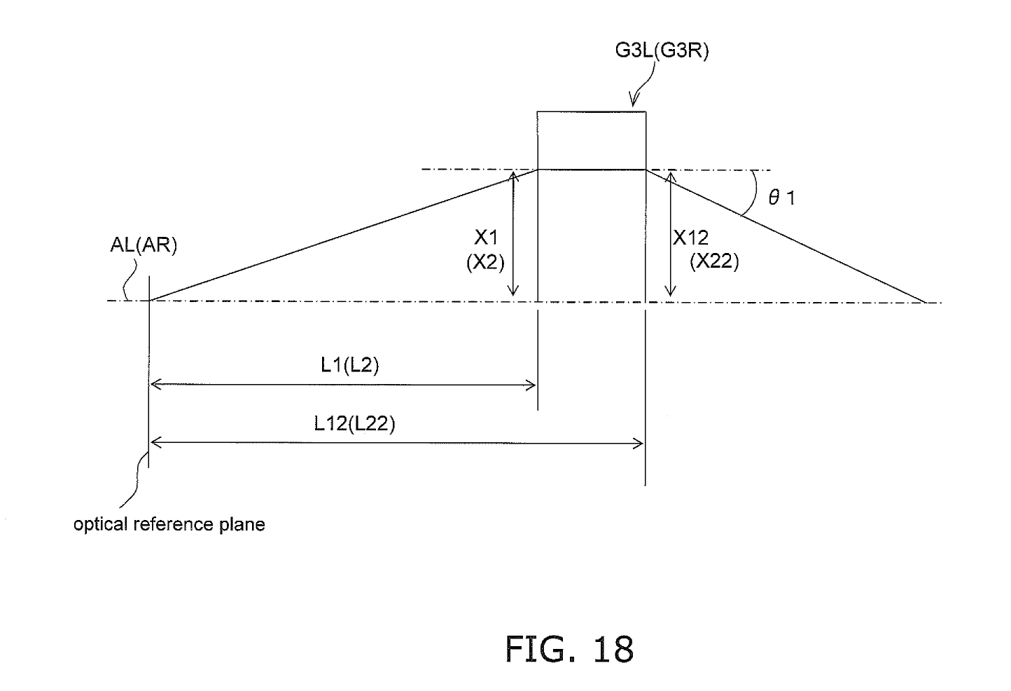

As shown in FIG. 18, if we let θL (an example of θ11 or θ22) be the polarization angle of the left-eye prism group G3L, θ1 be the emission angle of light transmitted by the left-eye prism group G3L, X1 be the vertical length from the left-eye optical axis AL to the point of intersection between the outermost light beam and the incident face of the left-eye prism group G3L, X12 be the vertical length from the left-eye optical axis AL to the point of intersection between the outermost light beam and the emission face of the left-eye prism group G3L, L1 be the distance from the incident face to an optical reference plane defined on the incident side of the left-eye prism group G3L (more precisely, the distance from the incident face of the left-eye prism group G3L to the convergence point shown in FIG. 7), and L12 be the distance from the optical reference plane to the emission face (more precisely, the distance from the emission face of the left-eye prism group G3L to the convergence point shown in FIG. 7), then the following formula (1) holds true.

θL≦{(θ1+arctan(X1/L1))²+(θ1+arctan(X12/L12))²}^{0.5}≦4×θL (1)

As shown in FIG. 18, the left-eye optical axis AL is inclined with respect to the intermediate reference face B so that it moves away from the intermediate reference face B as it goes toward the emission side. Light transmitted by the left-eye positive lens group G2L is refracted by the left-eye prism group G3L so as to move closer to the intermediate reference face B.

(3) Right-Eye Optical System OR

As shown in FIG. 3, the right-eye optical system OR is used to form a right-eye optical image (an example of a first optical image or a second optical image) as seen from a right-side viewpoint (an example of a first viewpoint or a second viewpoint), and has a right-eye negative lens group G1R, a right-eye positive lens group G2R, and a right-eye prism group G3R. The right-eye optical system OR is a substantially afocal optical system. For example, the focal distance of the right-eye optical system OR is preferably at least 1000 mm or no more than −1000 mm.

The right-eye negative lens group G1R (an example of a second adjusting optical system, and an example of a first negative lens group or a second negative lens group) has an overall negative focal distance (also called a negative refractive power), and has a first lens L1R, a second lens L2R, a third lens L3R, and a fourth lens L4R. The right-eye negative lens group G1R is disposed on the side closest to the subject (on the closest position to the subject) in the right-eye optical system OR. The first lens L1R has a negative focal distance. The second lens L2R has a negative focal distance. The third lens L3R has a positive focal distance (also called a positive refractive power). The fourth lens L4R has a negative focal distance, and is joined to the third lens L3R. The combined focal distance of the right-eye negative lens group G1R is negative. The effective diameter of the right-eye negative lens group G1R is smaller than the effective diameter of the right-eye positive lens group G2R.

As shown in FIG. 3, the right-eye positive lens group G2R (an example of a first positive lens group or a second positive lens group) is a lens group that receives light transmitted by the right-eye negative lens group G1R, and is disposed on the opposite side of the right-eye negative lens group G1R from the subject. The right-eye positive lens group G2R is disposed between the right-eye negative lens group G1R and the right-eye prism group G3R.

The right-eye positive lens group G2R has a fifth lens L5R, a sixth lens L6R, and a seventh lens L7R. The fifth lens L5R has a positive focal distance. The sixth lens L6R has a positive focal distance. The seventh lens L7R has a negative focal distance, and is joined to the sixth lens L6R.

As shown in FIG. 3, since the transmitted light of the right-eye negative lens group G1R scatters, the optically effective region of the incident face of the right-eye positive lens group G2R is larger than the optically effective region of the emission face of the right-eye negative lens group G1R. Therefore, the effective diameter of the right-eye positive lens group G2R is larger than the effective diameter of the right-eye negative lens group G1R. Also, the right-eye positive lens group G2R has a substantially semicircular shape in order to move the left-eye optical axis AL and right-eye optical axis AR closer together. More specifically, the inside of the right-eye positive lens group G2R (the right-eye optical axis AR side, and the intermediate reference face B side) is cut straight (see FIG. 14). Consequently, the stereo base can be smaller, and the convergence angle formed by the left-eye optical axis AL and the right-eye optical axis AR can be reduced. This makes it easier for the convergence angle formed by the left-eye optical axis AL and right-eye optical axis AR to be set to the proper value.

As shown in FIG. 3, the right-eye optical axis AR is defined by the right-eye negative lens group G1R and the right-eye positive lens group G2R. More specifically, the right-eye optical axis AR is defined by a line that passes through the principal point of the right-eye negative lens group G1R and the principal point of the right-eye positive lens group G2R. The left-eye optical axis AL and the right-eye optical axis AR are disposed so as to move apart as they go from the subject side toward the CMOS image sensor 110 side.

The right-eye prism group G3R (an example of a first prism group or a second prism group) is a lens group that receives light transmitted by the right-eye positive lens group G2R, and has a second front prism P1R and a second rear prism P2R. The second front prism P1R and the second rear prism P2R are refractory wedge prisms. The right-eye prism group G3R refracts light transmitted by the right-eye positive lens group G2R so that light transmitted by the right-eye positive lens group G2R is guided to the optical system V (an example of a uniaxial optical system) of the video camera 200. More specifically, light transmitted by the right-eye positive lens group G2R is refracted inward (so as to move closer to the intermediate reference face B) by the right-eye prism group G3R. The second front prism P1R refracts light transmitted by the right-eye positive lens group G2R inward (so as to move closer to the intermediate reference face B). The second rear prism P2R refracts light transmitted by the second front prism P1R outward (so as to move away from the intermediate reference face B). The main function of the second front prism P1R is to refract light transmitted by the right-eye positive lens group G2R inward, while the main function of the second rear prism P2R is to correct color dispersion caused by refraction. The combined polarization angle of the right-eye prism group G3R is approximately 1.7 degrees.

As shown in FIG. 14, the right-eye negative lens group G1R is fixed to a second adjustment frame 40 (discussed below) of the second adjusting mechanism 4, and is disposed movably substantially in the Z axis direction with respect to the right-eye positive lens group G2R, the right-eye prism group G3R, and the main body frame 2. As shown in FIG. 16, the right-eye positive lens group G2R is fixed to the intermediate lens frame 28 (discussed below). The right-eye prism group G3R is fixed to the prism support frame 29 (discussed below).

As shown in FIG. 18, if we let θR (an example of θ11 or θ22) be the polarization angle of the right-eye prism group G3R, θ2 be the emission angle of light transmitted by the right-eye prism group G3R, X2 be the vertical length from the right-eye optical axis AR to the point of intersection between the outermost light beam and the incident face of the right-eye prism group G3R, X22 be the vertical length from the right-eye optical axis AR to the point of intersection between the outermost light beam and the emission face of the right-eye prism group G3R, L2 be the distance from the incident face to an optical reference plane defined on the incident side of the right-eye prism group G3R (more precisely, the distance from the incident face of the right-eye prism group G3R to the convergence point shown in FIG. 7), and L22 be the distance from the optical reference plane to the emission face (more precisely, the distance from the emission face of the right-eye prism group G3R to the convergence point shown in FIG. 7), then the following formula (2) holds true.

θR≦{(θ2+arctan(X2/L2))²+(θ2+arctan(X22/L22))²}^{0.5}≦4×θL (2)

As shown in FIG. 18, the right-eye optical axis AR is inclined with respect to the intermediate reference face B so that it moves away from the intermediate reference face B as it goes toward the emission side. Light transmitted by the right-eye positive lens group G2R is refracted by the right-eye prism group G3R so as to move closer to the intermediate reference face B.

(4) Main Body Frame 2

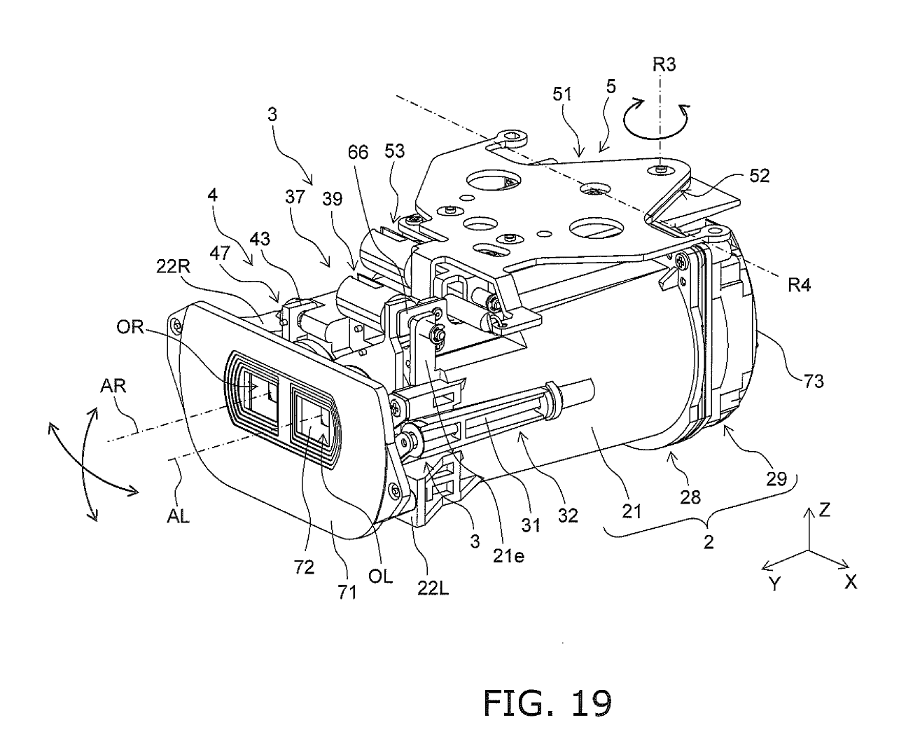

The main body frame 2 supports the entire left-eye optical system OL and the entire right-eye optical system OR, and is disposed inside the exterior casing 101. As shown in FIG. 19, the main body frame 2 is supported by the exterior casing 101 rotatably around a rotational axis R3 that is parallel to the X axis, and is able to move in the pitch direction with respect to the exterior casing 101. Since the rotational axis R3 is disposed at the rear of the main body frame 2, it can be said that the main body frame 2 is disposed movably with respect to the exterior casing 101 in substantially the Z axis direction (first direction). Also, the main body frame 2 is supported by the exterior casing 101 rotatably around a rotational axis R4 that is parallel to the Z axis, and is able to move in the yaw direction with respect to the exterior casing 101. Since the rotational axis R4 is disposed at the rear of the main body frame 2, it can be said that the main body frame 2 is disposed movably with respect to the exterior casing 101 in substantially the X axis direction (second direction). When the main body frame 2 moves substantially in the Z axis direction with respect to the exterior casing 101, the entire left-eye optical system OL and the entire right-eye optical system OR move substantially in the Z axis direction with respect to the exterior casing 101. When the main body frame 2 moves substantially in the X axis direction with respect to the exterior casing 101, the entire left-eye optical system OL and the entire right-eye optical system OR move substantially in the Z axis direction with respect to the exterior casing 101.

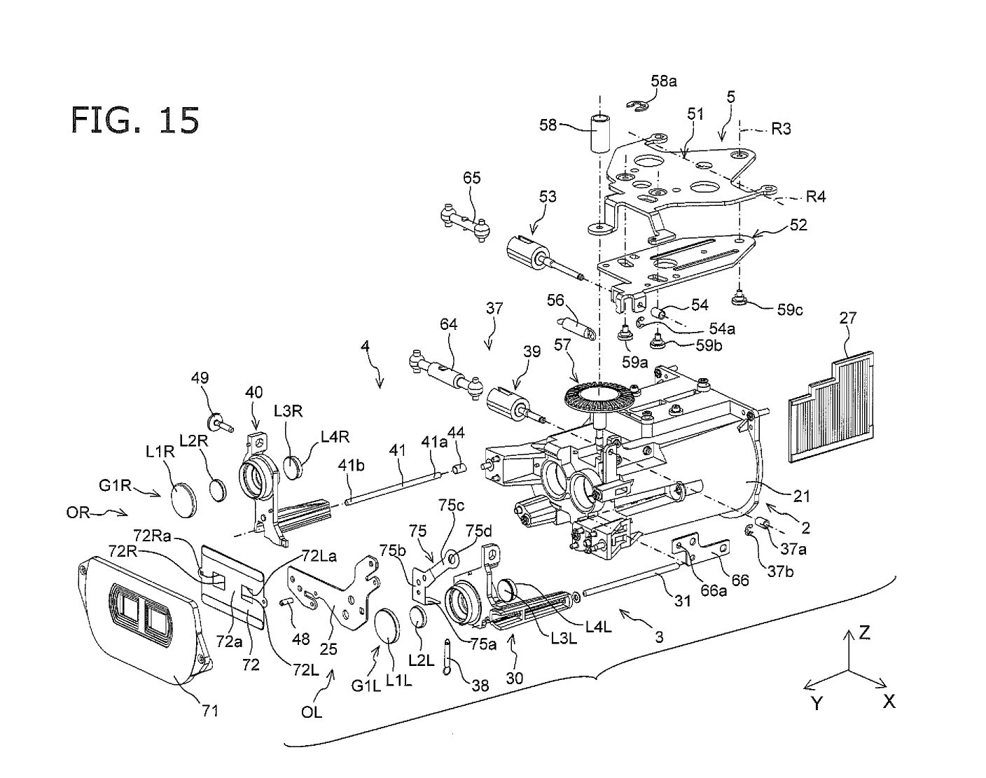

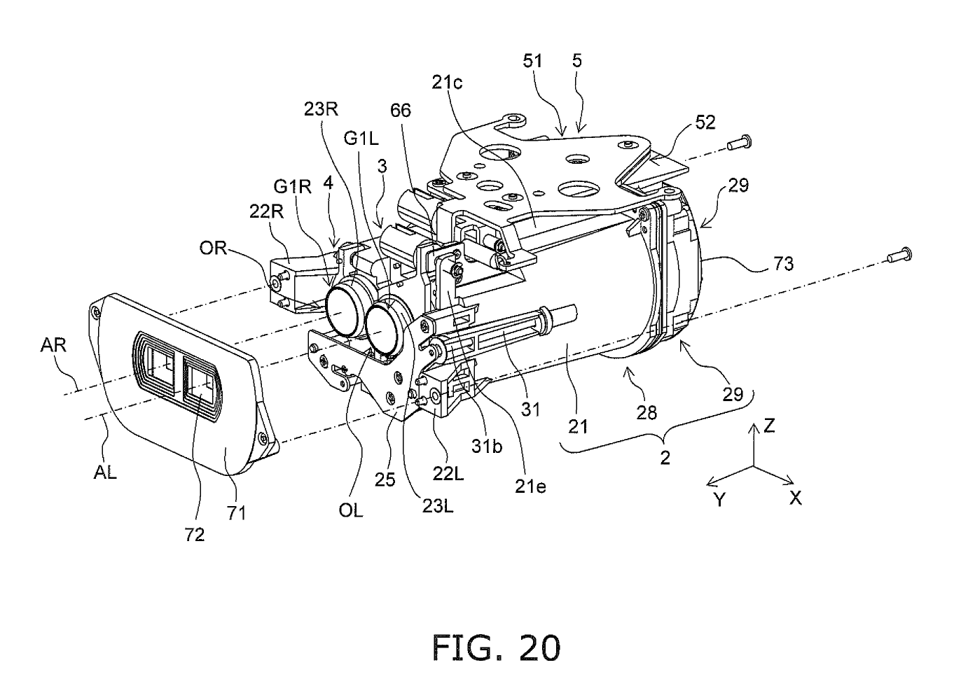

More specifically, as shown in FIG. 20, the main body frame 2 has a cylindrical frame 21, a first fixing component 22L, a second fixing component 22R, a left-eye cylindrical component 23L, a right-eye cylindrical component 23R, a seat 21c, a light blocking panel 27 (see FIG. 15), the intermediate lens frame 28, the prism support frame 29, a front panel 71, and a rear panel 73. The cylindrical frame 21, the first fixing component 22L, the second fixing component 22R, the left-eye cylindrical component 23L, the right-eye cylindrical component 23R, and the seat 21c are integrally molded from plastic.

The cylindrical frame 21 is disposed inside the exterior casing 101, and is linked to the exterior casing 101 by the third adjusting mechanism 5. The left-eye positive lens group G2L and the right-eye positive lens group G2R are disposed inside the cylindrical frame 21. The first fixing component 22L, the second fixing component 22R, the left-eye cylindrical component 23L, and the right-eye cylindrical component 23R are disposed on the front side (subject side) of the cylindrical frame 21. The seat 21c is disposed on the top side of the cylindrical frame 21.

As shown in FIG. 20, the front panel 71 is fixed to the first fixing component 22L and the second fixing component 22R. The left-eye cylindrical component 23L is disposed at a position corresponding to the left-eye negative lens group G1L. The light transmitted by the left-eye negative lens group G1L passes through the left-eye cylindrical component 23L and enters the cylindrical frame 21. The right-eye cylindrical component 23R is disposed at a position corresponding to the right-eye negative lens group G1R. The light transmitted by the right-eye negative lens group G1R passes through the right-eye cylindrical component 23R and enters the cylindrical frame 21. A second linking plate 52 (discussed below) of the third adjusting mechanism 5 is fixed to the seat 21c.

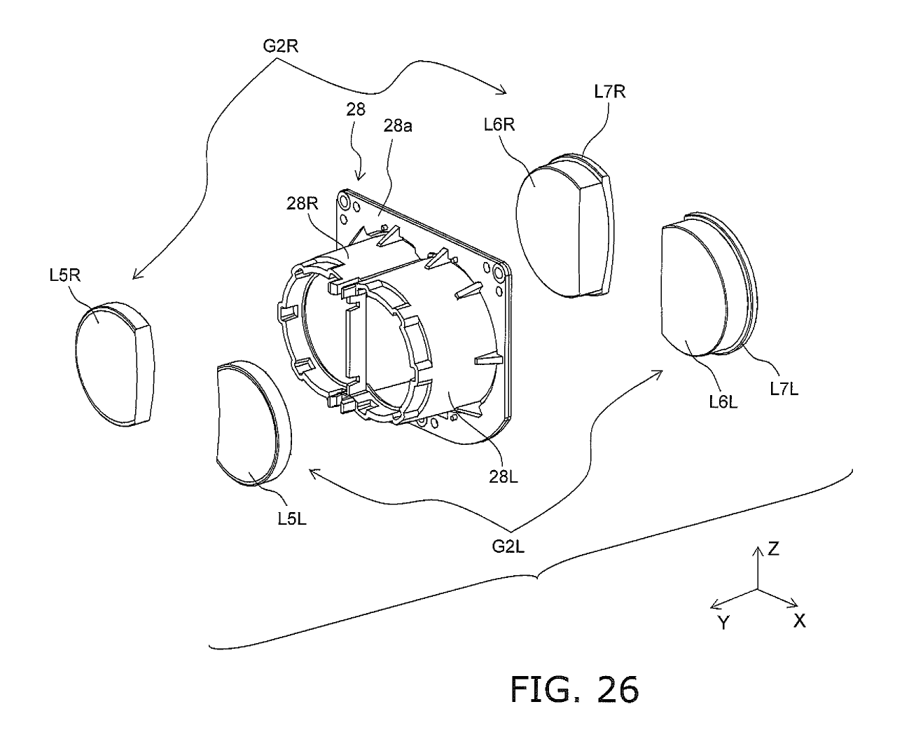

As shown in FIG. 26, the left-eye positive lens group G2L and the right-eye positive lens group G2R are fixed to the intermediate lens frame 28. More specifically, the intermediate lens frame 28 has a flange 28a, a first intermediate frame 28L, and a second intermediate frame 28R. The first intermediate frame 28L is a cylindrical portion that protrudes from the flange 28a. The second intermediate frame 28R is also a cylindrical portion that protrudes from the flange 28a. The fifth lens L5L and sixth lens L6L of the left-eye positive lens group G2L are fixed to the first intermediate frame 28L. The fifth lens L5R and sixth lens L6R of the right-eye positive lens group G2R are fixed to the second intermediate frame 28R.

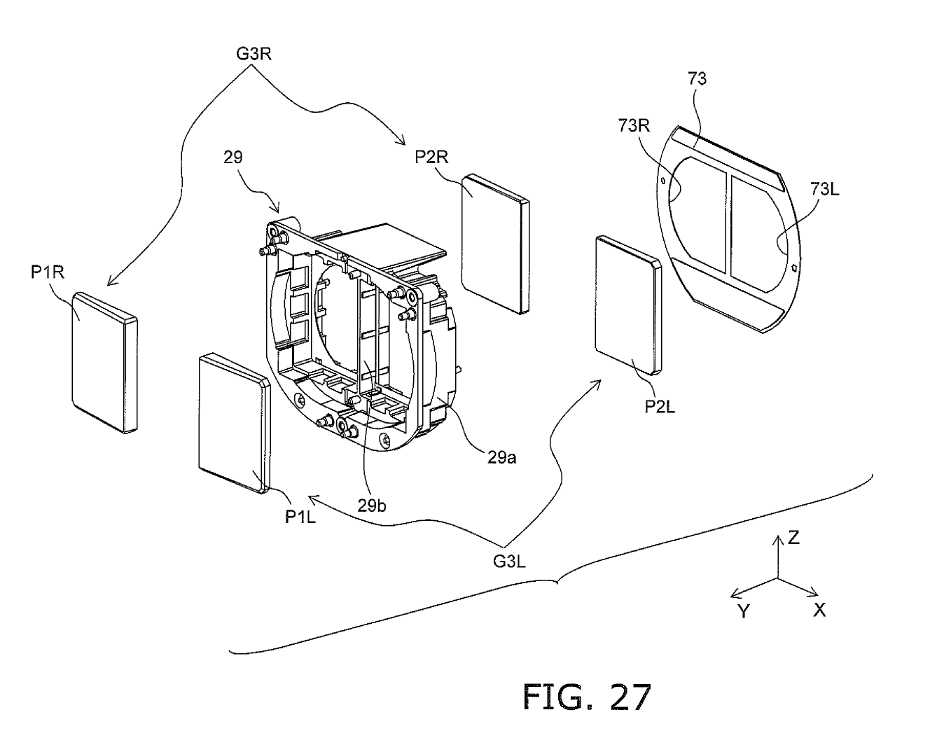

As shown in FIG. 27, the left-eye prism group G3L and the right-eye prism group G3R are fixed to the prism support frame 29. More specifically, the prism support frame 29 has an annular support frame main body 29a and a partition 29b. The first front prism P1L and the first rear prism P2L are fixed to the support frame main body 29a and the partition 29b. The second front prism P1R and the second rear prism P2R are fitted inside the support frame main body 29a and fixed to the support frame main body 29a and the partition 29b.

The rear panel 73 is fixed behind the prism support frame 29. The rear panel 73 has a first opening 73L and a second opening 73R. The light transmitted by the left-eye optical system OL passes through the first opening 73L. The light transmitted by the right-eye optical system OR passes through the second opening 73R.

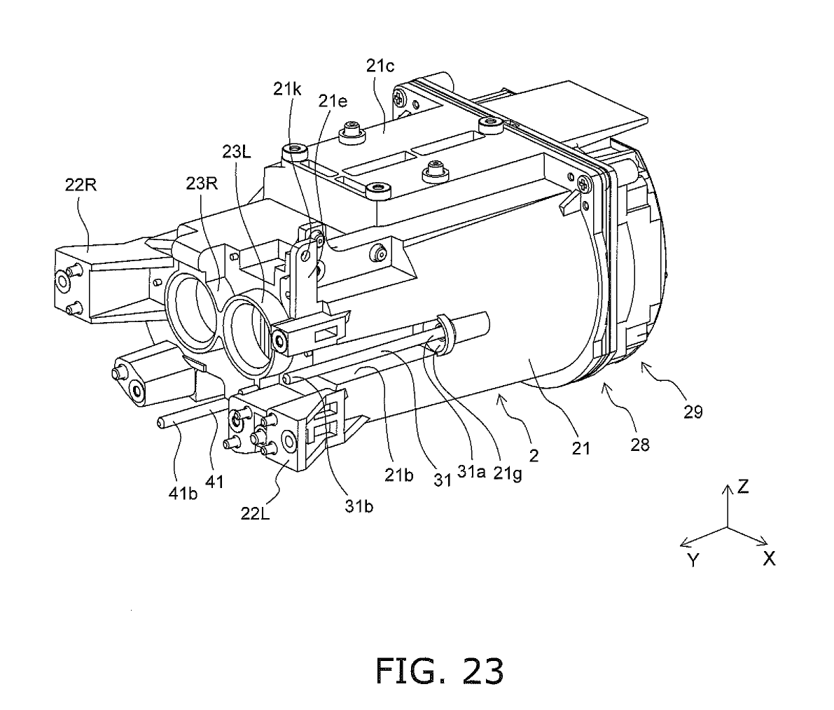

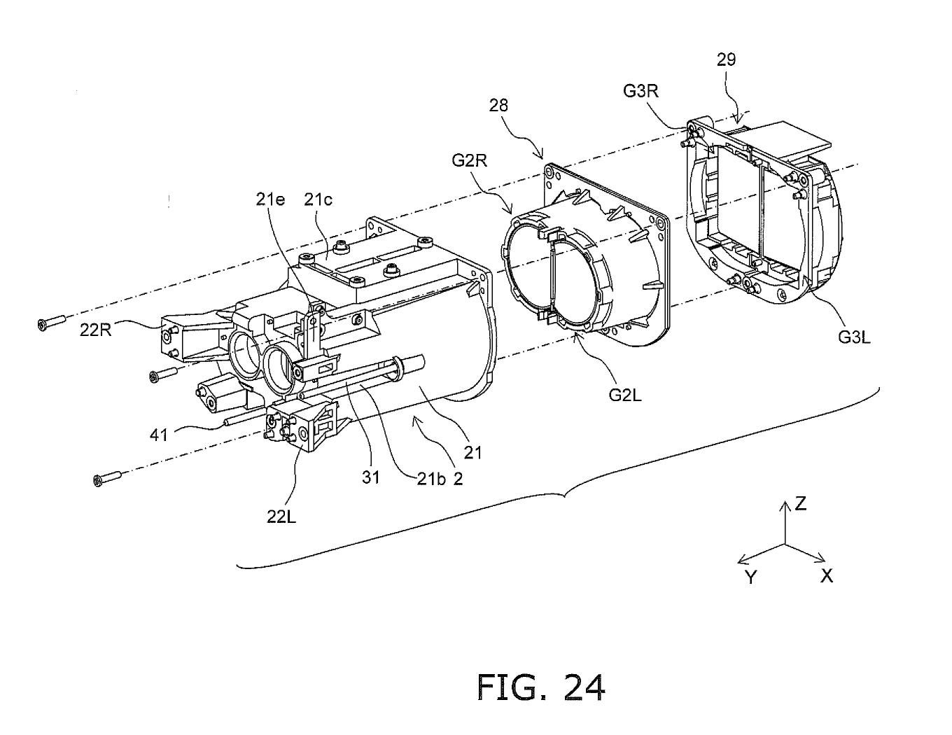

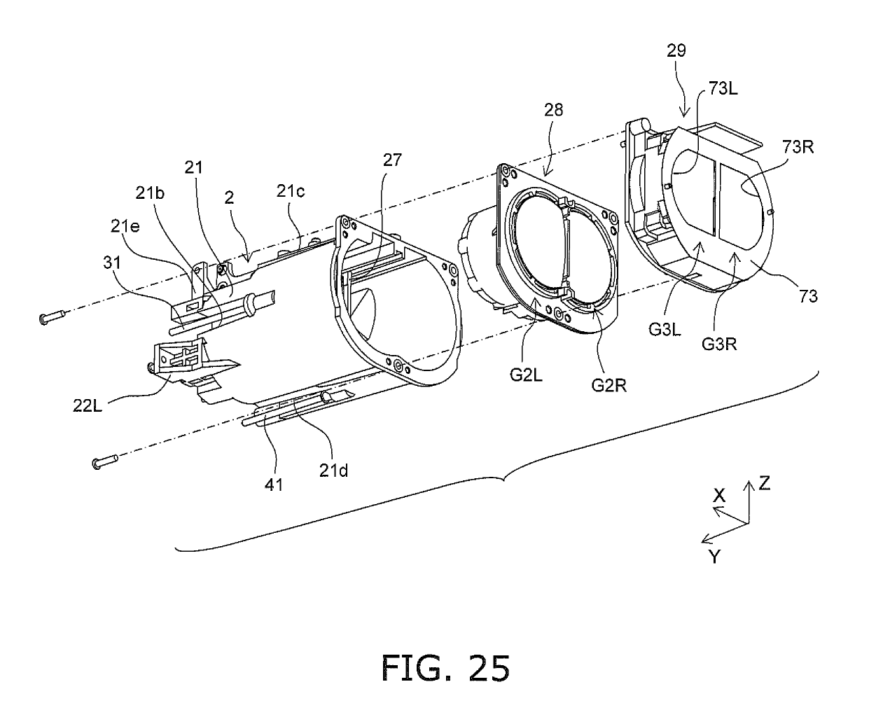

As shown in FIGS. 24 and 25, the intermediate lens frame 28 and the prism support frame 29 are fixed by screws to the rear of the cylindrical frame 21. Part of the intermediate lens frame 28 is inserted into the cylindrical frame 21. As shown in FIG. 25, the light blocking panel 27 is mounted in the interior of the cylindrical frame 21. The space inside the cylindrical frame 21 is partitioned by the light blocking panel 27. FIG. 23 shows how the intermediate lens frame 28 and the prism support frame 29 are fixed to the cylindrical frame 21.

(5) First Adjusting Mechanism 3

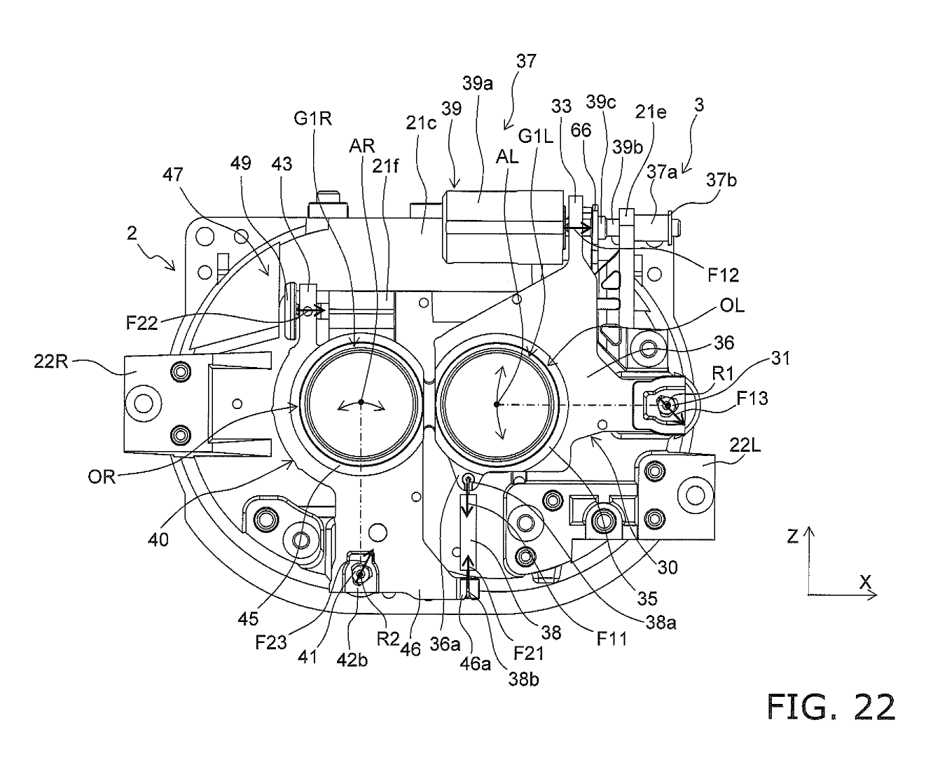

The first adjusting mechanism 3 shown in FIG. 22 is a mechanism for adjusting the vertical relative offset of the left-eye optical image QL1 and the right-eye optical image QR1, and moves the left-eye negative lens group G1L substantially in the Z axis direction (the first direction, and the second adjustment direction) with respect to the main body frame 2 according to a user's operation. The first adjusting mechanism 3 allows the position of the left-eye negative lens group G1L to be adjusted with respect to the main body frame 2. The first adjusting mechanism 3 has the first adjustment frame 30, a first rotary shaft 31, an adjustment spring 38, and a first restricting mechanism 37.

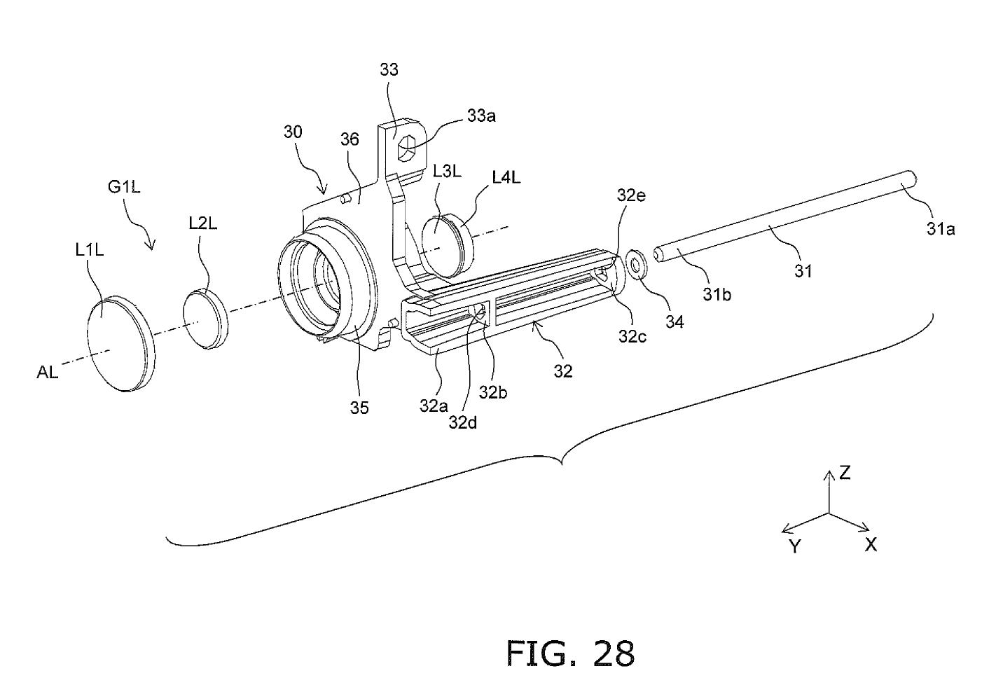

As shown in FIG. 28, the first adjustment frame 30 is supported by the main body frame 2 movably substantially in the Z axis direction (first direction). The first adjustment frame 30 has a first adjustment frame main body 36, a first cylindrical component 35, a first restrictor 33, and a first guide 32.

The first adjustment frame main body 36 is a flat portion. The first cylindrical component 35 protrudes in the Y axis direction from the first adjustment frame main body 36. The left-eye negative lens group G1L is fixed to the first cylindrical component 35. The first restrictor 33 is a flat portion that protrudes in the Z axis direction from the first adjustment frame main body 36, and constitutes part of the first restricting mechanism 37. The first restrictor 33 has a first hole 33a.

The first guide 32 extends in slender form in the Y axis direction, and protrudes in the Y axis direction from the first adjustment frame main body 36. The first guide 32 has a first guide main body 32a, a first front support 32b, and a first rear support 32c. The first guide main body 32a has a substantially U-shaped cross section. The first front support 32b and the first rear support 32c are disposed inside the first guide main body 32a. The first front support 32b has a first front support hole 32d. The first rear support 32c has a first rear support hole 32e.

The first rotary shaft 31 (an example of a rotary support shaft) rotatably links the first adjustment frame 30 to the main body frame 2. More specifically, the first rotary shaft 31 is inserted into the first front support hole 32d and the first rear support hole 32e of the first guide 32 of the first adjustment frame 30. As shown in FIG. 22, if we let the centerline of the first rotary shaft 31 be a first rotational axis R1, the first adjustment frame 30 is supported by the first rotary shaft 31 rotatably around the first rotational axis R1. This allows the left-eye negative lens group GIL to rotate around the first rotational axis R1 with respect to the main body frame 2. The main body frame 2 also has a stopper protrusion 21s. The stopper protrusion 21s is disposed on the Z axis direction negative side (bottom side) of the first adjustment frame 30. When the first adjustment frame 30 rotates counter-clockwise with respect to the main body frame 2, the first adjustment frame 30 comes into contact with the stopper protrusion 21s. The stopper protrusion 21s restricts the rotational angle of the first adjustment frame 30. The stopper protrusion 21s keeps a relative offset adjusting screw 39 of the first restricting mechanism 37 from being turned too far. This will be discussed below.

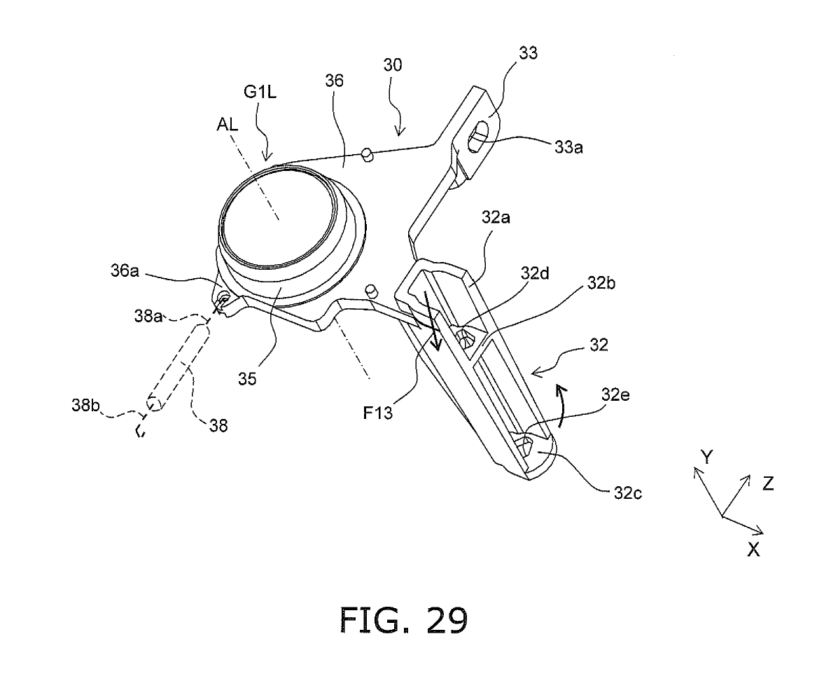

As shown in FIG. 29, the first adjustment frame main body 36 has a first hooking component 36a. A first end 38a of the adjustment spring 38 is hooked in the first hooking component 36a.

As shown in FIG. 23, a first end 31a of the first rotary shaft 31 is fixed to the cylindrical frame 21. A first recess 21b is formed in the cylindrical frame 21. The first recess 21b is a groove extending in the Y axis direction. The first guide 32 of the first adjustment frame 30 is inserted into the first recess 21b. A washer 34 (see FIG. 28) is sandwiched between the first guide 32 and the cylindrical frame 21.

As shown in FIG. 20, a second end 31b of the first rotary shaft 31 is supported by a front support plate 25 fixed to the cylindrical frame 21. That is, the first rotary shaft 31 is supported at both ends.

A variety of forces are exerted on the first rotary shaft 31, and if the second end 31b of the first rotary shaft 31 becomes offset, the position of the first adjustment frame 30 becomes offset with respect to the cylindrical frame 21, and this ends up affecting the vertical relative offset adjustment.

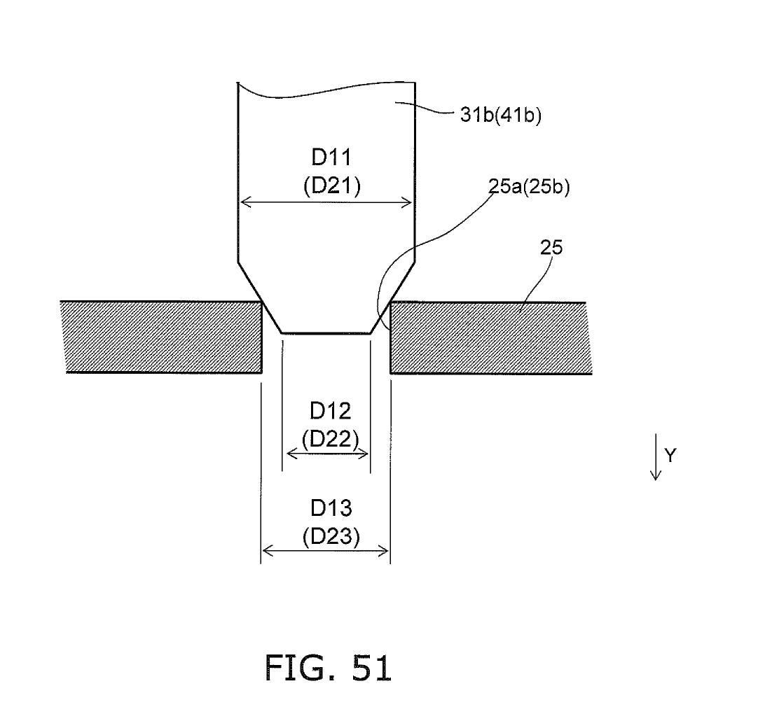

In view of this, the second end 31b of the first rotary shaft 31 is supported very precisely so as not to deviate with respect to the cylindrical frame 21. More specifically, as shown in FIG. 51, the second end 31b of the first rotary shaft 31 has a tapered shape. The front support plate 25 has a support hole 25a. The diameter D13 of the support hole 25a is smaller than the outside diameter D11 of the first rotary shaft 31, and is larger than the diameter D12 of the distal end of the first rotary shaft 31 (the smallest diameter of the tapered surface). In a state in which the second end 31b of the first rotary shaft 31 has been inserted into the support hole 25a, the front support plate 25 bends in the Y axis direction so as to hold the first rotary shaft 31 in place. Therefore, the distal end of the first rotary shaft 31 is less likely to deviate with respect to the cylindrical frame 21. This allows the vertical relative offset to be adjusted more precisely.

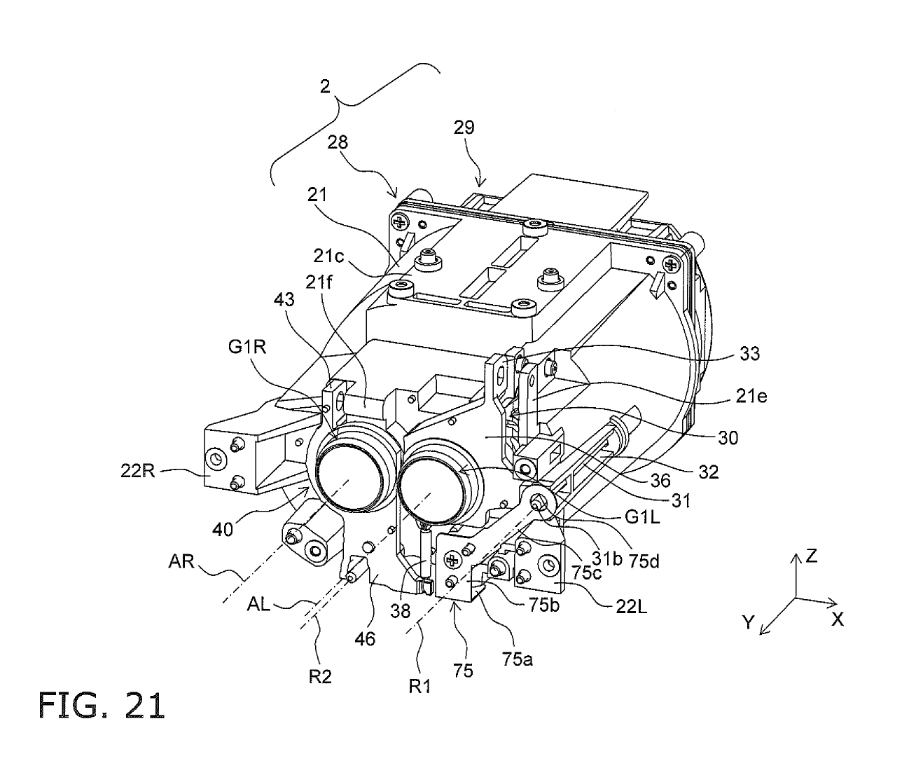

As shown in FIG. 21, the first adjustment frame 30 is held in place in the Y axis direction by a retainer plate 75. More specifically, the retainer plate 75 has a fixed part 75b that is fixed to the main body frame 2, a first leaf spring 75c that protrudes from the fixed part 75b, and a second leaf spring 75a that protrudes from the fixed part 75b. The first leaf spring 75c has a through-hole 75d, and the distal end of the first rotary shaft 31 is inserted into this through-hole 75d. The first leaf spring 75c bends slightly in the Y axis direction, and holds the first guide 32 in place on the Y axis direction negative side. This suppresses movement of the first adjustment frame 30 in the Y axis direction with respect to the main body frame 2. Also, the second leaf spring 75a extends from the fixed part 75b to the Y axis direction negative side, and enters on the bottom side of the main body frame 2. When the main body frame 2 moves to the Z axis direction negative side (bottom side) with respect to the exterior casing 101, the second leaf spring 75a restricts downward movement of the main body frame 2 with respect to the exterior casing 101 so that a threaded component 57c of the vertical position adjustment dial 57 does not come out of the threaded hole of a dial support 51c. This prevents malfunction caused by turning the vertical position adjustment dial 57 too far.

As shown in FIG. 23, the first recess 21b has a cup-shaped aligning component 21g. Although not depicted, the end of the first guide 32 has a shape that is complementary with that of the aligning component 21g. When the end of the first guide 32 is fitted into the aligning component 21g, this stabilizes the position of the first guide 32 in the X axis direction and the Z axis direction. Since the retainer plate 75 presses the first guide 32 against the aligning component 21g, the position of the first adjustment frame 30 with respect to the main body frame 2 is more stable.

As shown in FIG. 22, the first rotary shaft 31 is disposed aligned with the left-eye optical system OL and the right-eye optical system OR in the X axis direction. More specifically, the left-eye optical system OL is disposed between the right-eye optical system OR and the first rotary shaft 31. The first rotational axis R1 is disposed aligned substantially linearly in the X axis direction with the left-eye optical axis AL and the right-eye optical axis AR. Since the first rotary shaft 31 is thus disposed, the left-eye negative lens group G1L moves substantially in the Z axis direction, and the amount of movement of the left-eye negative lens group G1L in the X axis direction can be kept within a negligible range.

The adjustment spring 38 (an example of an adjustment elastic member) is a tension spring, and imparts a rotational force around the first rotary shaft 31 to the first adjustment frame 30. More specifically, when seen from the subject side, the adjustment spring 38 imparts to the first adjustment frame 30 an elastic force F11 toward the Z axis direction negative side (bottom side). As a result, the adjustment spring 38 imparts a counter-clockwise rotational force to the first adjustment frame 30. The adjustment spring 38 elastically links the first adjustment frame 30 and the second adjustment frame 40 (discussed below). The first end 38a of the adjustment spring 38 is hooked to the first hooking component 36a of the first adjustment frame 30. A second end 38b of the adjustment spring 38 is hooked to a second hooking component 46a (discussed below) of the second adjustment frame 40.

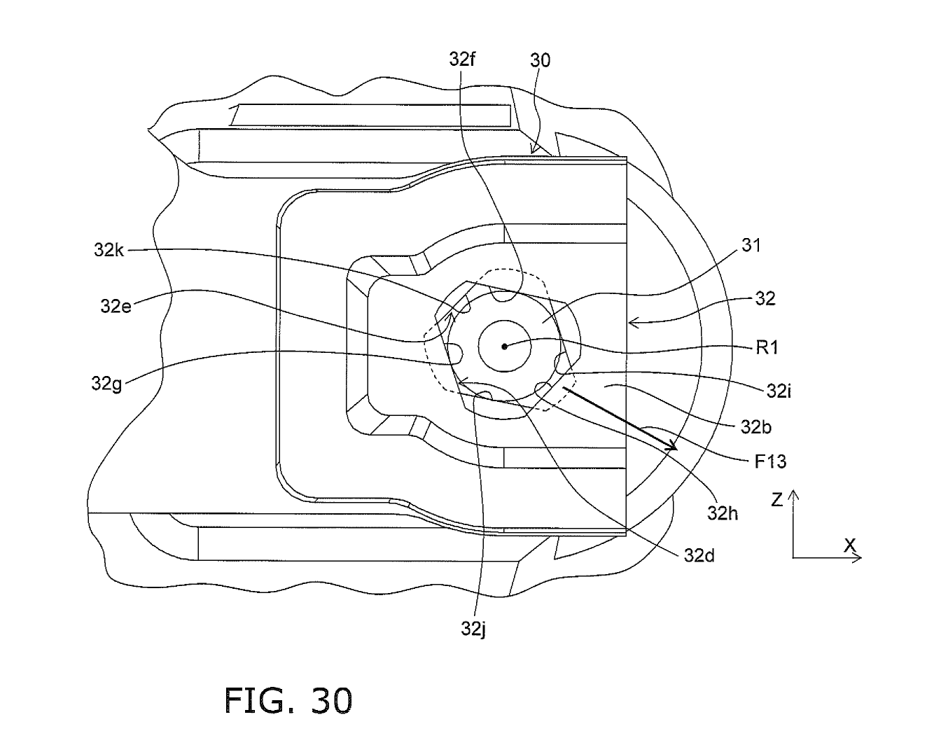

As shown in FIG. 30, the first front support hole 32d and the first rear support hole 32e have a substantially triangular shape, rather than being circular. More specifically, the first front support hole 32d has three straight edges 32f, 32g, and 32h. The straight edges 32f, 32g, and 32h form parts of the respective sides of a triangle, for example. The straight edges 32f and 32g are in contact with the first rotary shaft 31, but the straight edge 32h is not in contact with the first rotary shaft 31.

Meanwhile, the first rear support hole 32e has three straight edges 32i, 32j, and 32k. The straight edges 32i, 32j, and 32k form parts of the respective sides of a triangle, for example. The straight edges 32i and 32j are in contact with the first rotary shaft 31, but the straight edge 32k is not in contact with the first rotary shaft 31.

As shown in FIG. 22, the first adjustment frame 30 is subjected to a combined force F 13 of the elastic force F 11 produced by the adjustment spring 38 and the reaction force F 12 at the first restricting mechanism 37. Therefore, as shown in FIG. 30, this combined force F13 presses the straight edges 32f and 32g of the first front support hole 32d against the first rotary shaft 31. Since the combined force F 13 is also exerted on the first adjustment frame main body 36 disposed ahead of the first front support hole 32d, when the straight edges 32f and 32g of the first front support hole 32d are pressed against the first rotary shaft 31, the first adjustment frame main body 36 moves in the direction of the combined force F13 with the straight edges 32f and 32g serving as fulcrums, and the rear part of the first guide 32 moves in the opposite direction from the combined force F13 (see FIG. 29, for example). Also, when the entire first adjustment frame 30 tries to move under the combined force F13 in the direction of the combined force F13, the position of the rear part of the first guide 32 is supported by the aligning component 21g (see FIG. 23), and as a result the rear part of the first guide 32 moves in the opposite direction from the combined force F13. Therefore, as shown in FIG. 30, in a state in which the straight edges 32f and 32g of the first front support hole 32d are pressed against the first rotary shaft 31, the straight edges 32i and 32j of the first rear support hole 32e are also pressed against the first rotary shaft 31. Since the straight edges 32f, 32g, 32i, and 32j are pressed against the first rotary shaft 31, the first adjustment frame 30 is precisely positioned in the X axis direction and the Z axis direction with respect to the main body frame 2. Therefore, looseness of the first adjustment frame 30 in the X axis direction and the Z axis direction with respect to the main body frame 2 can be suppressed, and vertical relative offset can be adjusted more precisely.

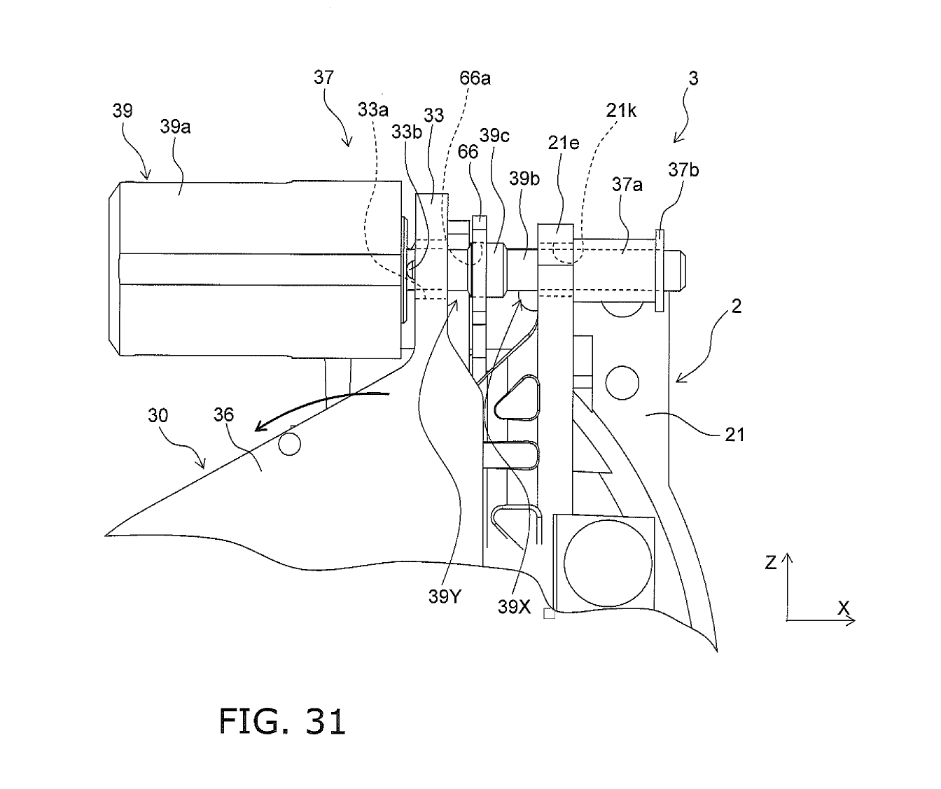

As shown in FIG. 31, the first restricting mechanism 37 (an example of a rotation restricting mechanism) is a mechanism that restricts the rotation of the first adjustment frame 30, and adjusts the position of the left-eye negative lens group G1L with respect to the main body frame 2 by varying the restriction position of the first adjustment frame 30. More specifically, it has the relative offset adjusting screw 39, a first support plate 66, a second support plate 21e, a first return spring 37a, and a first snap ring 37b. The first support plate 66 has a threaded hole 66a, and is fixed to the cylindrical frame 21. The second support plate 21e has a through-hole 21k, and is integrally molded with the cylindrical frame 21. The relative offset adjusting screw 39 has a joint component 39a and a shaft component 39b. The outside diameter of the joint component 39a is larger than the outside diameter of the shaft component 39b. The joint component 39a is mounted to the end of the shaft component 39b. The joint component 39a is linked to a second joint shaft 65 of the manipulation mechanism 6. The joint component 39a and the second joint shaft 65 constitute a universal joint. The shaft component 39b has a threaded component 39c. The threaded component 39c is threaded into the threaded hole 66a of the first support plate 66. When the relative offset adjusting screw 39 is rotated, the relative offset adjusting screw 39 moves in the X axis direction with respect to the main body frame 2. The shaft component 39b is inserted into the through-hole in the second support plate 21e and the first hole 33a in the first restrictor 33. The first snap ring 37b is mounted to the end of the shaft component 39b. The first return spring 37a is fitted over the shaft component 39b, and is compressed between the second support plate 21e and the first snap ring 37b.

The first restrictor 33 of the first adjustment frame 30 hits the joint component 39a. More specifically, a pair of sliding protrusions 33b are formed on the first restrictor 33. The sliding protrusions 33b hit the joint component 39a. Since the first restrictor 33 is pressed against the joint component 39a by the elastic force of the adjustment spring 38, rotation of the first adjustment frame 30 is restricted by the relative offset adjusting screw 39. The position of the left-eye negative lens group G1L in the Z axis direction can be adjusted by varying the restriction position of the first adjustment frame 30 in the rotation direction with the relative offset adjusting screw 39. Also, since the sliding protrusions 33b hit the joint component 39a, sliding resistance can be reduced in rotating the relative offset adjusting screw 39.

Also, since the first return spring 37a is provided, the first support plate 66 can be prevented from coming completely out of the threaded component 39c in the event that the user turns the relative offset adjusting screw 39 too far. More specifically, as shown in FIG. 31, the first adjustment frame 30 comes into contact with the stopper protrusion 21s of the main body frame 2 just before the first support plate 66 reaches a first side 39X of the threaded component 39c, and rotation of the first adjustment frame 30 with respect to the main body frame 2 stops. If the relative offset adjusting screw 39 is turned farther in a state in which the first adjustment frame 30 has hit the stopper protrusion 21s, the first support plate 66 reaches the first side 39X of the threaded component 39c. At this point, since rotation of the first adjustment frame 30 with respect to the main body frame 2 is restricted by the stopper protrusion 21s, the joint component 39a moves away from the sliding protrusions 33b of the first restrictor 33, and the elastic force of the adjustment spring 38 no longer acts on the relative offset adjusting screw 39. Therefore, only the elastic force of the first return spring 37a acts on the relative offset adjusting screw 39, and a state in which the threaded component 39c is in contact with the threaded hole 66a of the first support plate 66 is maintained by the elastic force of the first return spring 37a. If the user turns the relative offset adjusting screw 39 the other way in this state, the threaded component 39c will be threaded back into the threaded hole 66a of the first support plate 66, and a meshed state is maintained between the relative offset adjusting screw 39 and the first support plate 66.

Conversely, if the first support plate 66 reaches a second side 39Y of the threaded component 39c, since the elastic force of the adjustment spring 38 is much greater than the elastic force of the first return spring 37a, a state in which the threaded component 39c is in contact with the threaded hole 66a of the first support plate 66 is maintained by the elastic force of the adjustment spring 38. If the user turns the relative offset adjusting screw 39 the other way in this state, the threaded component 39c is threaded back into the threaded hole 66a of the first support plate 66, and a meshed state is maintained between the relative offset adjusting screw 39 and the first support plate 66.

With the above configuration, even if the user turns the relative offset adjusting screw 39 too far, the first support plate 66 can be prevented from completely coming out of the threaded component 39c. Furthermore, since the threaded component 39c is disposed away from the joint component 39a, damage that would otherwise be caused by turning too far can also be prevented.

(6) Second Adjusting Mechanism 4

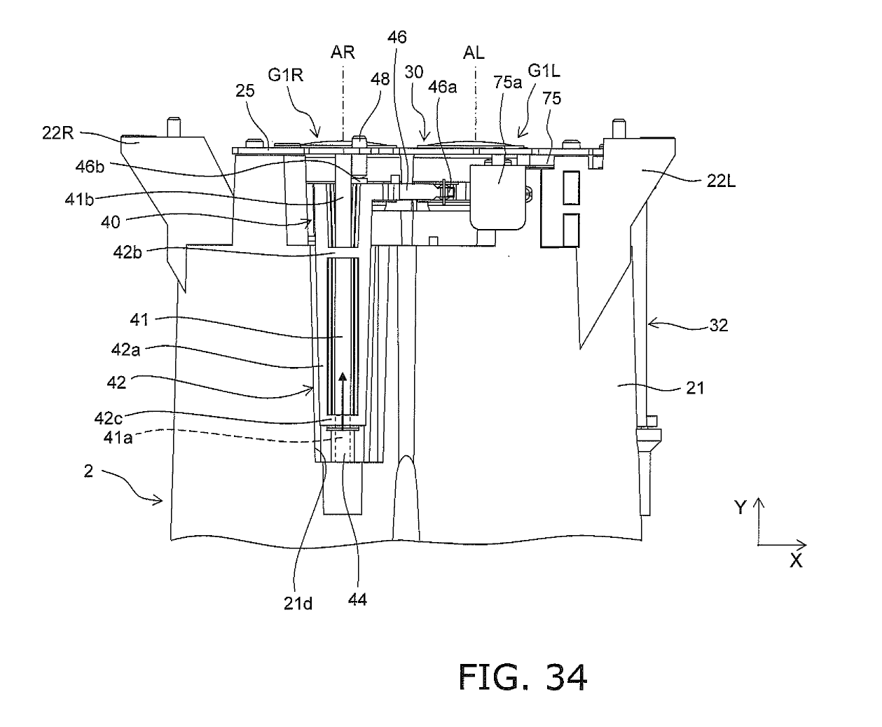

The second adjusting mechanism 4 shown in FIG. 22 is a mechanism for adjusting the convergence angle, and moves the right-eye negative lens group G1R in substantially the X axis direction (second direction, first adjustment direction) with respect to the main body frame 2. The second adjusting mechanism 4 has the second adjustment frame 40, a second rotary shaft 41, a focus adjusting screw 48 (see FIG. 34), a focus adjusting spring 44 (see FIG. 34), and a second restricting mechanism 47.

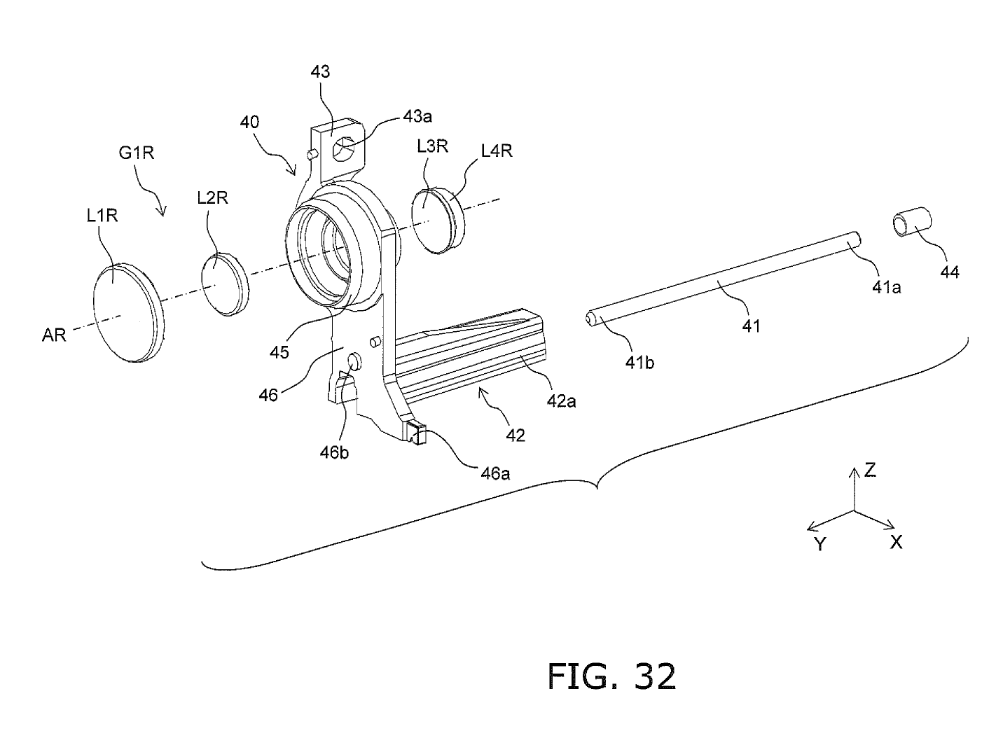

As shown in FIG. 32, the second adjustment frame 40 is supported by the main body frame 2 movably substantially in the X axis direction (first adjustment direction). The second adjustment frame 40 has a second adjustment frame main body 46, a second cylindrical component 45, a second restrictor 43, and a second guide 42.

The second adjustment frame main body 46 is a flat portion, and has the second hooking component 46a and a protrusion 46b. The adjustment spring 38 is hooked to the second hooking component 46a. The protrusion 46b protrudes to the Y axis direction positive side (front side, subject side), and hits the focus adjusting screw 48. Since the diameter of the protrusion 46b is larger than the diameter of the focus adjusting screw 48, even if the second adjustment frame 40 rotates with respect to the main body frame 2, the focus adjusting screw 48 remains in contact with the protrusion 46b. Also, since the distal end of the focus adjusting screw 48 is formed in a hemispherical shape, sliding resistance generated between the protrusion 46b and the focus adjusting screw 48 can be reduced.

The second cylindrical component 45 protrudes in the Y axis direction from the second adjustment frame main body 46. The right-eye negative lens group G1R is fixed to the second cylindrical component 45. The second restrictor 43 is a flat portion protruding in the Z axis direction from the second adjustment frame main body 46, and constitutes part of the second restricting mechanism 47. The second restrictor 43 has a second hole 43a.

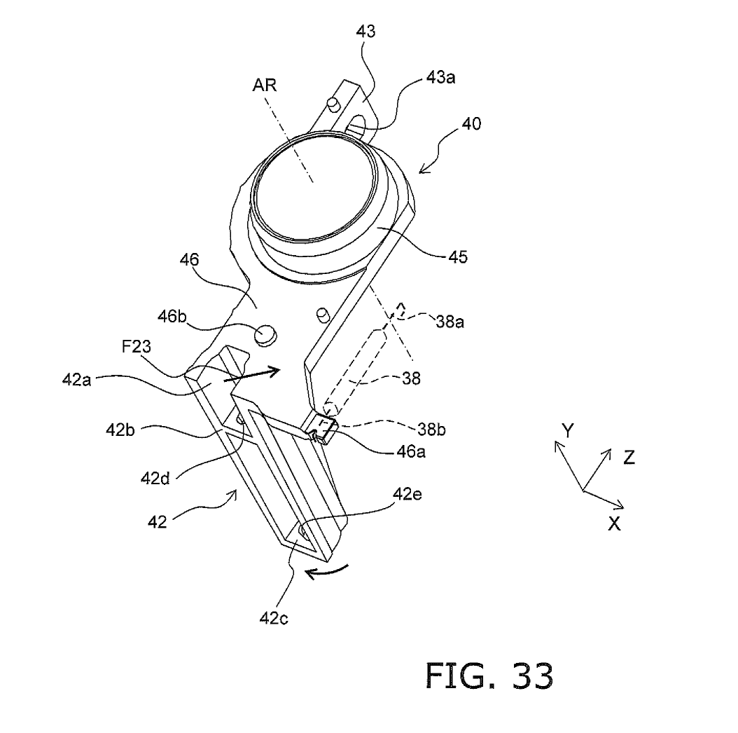

As shown in FIG. 33, the second guide 42 extends in slender form in the Y axis direction, and protrudes in the Y axis direction from the second adjustment frame main body 46. The second guide 42 has a second guide main body 42a, a second front support 42b, and a second rear support 42c. The second guide main body 42a has a substantially U-shaped cross section. The second front support 42b and the second rear support 42c are disposed inside the second guide main body 42a. The second front support 42b has a second front support hole 42d. The second rear support 42c has a second rear support hole 42e.

As shown in FIG. 22, the second end 38b of the adjustment spring 38 (an example of an adjustment elastic member) is hooked to the second hooking component 46a of the second adjustment frame main body 46, and imparts to the second adjustment frame 40 a rotational force around the second rotary shaft 41. More specifically, when seen from the subject side, the adjustment spring 38 imparts to the second adjustment frame 40 an elastic force F21 toward the Z axis direction positive side (up side). As a result, the adjustment spring 38 imparts a counter-clockwise rotational force to the second adjustment frame 40. Since the first end 38a is hooked to the first adjustment frame 30, and the second end 38b is hooked to the second adjustment frame 40, the adjustment spring 38 can be said to elastically link the first adjustment frame 30 and the second adjustment frame 40.

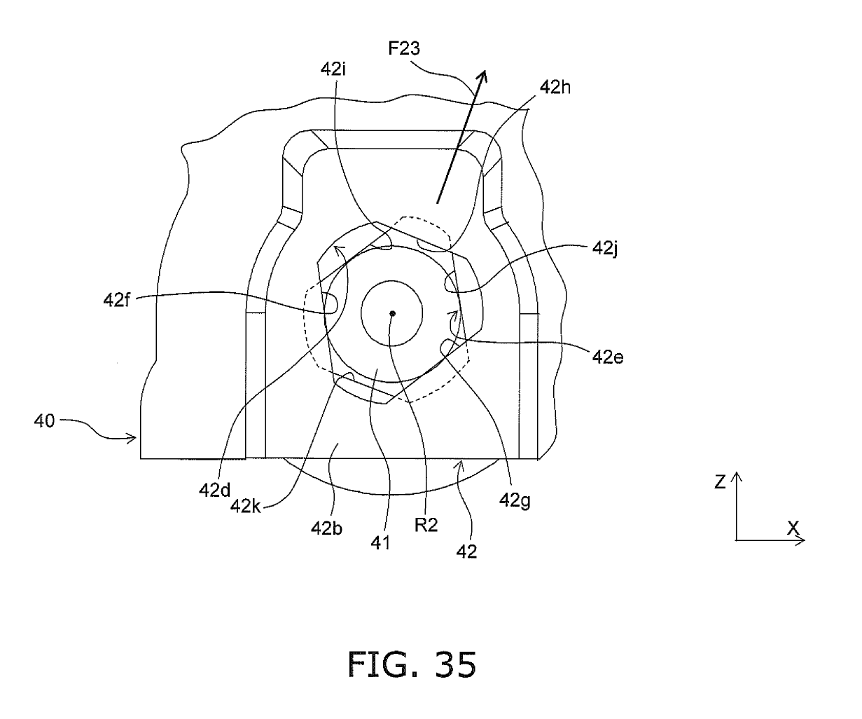

As shown in FIG. 35, the second rotary shaft 41 (an example of an adjusting rotary shaft) rotatably links the second adjustment frame 40 to the main body frame 2. More specifically, the second rotary shaft 41 is inserted into the second front support hole 42d and the second rear support hole 42e of the second guide 42 of the second adjustment frame 40.

As shown in FIG. 34, a second recess 21d is formed in the cylindrical frame 21. The second recess 21d is a groove extending in the Y axis direction. The second rotary shaft 41 and the second guide 42 of the second adjustment frame 40 are inserted into the second recess 21d. A first end 41a of the second rotary shaft 41 is fixed to the cylindrical frame 21. As shown in FIG. 20, a second end 41b of the second rotary shaft 41 is supported by the front support plate 25 fixed to the cylindrical frame 21. That is, the second rotary shaft 41 is supported at both ends.

A variety of forces are exerted on the second rotary shaft 41, and if the second end 41b of the second rotary shaft 41 becomes offset, the position of the second adjustment frame 40 becomes offset with respect to the cylindrical frame 21, and this ends up affecting the convergence angle adjustment.

In view of this, the second end 41b of the second rotary shaft 41 is supported very precisely so as not to deviate with respect to the cylindrical frame 21. More specifically, as shown in FIG. 51, the second end 41b of the second rotary shaft 41 has a tapered shape. The front support plate 25 has a support hole 25b. The diameter D23 of the support hole 25b is smaller than the outside diameter D21 of the second rotary shaft 41, and is larger than the diameter D22 of the distal end of the second rotary shaft 41 (the smallest diameter of the tapered surface). In a state in which the second end 41b of the second rotary shaft 41 has been inserted into the support hole 25b, the front support plate 25 bends in the Y axis direction so as to hold the second rotary shaft 41 in place. Therefore, the distal end of the second rotary shaft 41 is less likely to deviate with respect to the cylindrical frame 21. This allows the convergence angle to be adjusted more precisely.

As shown in FIG. 22, if we let the centerline of the second rotary shaft 41 be a second rotational axis R2, the second adjustment frame 40 is supported by the second rotary shaft 41 rotatably around the second rotational axis R2. This allows the right-eye negative lens group G1R to rotate around the second rotational axis R2 with respect to the main body frame 2.

The second adjusting mechanism 4 also has the function of adjusting the back focus of the right-eye optical system OR. More specifically, as shown in FIG. 34, the second rotary shaft 41 is inserted into the focus adjusting spring 44. The focus adjusting spring 44 is compressed between the second guide 42 and the cylindrical frame 21, and presses the second adjustment frame 40 against the focus adjusting screw 48 mounted to the front support plate 25. The front support plate 25 is fixed to the front side of the cylindrical frame 21. The focus adjusting screw 48 is threaded into the front panel 71. The focus adjusting screw 48 restricts movement of the second adjustment frame 40 in the Y axis direction. The position of the right-eye negative lens group G1R in the Y axis direction with respect to the main body frame 2 can be adjusted by varying the restriction position of the second adjustment frame 40. This allows the focus of the right-eye optical system OR to be adjusted. Therefore, even if the left-eye optical system OL and the right-eye optical system OR should go out of focus, the focus of the left-eye optical system OL and the right-eye optical system OR can be adjusted before the product is shipped by turning the focus adjusting screw 48. Since the user does not need to adjust the focus of the left-eye optical system OL and the right-eye optical system OR, after adjustment and before shipping, the focus adjusting screw 48 is adhesively fixed to the front panel 71, for example. However, the design may instead be such that the user can adjust the focus.

As shown in FIG. 22, the second rotary shaft 41 is disposed aligned with the right-eye optical system OR in the Z axis direction. More specifically, when seen from the subject side, a line connecting the left-eye optical axis AL and the right-eye optical axis AR is perpendicular to a line connecting the right-eye optical axis AR and the second rotational axis R2. Because the second rotary shaft 41 is thus disposed, the right-eye negative lens group G1R moves substantially in the X axis direction, and the amount of movement of the right-eye negative lens group G1R in the Z axis direction can be kept within a negligible range. For example, if the adjustment range of the right-eye negative lens group G1R in the X axis direction is about ±0.2 mm, the right-eye negative lens group G1R will move hardly at all in the Z axis direction. This configuration allows the convergence angle to be adjusted with a simple structure.

As shown in FIG. 35, the second front support hole 42d and the second rear support hole 42e have a substantially triangular shape, rather than being circular. More specifically, the second front support hole 42d has three straight edges 42f, 42g, and 42h. These straight edges 42f, 42g, and 42h each form part of a side of a triangle, for example. The straight edges 42f and 42g are in contact with the second rotary shaft 41, but the straight edge 42h does not touch the second rotary shaft 41.

Meanwhile, the second rear support hole 42e has three straight edges 42i, 42j, and 42k. These straight edges 42i, 42j, and 42k each form part of a side of a triangle, for example. The straight edges 42i and 42j are in contact with the second rotary shaft 41, but the straight edge 42k does not touch the second rotary shaft 41.

As shown in FIG. 22, a combined force F23 of the elastic force F21 produced by the adjusting spring 38 and a reaction force F22 from the second restricting mechanism 47 is exerted on the second adjustment frame 40. Therefore, the straight edges 42f and 42g of the second front support hole 42d are pressed against the second rotary shaft 41 by this combined force F23. Since the combined force F23 acts on the second adjustment frame main body 46 disposed ahead of the second front support hole 42d, when the straight edges 42f and 42f of the second front support hole 42d are pressed against the second rotary shaft 41, the straight edges 42f and 42f act as fulcrums as the second adjustment frame main body 46 moves in the direction of the combined force F23, while the rear part of the second guide 42 moves in the opposite direction from that of the combined force F23 (see FIG. 33, for example). Therefore, as shown in FIG. 35, in a state in which the straight edges 42f and 42f of the second front support hole 42d are pressed against the second rotary shaft 41, the straight edges 42i and 42j of the second rear support hole 42e are also pressed against the second rotary shaft 41. Since the straight edges 42f, 42g, 42i, and 42j are pressed against the second rotary shaft 41, the second adjustment frame 40 is precisely positioned in the X axis direction and the Z axis direction with respect to the main body frame 2. Therefore, looseness of the second adjustment frame 40 in the X axis direction and the Z axis direction with respect to the main body frame 2 can be suppressed, and vertical relative offset can be adjusted more precisely.

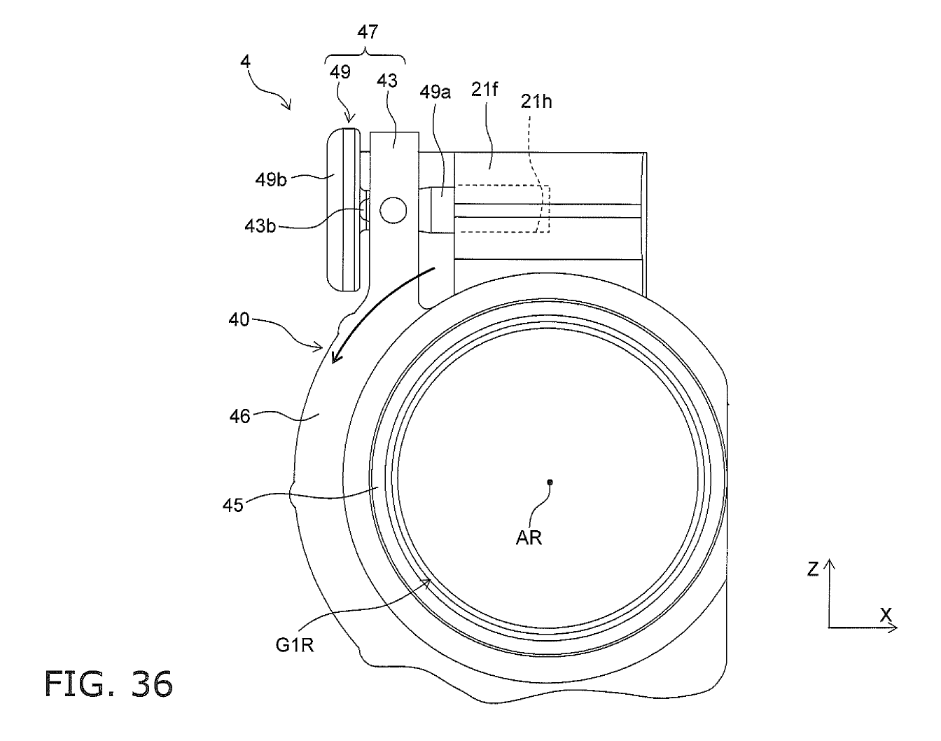

As shown in FIG. 36, the second restricting mechanism 47 (an example of a positioning mechanism) is a mechanism for restricting the rotation of the second adjustment frame 40, and the position of the right-eye negative lens group G1R with respect to the main body frame 2 is adjusted by varying the restriction position of the second adjustment frame 40. More specifically, the second restricting mechanism 47 has a convergence angle adjusting screw 49 and a support 21f.

The support 21f is formed on the cylindrical frame 21. A threaded hole 21h is formed in the support 21f. The convergence angle adjusting screw 49 has a threaded component 49a and a head component 49b. The threaded component 49a is inserted into the second hole 43a of the second restrictor 43, and is threaded into the threaded hole 21h of the support 21f. The threaded component 49a is inserted into the second hole 43a of the second restrictor 43. When the convergence angle adjusting screw 49 is rotated, the convergence angle adjusting screw 49 moves in the X axis direction with respect to the main body frame 2.

The second restrictor 43 of the second adjustment frame 40 hits the head component 49b. More specifically, a pair of sliding protrusions 43b is formed on the second restrictor 43. Since a counter-clockwise rotational force is imparted by the adjusting spring 38 to the second adjustment frame 40, the second restrictor 43 is pressed against the head component 49b, and the sliding protrusions 43b hit the head component 49b. The rotation of the second adjustment frame 40 is restricted by the convergence angle adjusting screw 49. The position of the right-eye negative lens group G1R in the X axis direction can be adjusted by changing the restriction position of the second adjustment frame 40 in the rotational direction with the convergence angle adjusting screw 49. Also, since the sliding protrusions 43b hit the head component 49b, sliding resistance can be reduced when the convergence angle adjusting screw 49 is rotated.

(7) Third Adjustment Mechanism 5

The third adjustment mechanism 5 (an example of a main body frame adjusting mechanism, and an example of an overall adjusting mechanism) is a mechanism for adjusting the positions of the left-eye optical image QL1 and the right-eye optical image QR1 (see FIG. 6) in the vertical direction (the pitch direction) and the horizontal direction (the yaw direction) with respect to the light receiving face 110a of the CMOS image sensor 110. The third adjusting mechanism 5 is able to adjust the position and orientation of the main body frame 2 with respect to the exterior casing 101, and is further able to adjust the position and orientation of the left-eye optical axis AL and the right-eye optical axis AR with respect to the optical axis A0 of the optical system V. The vertical position and the horizontal position of the left-eye optical image QL1 and the right-eye optical image QR1 can be adjusted with the third adjustment mechanism 5 by moving the left-eye optical system OL and the right-eye optical system OR with respect to the exterior casing 101.

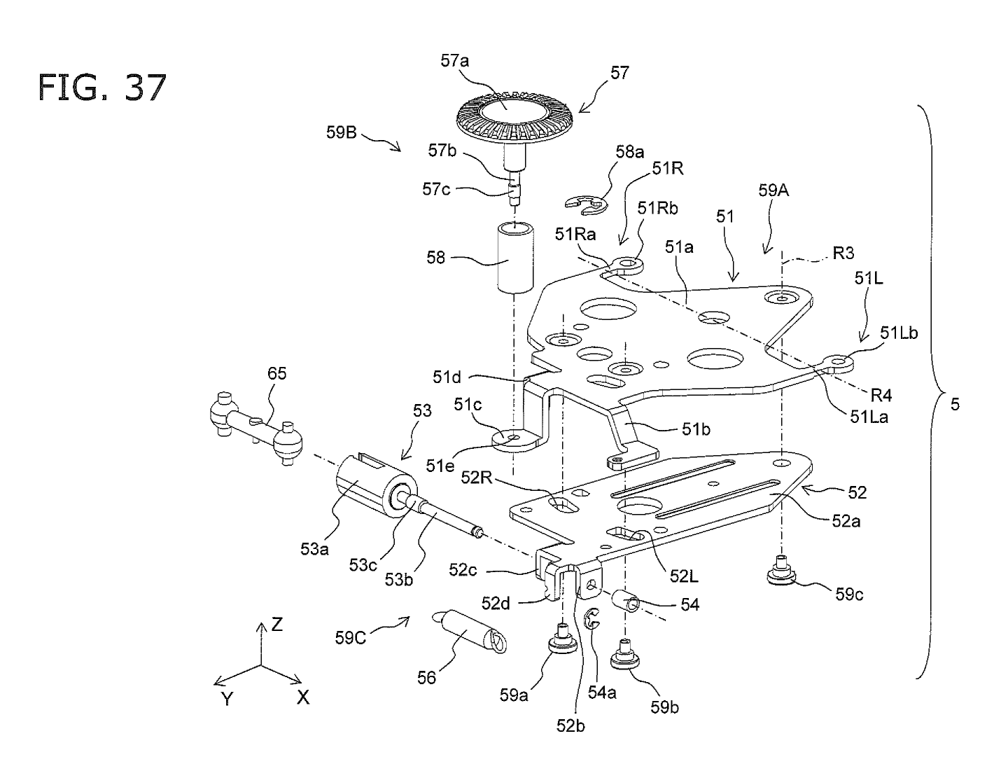

More specifically, as shown in FIG. 37, the third adjustment mechanism 5 has an elastic linking mechanism 59A, a first movement restricting mechanism 59B, and a second movement restricting mechanism 59C.

The elastic linking mechanism 59A is a mechanism that imparts a force in the Z axis direction (the second adjustment direction) to the main body frame 2, and links the main body frame 2 to the exterior casing 101 rotatably around the rotational axis R4. In this embodiment, the elastic linking mechanism 59A imparts a force to the Z axis direction negative side (bottom side) to the main body frame 2.

The elastic linking mechanism 59A also imparts a force in the X axis direction (the first adjustment direction) to the main body frame 2, and links the main body frame 2 to the exterior casing 101 rotatably around the rotational axis R3 (an example of an optical system rotational axis). In this embodiment, the elastic linking mechanism 59A imparts a force to the X axis direction negative side to the main body frame 2.

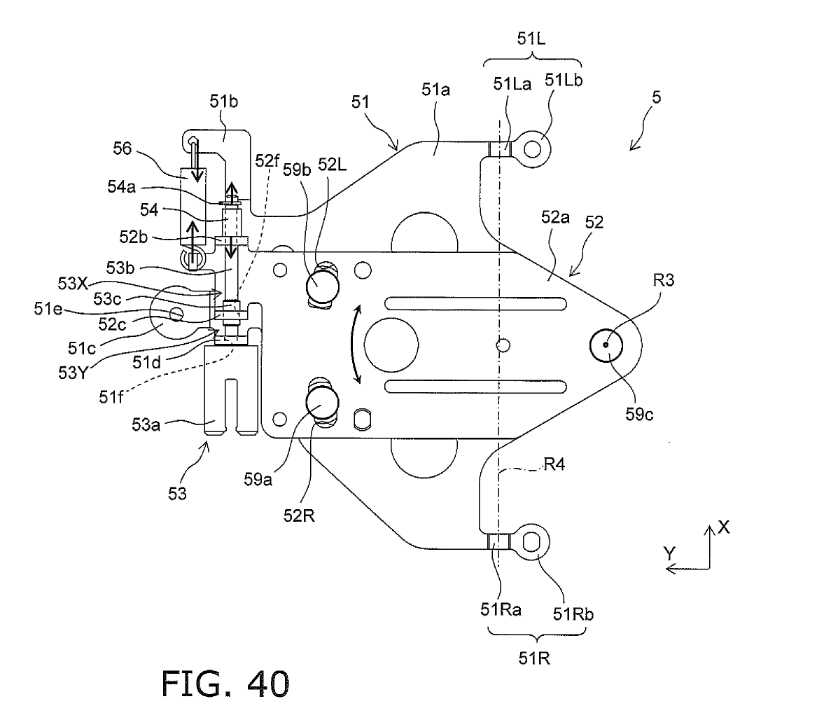

The rotational axis R3 here is disposed parallel to the Z axis. The rotational axis R4 is disposed substantially parallel to the X axis direction, and can be defined by the area around a first elastic support 51L and a second elastic support 51R of a first linking plate 51. More precisely, as shown in FIG. 40, the rotational axis R4 can be defined by the area around a first elastic component 51La of the first elastic support 51L and a second elastic component 51Ra of the second elastic support 51R.

The elastic linking mechanism 59A has a first linking plate 51, the second linking plate 52, a first linking spring 56, and a second linking spring 58. The first linking plate 51 elastically links the main body frame 2 to the exterior casing 101, and is fixed to the exterior casing 101. More specifically, the first linking plate 51 has a first main body component 51a, the first elastic support 51L, the second elastic support 51R, a first support arm 51b, a first contact component 51d, and the dial support 51c.

The first elastic support 51L protrudes to the Y axis direction negative side from the first main body component 51a, and is fixed to the exterior casing 101. The second elastic support 51R protrudes to the Y axis direction negative side from the first main body component 51a, and is fixed to the exterior casing 101. In this embodiment, the first elastic support 51L has substantially the same shape as the second elastic support 51R.

The first elastic support 51L has a first fixing component 51Lb and the first elastic component 51La. The first fixing component 51Lb is fixed to the exterior casing 101. More precisely, the first fixing component 51Lb is fixed to the upper case 11 via an intermediate plate 11L (see FIG. 10). The first elastic component 51La elastically links the first fixing component 51Lb and the first main body component 51a. The first elastic component 51La is compressed in the Z axis direction by stamping, for example, and the first elastic component 51La is thinner than the first fixing component 51Lb and the first main body component 51a. Therefore, the stiffness of the first elastic component 51La (more precisely, the stiffness in the Z axis direction) is much lower than that of the first main body component 51a.

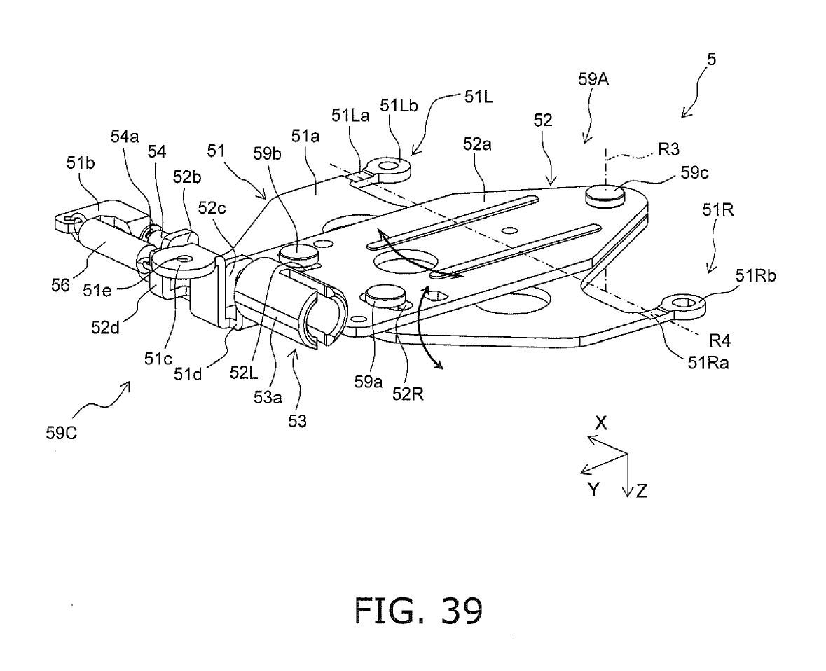

The second elastic support 51R has a second fixing component 51Rb and a second elastic component 51Ra. The second fixing component 51Rb is fixed to the exterior casing 101. More precisely, the second fixing component 51Rb is fixed to the upper case 11 via an intermediate plate 11R (see FIG. 10). The second elastic component 51Ra elastically links the second fixing component 51Rb and a second main body component 52a. As shown in FIG. 39, the second elastic component 51Ra is compressed in the Z axis direction by stamping, for example, and the second elastic component 51Ra is thinner than the second fixing component 51Rb and the second main body component 52a. Therefore, the stiffness of the second elastic component 51Ra (more precisely, the stiffness in the Z axis direction) is lower than that of the second main body component 52a. Since the stiffness of the first elastic component 51La and the second elastic component 51Ra is lower, when the main body frame 2 is subjected to a force in the Z axis direction, the first elastic component 51La and the second elastic component 51Ra undergo elastic deformation. Therefore, the rotational axis R4 can be defined by the central area in the Y axis direction of the first elastic component 51La and the second elastic component 51Ra.

In this embodiment, since the thickness of the first elastic component 51La is set to be substantially the same as the thickness of the second elastic component 51Ra, the stiffness of the first elastic component 51La is substantially the same as the stiffness of the second elastic component 51Ra.

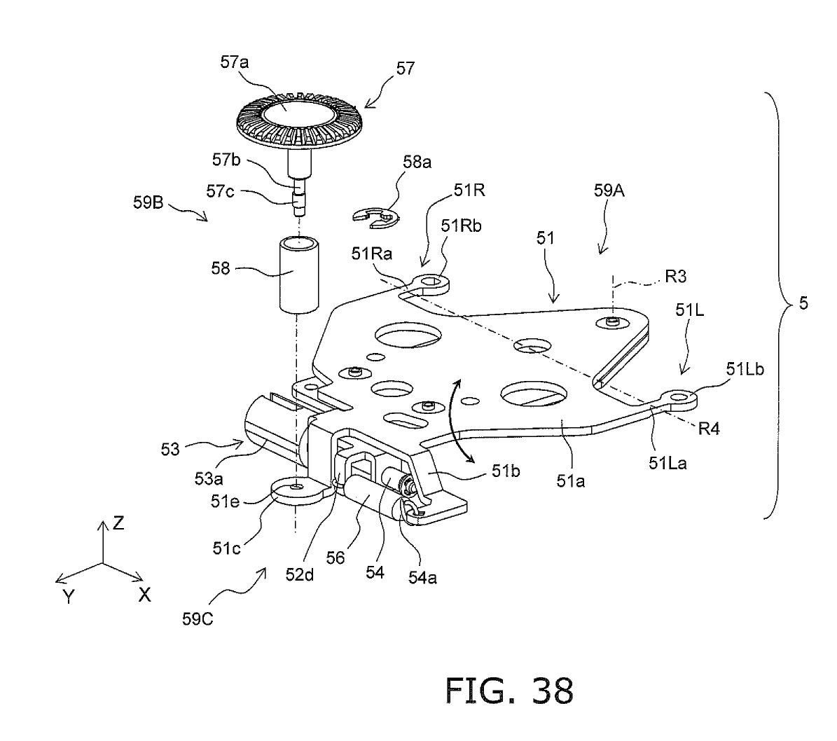

As shown in FIG. 40, the first support arm 51b extends from the first main body component 51a. The end of the first linking spring 56 is hooked to the first support arm 51b. The first contact component 51d hits a horizontal position adjusting screw 53 in the X axis direction. A hole 51f is formed in the first contact component 51d, and a shaft component 53b of the horizontal position adjusting screw 53 is inserted into this hole 51f. As shown in FIG. 38, the dial support 51c has a threaded hole 51e, and the threaded component 57c of the vertical position adjustment dial 57 is threaded into this threaded hole 51e.

The second linking plate 52 is rotatably linked to the first linking plate 51, and is fixed to the seat component 21c of the main body frame 2 (see FIG. 20, for example). The second linking plate 52 is linked to the first linking plate 51 by a rivet 59c rotatably around the rotational axis R3.

As shown in FIG. 37, the second linking plate 52 has the second main body component 52a, a second support arm 52d, a second contact component 52b, and a support 52c. The second main body component 52a is linked to the first linking plate 51 by the rivet 59c rotatably around the rotational axis R3. The second main body component 52a is also fixed to the seat component 21c of the main body frame 2. This allows the main body frame 2 to rotate around the rotational axis R3 with respect to the exterior casing 101.

The second main body component 52a has a pair of slots 52L and 52R. The first linking plate 51 and the second linking plate 52 are linked in the Z axis direction by two rivets 59a and 59b. The rivet 59b is inserted into the slot 52L, and the rivet 59a is inserted into the slot 52R. When the horizontal position adjusting screw 53 is turned, the second linking plate 52 rotates with respect to the first linking plate 51, but if the horizontal position adjusting screw 53 is turned too far, the rivet 59b hits the edge 52La of the slot 52L, and the rotation of the second linking plate 52 with respect to the first linking plate 51 stops (discussed below). Meanwhile, the size of the slot 52R is set so as not to interfere with the rivet 59b.

As shown in FIG. 40, the end of the first linking spring 56 is hooked to the second support arm 52d. The first support arm 51b and the second support arm 52d are pulled toward each other by the first linking spring 56. This imparts rotational force around the rotational axis R3 to the main body frame 2.

The second contact component 52b hits a second return spring 54. The second return spring 54 is sandwiched between the second contact component 52b and a second snap ring 54a mounted to the distal end of the shaft component 53b. The horizontal position adjusting screw 53 is pulled by the second return spring 54 to the X axis direction positive side with respect to the second linking plate 52.

As shown in FIG. 37, the first movement restricting mechanism 59B is a mechanism that restricts the movement of the main body frame 2 in the Z axis direction (first direction) with respect to the exterior casing 101, and adjusts the position of the main body frame 2 with respect to the exterior casing 101 by changing the restriction position of the main body frame 2. More specifically, the first movement restricting mechanism 59B has the vertical position adjustment dial 57 and a snap ring 58a. The vertical position adjustment dial 57 has a dial component 57a and a shaft component 57b. The vertical position adjustment dial 57 is mounted to the upper case 11. More specifically, the shaft component 57b is inserted into a hole 11d in the upper case 11 (see FIG. 11), and the vertical position adjustment dial 57 is able to rotate with respect to the upper case 11. Also, the snap ring 58a is mounted to the base of the shaft component 57b, and the second linking spring 58 is sandwiched in a compressed state between the snap ring 58a and the upper case 11. Therefore, the dial component 57a is always pressed against the upper case 11, and the position of the vertical position adjustment dial 57 in the Z axis direction with respect to the upper case 11 is stable. Also, the vertical position adjustment dial 57 does not fall out of the upper case 11.

The threaded component 57c of the shaft component 57b is threaded into the threaded hole 51e of the dial support 51c. When the vertical position adjustment dial 57 is turned, the dial support 51c moves in the Z axis direction. Thus, movement of the main body frame 2 in the Z axis direction with respect to the exterior casing 101 (more precisely, rotation around the rotational axis R4) is restricted by the vertical position adjustment dial 57. Since the restriction position of the main body frame 2 with respect to the exterior casing 101 changes when the vertical position adjustment dial 57 is turned, the up and down angle of the main body frame 2 with respect to the exterior casing 101 can be adjusted.

As shown in FIG. 37, the second movement restricting mechanism 59C is a mechanism that restricts the movement of the main body frame 2 in the X axis direction (first adjustment direction) with respect to the exterior casing 101, and adjusts the position of the main body frame 2 with respect to the exterior casing 101 by changing the restriction position of the main body frame 2. More specifically, the second movement restricting mechanism 59C has the horizontal position adjusting screw 53, the second return spring 54, and the second snap ring 54a. The horizontal position adjusting screw 53 has a joint component 53a and the shaft component 53b. The outside diameter of the joint component 53a is larger than the outside diameter of the shaft component 53b. The joint component 53a is mounted to the end of the shaft component 53b. The joint component 53a and the second joint shaft 65 constitute a universal joint.

As shown in FIG. 40, the joint component 53a hits the first contact component 51d of the first linking plate 51. The joint component 53a is pressed against the first contact component 51d by the elastic force of the first linking spring 56. The shaft component 53b has a threaded component 53c. The threaded component 53c is threaded into a threaded hole 52f in the support 52c. When the horizontal position adjusting screw 53 is turned, the horizontal position adjusting screw 53 moves in the X axis direction with respect to the main body frame 2. Since the first contact component 51d is pressed against the shaft component 53b by the elastic force of the first linking spring 56, when the horizontal position adjusting screw 53 is turned, the second linking plate 52 rotates around the rotational axis R3 with respect to the first linking plate 51. When the second linking plate 52 rotates around the rotational axis R3 with respect to the first linking plate 51, the main body frame 2 rotates around the rotational axis R3 with respect to the exterior casing 101 (see FIG. 19). Thus, the position of the main body frame 2 in the X axis direction with respect to the exterior casing 101 can be adjusted by changing the restriction position of the second linking plate 52 in the rotational direction with the horizontal position adjusting screw 53. More precisely, the rotational position (orientation) of the main body frame 2 with respect to the exterior casing 101 can be adjusted.

Also, since the second return spring 54 is provided, if the user should turn the horizontal position adjusting screw 53 too far, the support 52c can be prevented from completely falling out of the threaded component 53c. More specifically, as shown in FIG. 40, the rivet 59b hits the edge 52La of the slot 52L, and the rotation of the second linking plate 52 with respect to the first linking plate 51 stops, just before the support 52c reaches the first side 53X of the threaded component 53c. If the horizontal position adjusting screw 53 is turned farther in a state in which the rivet 59b has hit the edge 52La, the support 52c arrives at the first side 53X of the threaded component 53c. At this point, since the rotation of the second linking plate 52 with respect to the first linking plate 51 is restricted by the rivet 59b, the horizontal position adjusting screw 53 moves to the X axis direction negative side with respect to the second linking plate 52, the joint component 53a moves away from the first contact component 51d, the elastic force of the first linking spring 56 no longer acts on the horizontal position adjusting screw 53, and a state in which the threaded component 53c is in contact with the support 52c is maintained by the elastic force of the second return spring 54. If the user turns the horizontal position adjusting screw 53 the other way in this state, the threaded component 53c is threaded back into the threaded hole 52f of the support 52c, and a meshed state is maintained between the horizontal position adjusting screw 53 and the support 52c.

Conversely, if the support 52c moves to a second side 53Y of the threaded component 53c, since the elastic force of the first linking spring 56 is much greater than the elastic force of the second return spring 54, a state in which the threaded component 53c is in contact with the threaded hole 52f of the support 52c is maintained by the elastic force of the first linking spring 56. If the user turns the horizontal position adjusting screw 53 the other way in this state, the threaded component 53c is threaded back into the threaded hole 52f of the support 52c, and a meshed state is maintained between the horizontal position adjusting screw 53 and the support 52c.

With the above configuration, even if the user turns the horizontal position adjusting screw 53 too far, the support 52c can be prevented from completely coming out of the threaded component 53c. Furthermore, since the threaded component 53c is disposed away from the joint component 53a, damage that would otherwise be caused by turning too far can also be prevented.

Furthermore, when the vertical position adjustment dial 57 is turned, the main body frame 2 rotates around the rotational axis R4 with respect to the exterior casing 101, but if the main body frame 2 moves too far to the Z axis direction negative side (bottom side), the threaded component 57c of the vertical position adjustment dial 57 may come out of the threaded hole 51e in the dial support 51c.

However, since the second leaf spring 75a of the retainer plate 75 is designed to come into contact with the exterior casing 101 just before the threaded component 57c comes out of the threaded hole 51e, even if the threaded component 57c should come out of the threaded hole 51e, the threaded hole 51e will be pressed against the threaded component 57c by the elastic force of the second leaf spring 75a. If the vertical position adjustment dial 57 is turned the other way in this state, the threaded component 57c is threaded into the threaded hole 51e. Thus, even if the threaded component 57c comes out of the threaded hole 51e because the vertical position adjustment dial 57 is turned too far, the original state can be returned to merely by turning the vertical position adjustment dial 57 in the other direction, so malfunction caused by turning the vertical position adjustment dial 57 too far can be prevented by the second leaf spring 75a.

(8) Manipulation Mechanism 6

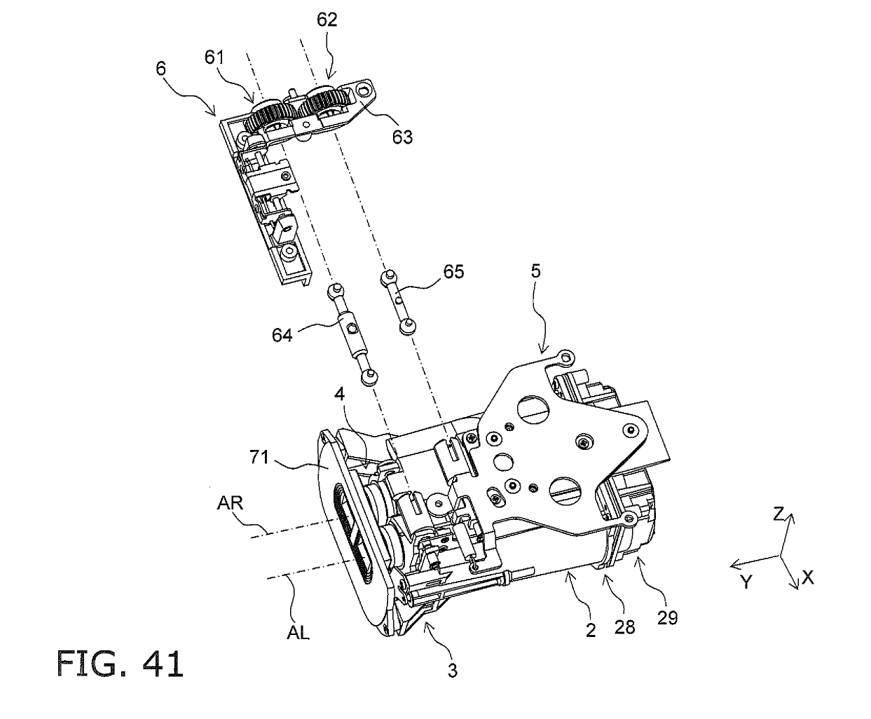

As shown in FIG. 41, the manipulation mechanism 6 has a support frame 63, the relative offset adjustment dial 61, the horizontal position adjustment dial 62, a first joint shaft 64, and the second joint shaft 65.

The support frame 63 is fixed to the top face of the main body frame 2. The relative offset adjustment dial 61 and the horizontal position adjustment dial 62 are rotatably supported by the support frame 63. In a state in which the cover 15 has been opened, part of the relative offset adjustment dial 61 and part of the horizontal position adjustment dial 62 are exposed to the outside through a first opening 11b and a second opening 11c in the upper case 11 (see FIGS. 9 and 11). When the cover 15 is opened, the user can operate the relative offset adjustment dial 61 and the horizontal position adjustment dial 62.

As shown in FIG. 41, the first joint shaft 64 is inserted into the relative offset adjustment dial 61. The second joint shaft 65 is inserted into the horizontal position adjustment dial 62. The rotation of the relative offset adjustment dial 61 is transmitted through the first joint shaft 64 to the relative offset adjustment screw 39. The rotation of the horizontal position adjustment dial 62 is transmitted through the second joint shaft 65 to the horizontal position adjusting screw 53. When the relative offset adjustment dial 61 is turned, vertical relative offset of the left- and right-eye images can be adjusted. When the horizontal position adjustment dial 62 is turned, the positions of the left-eye optical image QL1 and the right-eye optical image QR1 in the horizontal direction with respect to the CMOS image sensor 110 can be adjusted. When the vertical position adjustment dial 57 (FIG. 38) is turned, the positions of the left-eye optical image QL1 and the right-eye optical image QR1 in the vertical direction with respect to the CMOS image sensor 110 can be adjusted.

### Stereo Images

We will now describe the left-eye optical image QL1 and right-eye optical image QR1 formed on the CMOS image sensor 110 when the 3D adapter 100 is mounted to the video camera 200.

The two optical images shown in FIG. 6 are formed on the CMOS image sensor 110 of the video camera 200. More specifically, the left-eye optical image QL1 is formed by the left-eye optical system OL, and the right-eye optical image QR1 is formed by the right-eye optical system OR. FIG. 6 shows the optical images on the CMOS image sensor 110 as seen from the rear face side (image side). The right and left positions of the left-eye optical image QL1 and the right-eye optical image QR1 are switched, and the images are inverted up and down, by the optical system V.

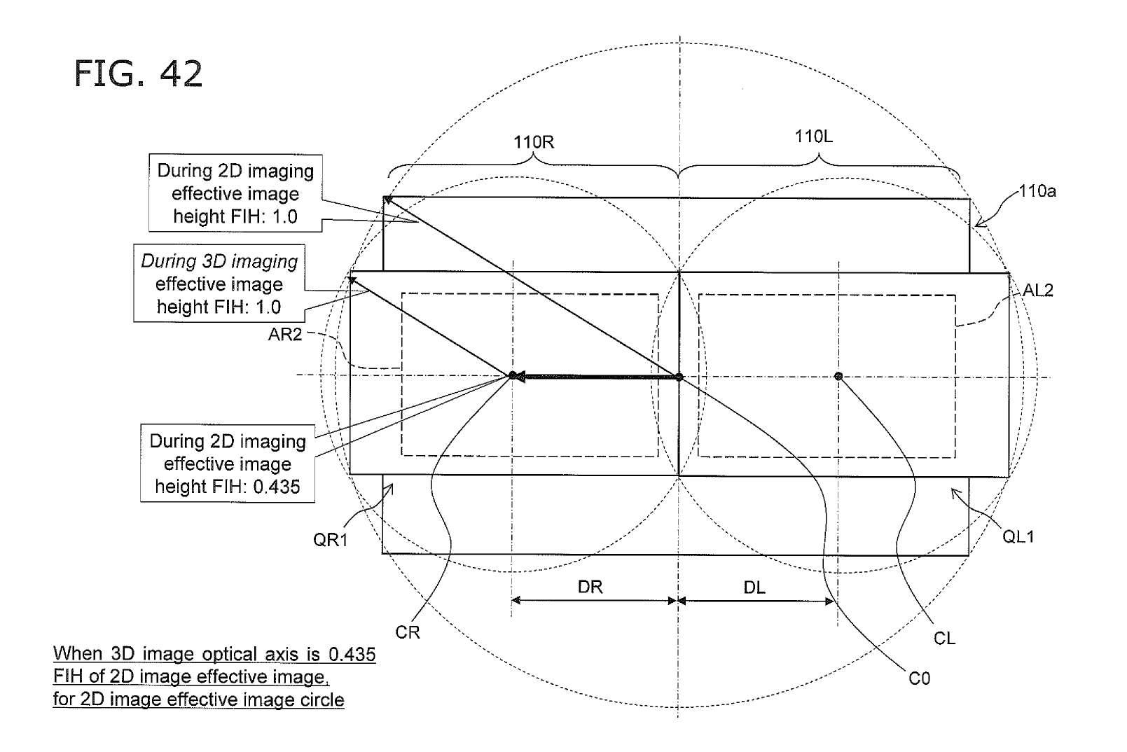

As shown in FIG. 42, the effective image height of the left-eye optical image QL1 is set to a range of 0.3 to 0.7, and the effective image height of the right-eye optical image QR1 is set to a range of 0.3 to 0.7. More precisely, if the main body maximum image height is 1.0, then a light beam passing through the optical axis center of the left-eye optical system OL arrives at a region corresponding to a range of 0.3 to 0.7 of the main body maximum image height. Also, if the main body maximum image height is 1.0, a light beam passing through the optical axis center of the right-eye optical system OR arrives at a region corresponding to a range of 0.3 to 0.7 of the main body maximum image height.

The “effective image height” referred to here is set using the effective image height during normal imaging (two-dimensional imaging) as a reference. More specifically, the effective image height of the left-eye optical image QL1 during three-dimensional imaging is the quotient of dividing the distance DL from the center C0 of the effective image circle of a two-dimensional image to the center CL of the effective image circle of the left-eye optical image QL1, by the diagonal length D0 from the center C0 of the two-dimensional image. A light beam passing through the optical axis center of the left-eye optical system OL arrives at the center CL. Similarly, the effective image height of the right-eye optical image QR1 during three-dimensional imaging is the quotient of dividing the distance DR from the center C0 of the effective image circle of a two-dimensional image to the center CR of the effective image circle of the right-eye optical image QR1, by the diagonal length D0 from the center C0 of the two-dimensional image. A light beam passing through the optical axis center of the right-eye optical system OR arrives at the center CR.

If the effective image height of the left-eye optical image QL1 and the right-eye optical image QR1 is set to be within the above range, the left-eye optical image QL1 and the right-eye optical image QR1 will readily fit within the effective image range.

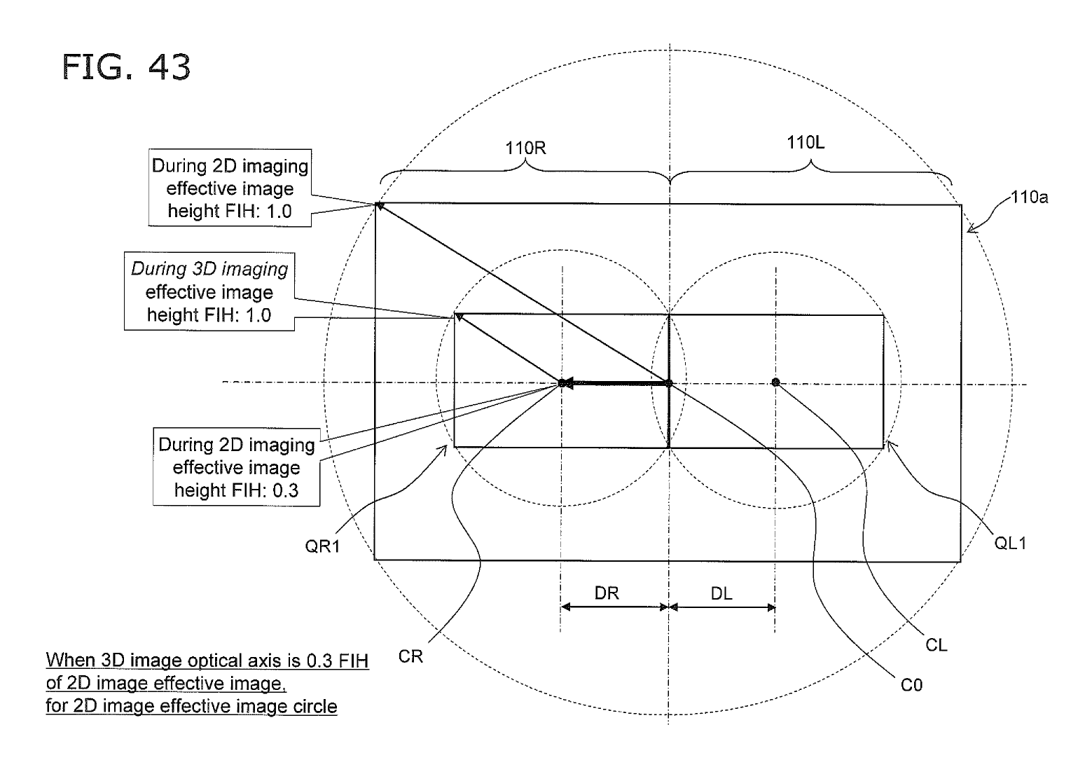

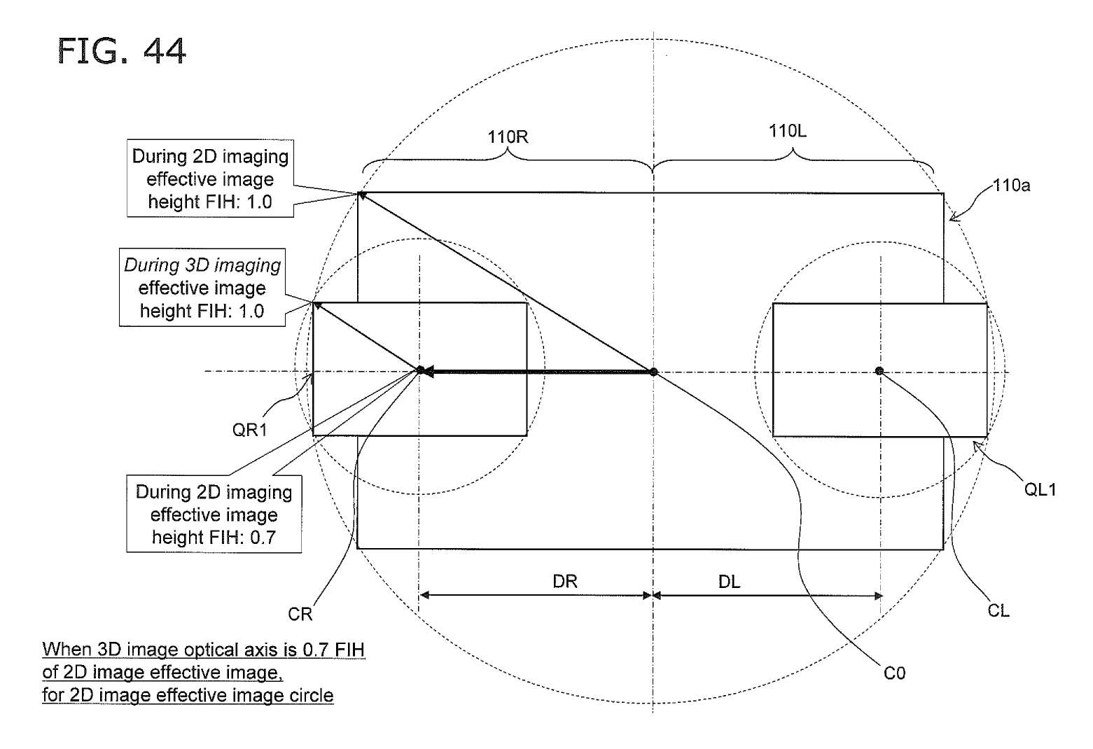

FIG. 43 shows the state when both effective image heights are 0.3, and FIG. 44 shows the state when both are 0.7. The state shown in FIG. 42 is a state in which both effective image heights are 0.435.

Since the amount of light usually decreases around the periphery of the left-eye optical image QL1 and around the periphery of the right-eye optical image QR1 as compared to in the center, there is a limited region of the left-eye optical image QL1 and the right-eye optical image QR1 from which an image can be extracted. Furthermore, the effective regions of the left-eye optical image QL1 and the right-eye optical image QR1 must be separated so that the periphery of the right-eye optical image QR1 does not overlap the effective region of the left-eye optical image QL1, and so that the periphery of the left-eye optical image QL1 does not overlap the effective region of the right-eye optical image QR1. Therefore, even if the effective image heights are set as discussed above, the left-eye optical image QL1 and the right-eye optical image QR1 must be reduced in size somewhat so that the effective region of the left-eye optical image QL1 and the effective region of the right-eye optical image QR1 will fit on the CMOS image sensor 110.

However, when the left-eye optical image QL1 and the right-eye optical image QR1 are made smaller, the resolution of three-dimensional imaging ends up decreasing. To obtain a good stereo image, the left-eye optical image QL1 and the right-eye optical image QR1 are preferably arranged efficiently in the effective image region of the CMOS image sensor 110.

In view of this, with the 3D adapter 100, a shaded region is intentionally provided to the left-eye optical image QL1 and the right-eye optical image QR1.

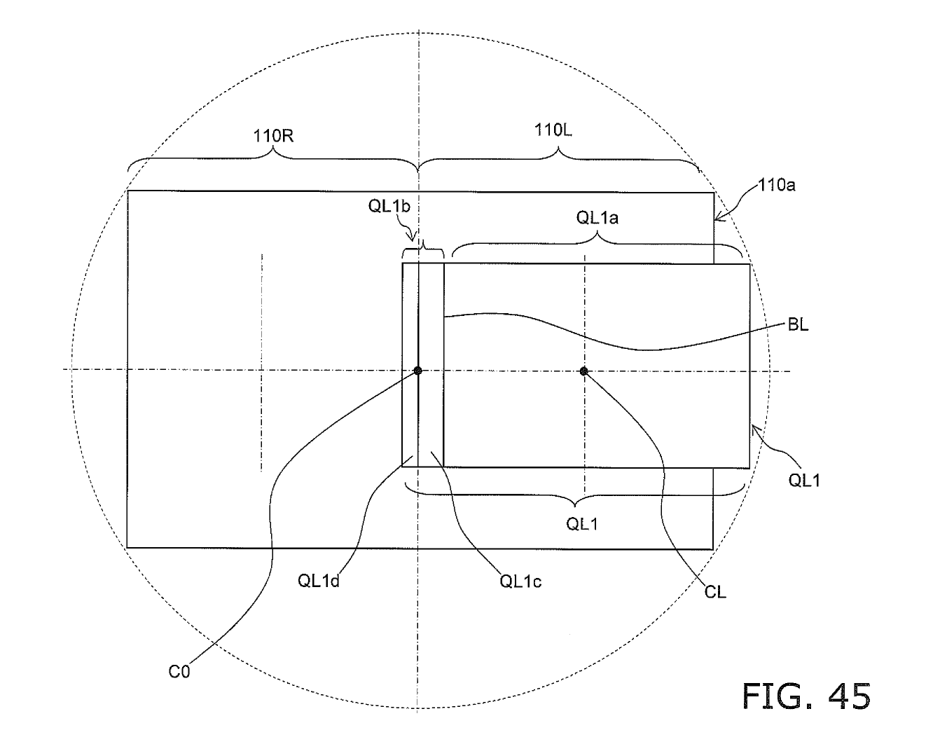

More specifically, as shown in FIG. 45, the left-eye optical image QL1 has a left-eye effective image region QL1a and a left-eye shaded region QL1b in which the amount of light is reduced by an intermediate light blocker 72a. Only the left-eye optical image QL1 is shown in FIG. 45. The left-eye effective image region QL1a is formed by light passing through a first opening 72La, and is adjacent to the left-eye shaded region QL1b. The left-eye effective image region QL1a is used in the production of a stereo image. More precisely, as shown in FIGS. 6 and 42, image data for the first extraction region AL2 is cropped from the image data for the left-eye effective image region QL1a and used in the production of a stereo image. Meanwhile, as shown in FIG. 45, the left-eye shaded region QL1b is a region in which the amount of light is reduced by the intermediate light blocker 72a, and is not used in the production of a stereo image.

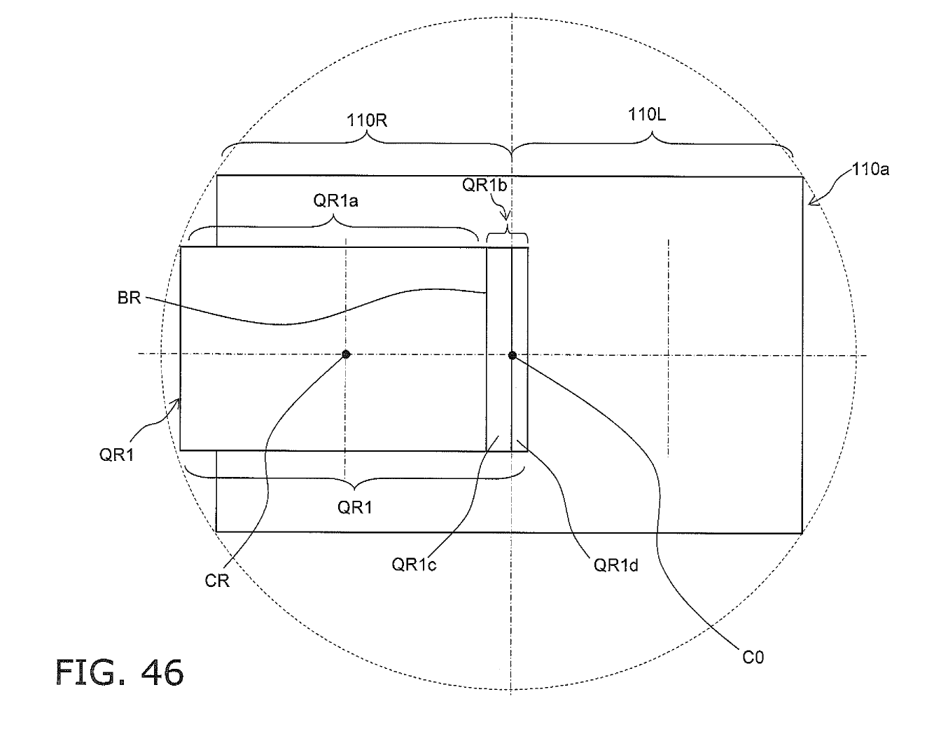

Also, as shown in FIG. 46, the right-eye optical image QR1 has a right-eye effective image region QR1a and a right-eye shaded region QR1b in which the amount of light is reduced by the intermediate light blocker 72a. Only the right-eye optical image QR1 is shown in FIG. 46. The right-eye effective image region QR1a is formed by light passing through a second opening 72Ra, and is adjacent to the right-eye shaded region QR1b. The right-eye effective image region QR1a is used in the production of a stereo image. More precisely, as shown in FIGS. 6 and 42, image data for the second extraction region AR2 is cropped from the image data for the right-eye effective image region QR1a and used in the production of a stereo image. Meanwhile, as shown in FIG. 46, the right-eye shaded region QR1b is a region in which the amount of light is reduced by the intermediate light blocker 72a, and is not used in the production of a stereo image.

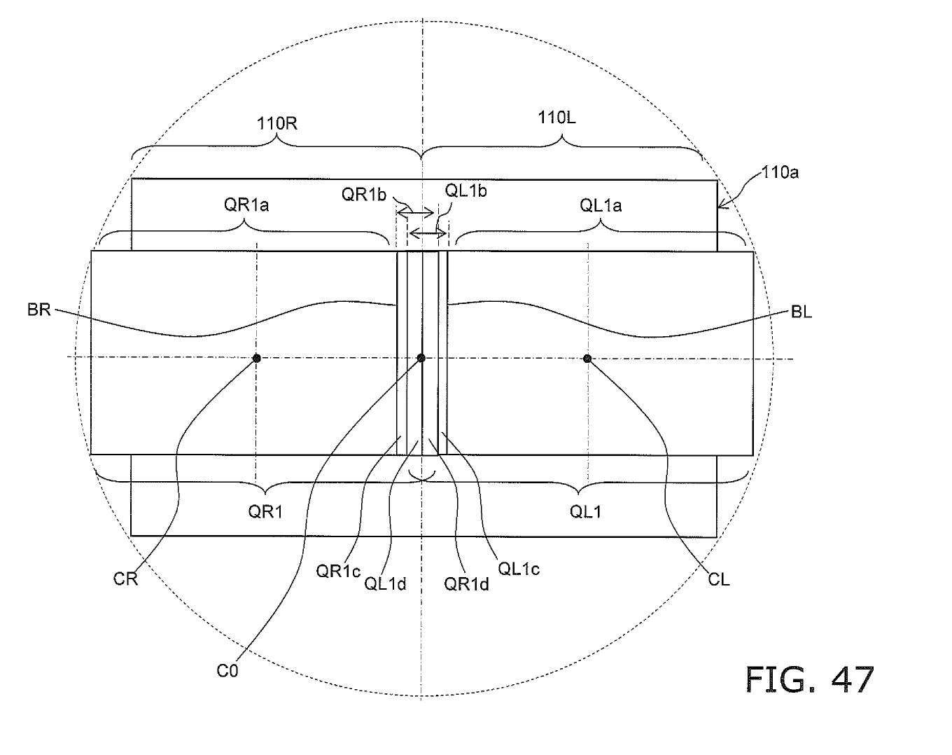

FIG. 47 shows the left-eye optical image QL1 and the right-eye optical image QR1. As shown in FIG. 47, during normal imaging, part of the left-eye shaded region QL1b overlaps the right-eye shaded region QR1b.

For example, as shown in FIGS. 45 and 47, the left-eye shaded region QL1b has a left-eye inner region QL1c formed on the first light receiving face 110L, and a left-eye outer region QL1d formed on the second light receiving face 110R. The surface area of the left-eye outer region QL1d is smaller than the surface area of the left-eye inner region QL1c. More precisely, the dimension in the horizontal direction of the left-eye outer region QL1d is smaller than the dimension in the horizontal direction of the left-eye inner region QL1c, and in this embodiment is approximately one-half the dimension in the horizontal direction of the left-eye inner region QL1c.

Similarly, as shown in FIGS. 46 and 47, part of the right-eye shaded region QR1b overlaps the left-eye shaded region QL1b. The right-eye shaded region QR1b has a right-eye inner region QR1c formed on the second light receiving face 110R, and a right-eye outer region QR1d formed on the first light receiving face 110L. The surface area of the right-eye outer region QR1d is smaller than the surface area of the right-eye inner region QR1c. More precisely, the dimension in the horizontal direction of the right-eye outer region QR1d is smaller than the dimension in the horizontal direction of the right-eye inner region QR1c, and in this embodiment is approximately one-half the dimension in the horizontal direction of the right-eye inner region QR1c.

Thus, the left-eye shaded region QL1b and the right-eye shaded region QR1b are formed by the intermediate light blocker 72a, and during normal imaging, part of the left-eye shaded region QL1b overlaps the right-eye shaded region QR1b, and part of the right-eye shaded region QR1b overlaps the left-eye shaded region QL1b. As a result, the periphery of the left-eye optical image QL1 can be prevented from overlapping the effective region of the right-eye optical image QR1, and the periphery of the right-eye optical image QR1 can be prevented from overlapping the effective region of the left-eye optical image QL1. Consequently, the effective region of the left-eye optical image QL1 and the effective region of the right-eye optical image QR1 can be moved closer together, and the effective region of the left-eye optical image QL1 and the effective region of the right-eye optical image QR1 can be set to be relatively larger. Specifically, the effective image region of the CMOS image sensor 110 can be used more efficiently.

The extent to which the left-eye shaded region QL1b and the right-eye shaded region QR1b overlap can be adjusted mainly by varying the width of the intermediate light blocker 72a (the dimension in the X axis direction). As shown in FIG. 15, the intermediate light blocker 72a has a first edge 72L and a second edge 72R. The first edge 72L forms the end of the left-eye shaded region QL1b, and is disposed parallel to the Z axis direction (perpendicular to the reference plane). The second edge 72R forms the end of the right-eye shaded region QR1b, and is disposed parallel to the Z axis direction (perpendicular to the reference plane).

More precisely, a light blocking sheet 72 (an example of a light blocking member, and an example of a light blocking unit) has the rectangular first opening 72La through which passes light incident on the left-eye optical system OL, and the rectangular second opening 72Ra through which passes light incident on the right-eye optical system OR. The intermediate light blocker 72a is formed by the first opening 72La and the second opening 72Ra. Part of the edge of the first opening 72La is formed by the first edge 72L, and part of the edge of the second opening 72Ra is formed by the second edge 72R. Since the first edge 72L is formed in a straight line, as shown in FIGS. 45 and 47, a first boundary BL between the left-eye effective image region QL1a and the left-eye shaded region QL1b is substantially a straight line. Since the second edge 72R is formed in a straight line, as shown in FIGS. 46 and 47, a second boundary BR between the right-eye effective image region QR1a and the right-eye shaded region QR1b is substantially a straight line. Therefore, it is easy to ensure a larger first extraction region AL2 and second extraction region AR2.

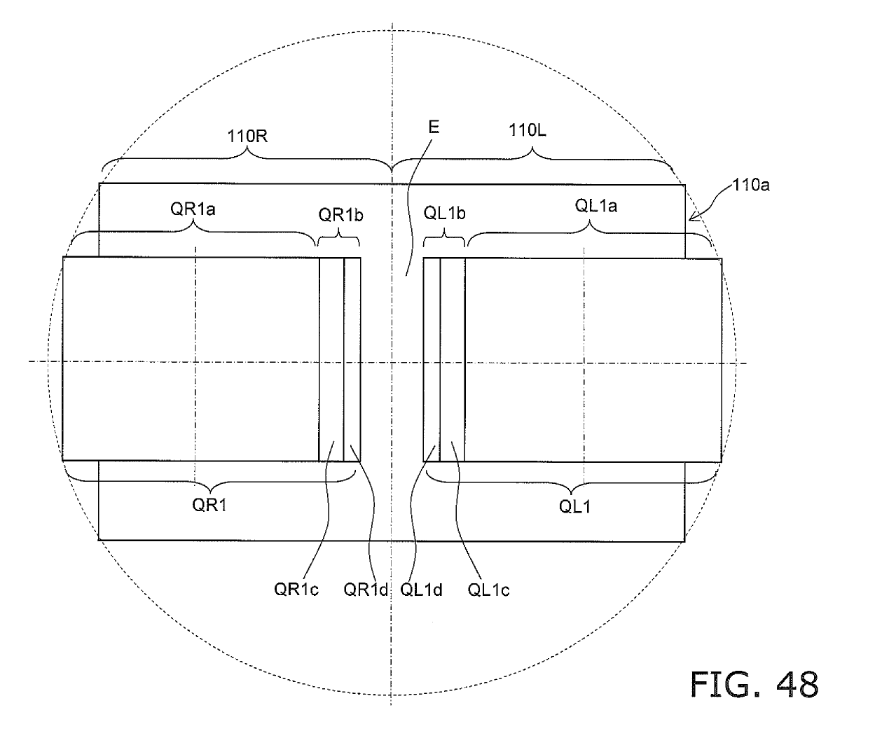

Meanwhile, during normal imaging the video camera 200 cannot focus on the intermediate light blocker 72a, but in adjustment mode the video camera 200 can focus on the intermediate light blocker 72a. More specifically, when the adjustment mode button 133 is pressed, the second lens group G2 and the fourth lens group G4 are driven to their specific positions by the zoom motor 214 and the focus motor 233, respectively. Fine adjustment of focus may be performed with a contrast detection type of auto focus, or the user can perform it using a focus adjustment lever (not shown). The focus can also be on the intermediate light blocker 72a of the light blocking sheet 72. When the focus is on the intermediate light blocker 72a, the focal length increases and the overall image height on the light receiving face 110a is greater. As a result, as shown in FIG. 48, the left-eye optical image QL1 moves away from the right-eye optical image QR1 in the horizontal direction, and this is accompanied by the left-eye shaded region QL1b moving away from the right-eye shaded region QR1b in the horizontal direction. In this case, a black band E is displayed between the left-eye optical image QL1 and the right-eye optical image QR1 on the camera monitor 120. In this state, it is easier for the user to recognize relative offset in the vertical direction between the left-eye optical image QL1 and the right-eye optical image QR1, which can be adjusted with the first adjustment mechanism 3.

### Adjustment Work

Since there are differences between individual products of the 3D adapter 100 and the video camera 200, it is preferable to adjust the state of the left-eye optical system OL and right-eye optical system OR before shipping and use by using the first adjustment mechanism 3, the second adjustment mechanism 4, and the third adjustment mechanism 5.

The various kinds of adjustment work in which the above-mentioned constitution is employed will now be described in brief.

### Relative Offset Adjustment

“Relative offset adjustment” refers to adjusting positional offset in the vertical direction of the left-eye optical image QL1 and the right-eye optical image QR1. To produce a good stereo image, it is preferable if the positions in the vertical direction of the left-eye optical image QL1 and the right-eye optical image QR1 formed on the CMOS image sensor 110 are matched to a relatively high degree of precision.

However, we can imagine situations in which even though adjustment is performed at the time of shipping, relative offset increases due to individual differences between video cameras 200 that are mounted.

In view of this, with the 3D adapter 100, during use the user adjusts the positions of the left-eye optical image QL1 and the right-eye optical image QR1 in the vertical direction (more specifically, the positions of the left-eye image and the right-eye image in the vertical direction) with the relative offset adjustment dial 61 while looking at the image displayed on the camera monitor 120.

The adjustment of relative offset is accomplished by operating the relative offset adjustment dial 61 in adjustment mode. The adjustment mode is executed when the adjustment mode button 133 is pressed in a state in which the 3D adapter 100 has been mounted to the video camera 200. In adjustment mode, not just either the left- or right-eye image is displayed on the camera monitor 120, but rather the entire image corresponding to the effective image region of the CMOS image sensor 110, and the focus is put on the intermediate light blocker 72a of the light blocking sheet 72. In a state in which the intermediate light blocker 72a is in focus, as shown in FIG. 48, the left-eye optical image QL1 and the right-eye optical image QR1 each move outward in the left and right direction on the display screen of the camera monitor 120, and the left-eye optical image QL1 and the right-eye optical image QR1 separate to the left and right. Since the black band E appears between the left-eye optical image QL1 and the right-eye optical image QR1, it is easier for the user to grasp the vertical relative offset of the left-eye optical image QL1 and the right-eye optical image QR1 on the camera monitor 120.

As shown in FIG. 22, when the relative offset adjustment dial 61 is turned, the relative offset adjustment screw 39 rotates via the first joint shaft 64. Since the threaded component 39c is threaded into the threaded hole of the first support plate 66, when the relative offset adjustment screw 39 rotates, it moves in the X axis direction with respect to the main body frame 2. Since the first restrictor 33 is pressed against the relative offset adjustment screw 39 by the elastic force of the adjusting spring 38, when the relative offset adjustment screw 39 moves in the X axis direction with respect to the main body frame 2, this is accompanied by rotation of the first adjustment frame 30 around the first rotational axis R1. When the first adjustment frame 30 rotates, the left-eye negative lens group G1L rotates around the first rotational axis R1, and as a result the left-eye negative lens group G1L moves substantially in the Z axis direction.

When the left-eye negative lens group G1L moves substantially in the Z axis direction, there is a change in the vertical position of the left-eye optical image QL1 formed on the CMOS image sensor 110. As a result, the left-eye image displayed on the camera monitor 120 moves up or down.

Thus, the vertical relative offset of the left-eye image and right-eye image can be reduced by turning the relative offset adjustment dial 61 while looking at the camera monitor 120, and thereby matching the position of the left-eye image in the vertical direction on the camera monitor 120 to that of the right-eye image.

### Convergence Angle Adjustment

The term “convergence angle” refers to the angle formed by the left-eye optical axis AL and the right-eye optical axis AR. To produce a good stereo image, the convergence angle is preferably set to the proper angle.

However, it is conceivable that individual differences between products could result in the convergence angle varying from one product to the next. Variance in the convergence angle is preferably suppressed in order to produce a good stereo image.

In view of this, with the 3D adapter 100, a worker uses the second adjustment mechanism 4 to adjust the convergence angle during manufacture or before shipping.

As shown in FIG. 22, the worker turns the convergence angle adjusting screw 49 in a state in which the exterior casing 101 has been removed. Since the convergence angle adjusting screw 49 is threaded into the threaded hole 21h of the support 21f, when the convergence angle adjusting screw 49 is turned, it moves in the X axis direction with respect to the main body frame 2. Since the second restrictor 43 is pressed against the head component 49b by the elastic force of the adjusting spring 38, when the convergence angle adjusting screw 49 moves in the X axis direction with respect to the main body frame 2, this is accompanied by rotation of the second adjustment frame 40 around the second rotational axis R2. When the second adjustment frame 40 rotates, the right-eye negative lens group G1R rotates around the second rotational axis R2, and as a result, the right-eye negative lens group G1R moves substantially in the X axis direction.

When the right-eye negative lens group G1R moves substantially in the X axis direction, there is a change in the horizontal position of the right-eye optical image QR1 formed on the CMOS image sensor 110. This allows the convergence angle to be adjusted to the proper angle.

Once the adjustment of the convergence angle is complete, the user does not need to adjust it again, so the convergence angle adjusting screw 49 is fixed adhesively, for example, to the second restrictor 43. However, the design may be such that the user can adjust the convergence angle.

### Focus Adjustment

To produce a good stereo image, it is preferable if the left-eye optical system OL and the right-eye optical system OR are not out of focus. However, individual differences between products may cause the left-eye optical system OL and the right-eye optical system OR to be out of focus.

In view of this, with the 3D adapter 100, a worker uses the second adjustment mechanism 4 to focus left-eye optical system OL and the right-eye optical system OR during manufacture or before shipping. In this embodiment, the focus is adjusted by moving the right-eye negative lens group G1R of the right-eye optical system OR in the Y axis direction.

As shown in FIG. 34, when the worker turns the focus adjusting screw 48, it moves in the Y axis direction with respect to the main body frame 2. Since the second adjustment frame 40 is pressed against the focus adjusting screw 48 by the elastic force of the focus adjusting spring 44, when the focus adjusting screw 48 moves, this is accompanied by movement of the second adjustment frame 40 in the Y axis direction with respect to the main body frame 2. As a result, the right-eye negative lens group G1R moves in the Y axis direction with respect to the right-eye positive lens group G2R, and the focus of the right-eye optical system OR changes.

Thus, offset in the focus of the left-eye optical system OL and the right-eye optical system OR can be adjusted by turning the focus adjusting screw 48.

Once adjustment of the focus is complete, the user does not need to adjust it again.

Therefore, after adjustment the focus adjusting screw 48 is fixed adhesively, for example, to the front support plate 25. However, the design may be such that the user can adjust the focus.

### Image Position Adjustment

To produce a good stereo image, it is preferable if the left-eye optical image QL1 and the right-eye optical image QR1 are set to the proper positions on the CMOS image sensor 110. However, it is conceivable that individual differences between products may cause the positions of the left-eye optical image QL1 and the right-eye optical image QR1 to deviate greatly from the design positions. It is also conceivable that the above-mentioned relative offset adjustment and convergence angle adjustment could cause an overall deviation in the positions of the left-eye optical image QL1 and the right-eye optical image QR1 on the CMOS image sensor 110.

In view of this, with the 3D adapter 100, the user uses the third adjustment mechanism 5 to adjust the image positions during use (or in a state in which the effective image region of the CMOS image sensor 110 is displayed on the camera monitor 120).

As shown in FIG. 38, when the vertical position adjustment dial 57 is turned, since the threaded component 57c of the vertical position adjustment dial 57 is threaded into the threaded hole of the dial support 51c, the main body frame 2 moves up or down with respect to the exterior casing 101, with the first elastic support 51L and the second elastic support 51R as fulcrums. More precisely, the main body frame 2 rotates with respect to the exterior casing 101 and around the rotational axis R4. Since the first elastic component 51La and the second elastic component 51Ra here are thinner, no heavy load is exerted on the first elastic support 51L or the second elastic support 51R.

When the main body frame 2 rotates with respect to the exterior casing 101 and around the rotational axis R4, the left-eye optical system OL and the right-eye optical system OR move in the Z axis direction with respect to the exterior casing 101. More precisely, the orientation of the left-eye optical system OL and the right-eye optical system OR changes to face upward or downward with respect to the exterior casing 101. This allows the vertical positions of the left-eye optical image QL1 and the right-eye optical image QR1 on the CMOS image sensor 110 to be adjusted.

Also, as shown in FIG. 41, when the horizontal position is adjusted, such as when the horizontal position adjustment dial 62 is turned, the horizontal position adjusting screw 53 rotates via the second joint shaft 65. As shown in FIG. 40, since the first contact component 51d is pressed against the joint component 53a of the horizontal position adjusting screw 53 by the tensile force of the first linking spring 56, the horizontal position adjusting screw 53 does not move in the X axis direction with respect to the first linking plate 51. Instead, since the threaded component 53c is threaded into the threaded hole 52f of the support 52c, when the horizontal position adjusting screw 53 rotates, the support 52c moves in the X axis direction with respect to the first linking plate 51 (that is, the exterior casing 101). In other words, the second linking plate 52 and the main body frame 2 rotate around the rotational axis R3 and with respect to the exterior casing 101.

When the main body frame 2 rotates with respect to the exterior casing 101 and around the rotational axis R3, the left-eye optical system OL and the right-eye optical system OR move in the X axis direction with respect to the exterior casing 101. More precisely, the orientation of the left-eye optical system OL and the right-eye optical system OR changes to face right or left with respect to the exterior casing 101. This allows the horizontal positions of the left-eye optical image QL1 and the right-eye optical image QR1 on the CMOS image sensor 110 to be adjusted.

### Operation of Video Camera

We will now describe the operation of the video camera 200 when the 3D adapter 100 is used to perform three-dimensional imaging with the video camera 200.

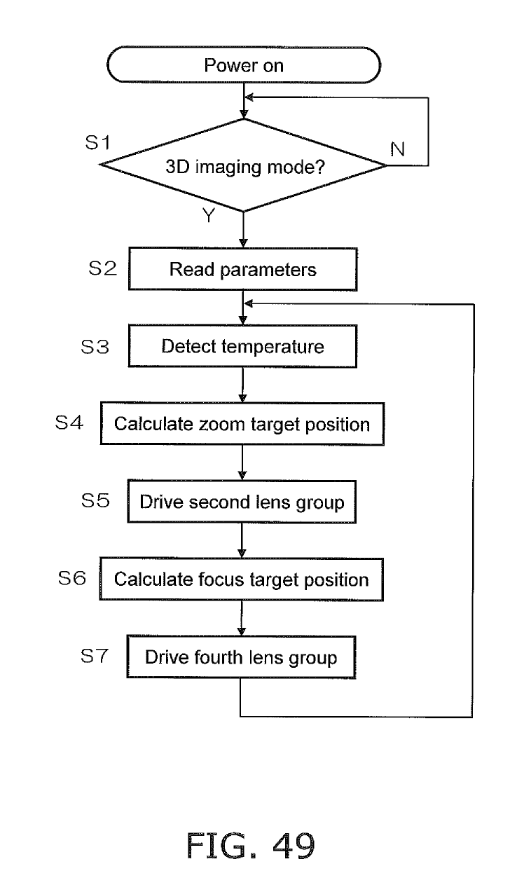

As shown in FIG. 49, when the power is switched on to the video camera 200, electrical power is supplied to the various components, and the camera controller 140 confirms the operating mode, such as reproduction mode, two-dimensional imaging mode, or three-dimensional imaging mode (step S1).

When the power goes on in a state in which the 3D adapter 100 has been mounted to the video camera 200, the lens detector 149 detects that the 3D adapter 100 is mounted, and the camera controller 140 automatically switches the imaging mode of the video camera 200 to three-dimensional imaging mode. Even if the 3D adapter 100 is mounted to the video camera 200 while the power to the video camera 200 is already on, the lens detector 149 will detect that the 3D adapter 100 has been mounted, and the camera controller 140 will automatically switch the imaging mode of the video camera 200 to three-dimensional imaging mode.

Here, there may be situations in which individual differences between products (more precisely, individual differences between the video cameras 200) cause the reference plane distance (see FIG. 7) of the 3D adapter 100 to deviate from the design value, cause the convergence angle also to deviate from the design value, and as a result cause the left and right positions of the left-eye optical image QL1 and the right-eye optical image QR1 to deviate from the design positions. Also, there may be situations in which the characteristics of the optical system V vary due to changes in the ambient temperature, so left and right positional offset of the left-eye optical image QL1 and the right-eye optical image QR1 using the design position as a reference can also be caused by changes in the ambient temperature. Left and right positional offset of the left-eye optical image QL1 and the right-eye optical image QR1 is undesirable because it affects the stereoscopic look of a three-dimensional image.

In view of this, the video camera 200 has the function of correcting offset in the reference plane distance and thereby correcting left and right positional offset of the left-eye optical image QL1 and the right-eye optical image QR1 using the design positions as a reference. Adjustment of the reference plane distance is performed by moving the second lens group G2 (a zoom adjusting lens group) in the Y axis direction with the zoom motor 214.

More specifically, when the operating mode of the video camera 200 is switched to three-dimensional imaging mode, various parameters are read by the drive controller 140d (step S2). Index data indicating individual differences of the optical system V is read from the ROM 140b to the drive controller 140d. This index data is measured before shipment of the product and stored ahead of time in the ROM 140b.

Next, since the characteristics of the optical system V will vary with the ambient temperature, the temperature is detected by the temperature sensor 118 (FIG. 4) to ascertain the ambient temperature (step S3). The detected temperature is temporarily stored in the RAM 140c as temperature information, and is read by the drive controller 140d as needed.

The zoom motor 214 is controlled by the drive controller 140d on the basis of the index data and the detected temperature. More specifically, the target position of the second lens group G2 (zoom adjusting lens group) is calculated by the drive controller 140d on the basis of the index data and the detected temperature (step S4). Information (such as a calculation formula or a data table) for calculating the target position of the second lens group G2 on the basis of the index data and the detected temperature is stored ahead of time in the ROM 140b. The second lens group G2 is driven by the zoom motor 214 up to the calculated target position (step S5). The target position of the second lens group G2 may also be calculated on the basis of the index data alone.

To perform fine adjustment of the focus, the target position of the fourth lens group G4 is calculated by the drive controller 140d on the basis of the calculated target position of the second lens group G2 (step S6). Information (such as a calculation formula or a data table) for calculating the target position of the fourth lens group G4 is stored ahead of time in the ROM 140b. The fourth lens group G4 is driven by the focus motor 233 up to the calculated target position (step S7).

Since the above-mentioned control is thus performed by taking into account the fact that changes in the ambient temperature or individual differences between products may cause left and right positional offset of the left-eye optical image QL1 and the right-eye optical image QR1, a better stereo image can be acquired when mounting the 3D adapter 100 to the video camera 200 and performing three-dimensional imaging.

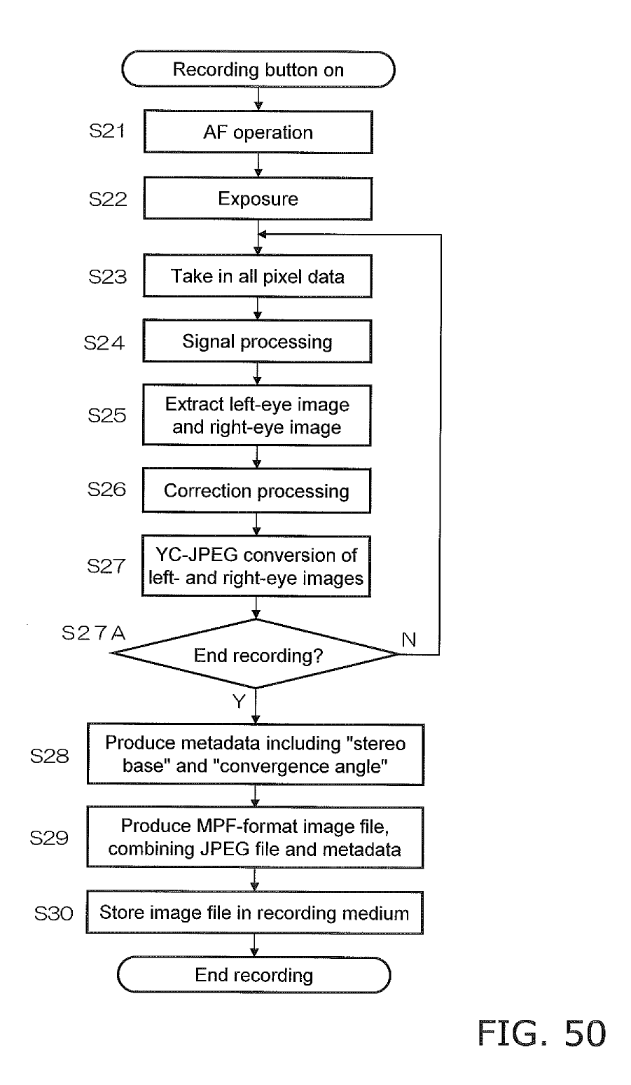

When three-dimensional imaging is performed, for example, the capture of a stereo image is executed when the user presses the record button 131. More specifically, as shown in FIG. 50, when the user presses the record button 131, auto focus is executed by wobbling, etc. (step S21), the CMOS image sensor 110 is exposed (step S22), and image signals from the CMOS image sensor 110 (data for all pixels) are sequentially read to the signal processor 215 (step S23).

Focus adjustment during three-dimensional imaging is performed using either the left-eye optical image QL1 or the right-eye optical image QR1. In this embodiment, focus adjustment is performed using the left-eye optical image QL1. In the case of wobbling, for instance, the region in which the AF evaluation value is calculated is set to part of the left-eye effective image region QL1a of the left-eye optical image QL 1. The AF evaluation value in the set region is calculated at a specific period, and wobbling is executed on the basis of the calculated AF evaluation value.

The image signals that are taken in are subjected to A/D conversion or other such signal processing by the signal processor 215 (step S24). The basic image data produced by the signal processor 215 is temporarily stored in the DRAM 241.

Next, left-eye image data and right-eye image data are extracted by the image extractor 216 from the basic image data (step S25). The size and position of the first and second extraction regions AL2 and AR2 here are stored ahead of time in the ROM 140b.

The extracted left-eye image data and right-eye image data are subjected to correction processing by the correction processor 218, and the left-eye image data and right-eye image data are subjected to JPEG compression or other such compression processing by the image compressor 217 (steps S26 and S27). The processing of steps S23 to S27 is executed until the record button 131 is pressed again (step S27A).

When the record button 131 is pressed again, metadata including the stereo base and convergence angle is produced by the metadata production component 147 of the camera controller 140 (step S28).

After the metadata production, the compressed left- and right-eye image data and the metadata are combined, and an MPF-format image file is produced by the image file production component 148 (step S29). The image files thus produced are sequentially transmitted to the card slot 170 and stored on the memory card 171, for example (step S30). When a moving picture is captured, these operations are repeated.

When the stereo video file thus obtained is displayed in 3D using the stereo base, convergence angle, and other such information, the displayed image can be viewed in 3D by using special glasses or the like.

### Features of 3D Adapter 100 (1)

With the 3D adapter 100 described above, since the positions of the left-eye optical image QL1 and the right-eye optical image QR1 with respect to the CMOS image sensor 110 can be adjusted using the adjusting mechanism 8 from outside the exterior casing 101, the effect that individual differences between products have on the stereo image can be reduced relatively simply.

For example, since the adjusting mechanism 8 has the first adjusting mechanism 3 that adjusts vertical relative offset, even if individual differences between products causes the relative positions of the left-eye optical image QL1 and the right-eye optical image QR1 on the CMOS image sensor 110 to deviate from the design value, the first adjusting mechanism 3 can be used to adjust the vertical relative offset relatively simply.

Also, since the adjusting mechanism 8 has the second adjusting mechanism 4 that adjusts the convergence angle, even if individual differences between products cause the convergence angle to deviate from the design value, the second adjusting mechanism 4 can be used to adjust the convergence angle relatively simply.

Furthermore, since the adjusting mechanism 8 has the third adjusting mechanism 5 that adjusts the position of the main body frame 2 with respect to the exterior casing 101, the positions of the left-eye optical image QL1 and the right-eye optical image QR1 in the vertical and horizontal directions with respect to the CMOS image sensor 110 can be adjusted relatively simply.

Thus, with the 3D adapter 100, adjustments necessary for acquiring a good stereo image can be performed through the adjusting mechanism 8 from the outside.

Modification Examples from the Viewpoint of Features (1)

Modification examples of the above embodiment that are conceivable from the viewpoint of the Features (1) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD image sensor, for instance.

(B) In the above embodiment, the adjusting mechanism 8 was described as an example of an adjusting unit, but the adjusting unit is not limited to the above embodiment. The adjusting unit may have one or more of the following adjustment functions a) to c).

a) The function of adjusting relative offset of the left-eye optical image QL1 and the right-eye optical image QR1 in the vertical direction on the CMOS image sensor 110.

b) The function of adjusting the positions of the left-eye optical image QL1 and the right-eye optical image QR1 in the vertical direction with respect to the CMOS image sensor 110.

c) The function of adjusting the positions of the left-eye optical image QL1 and the right-eye optical image QR1 in the horizontal direction with respect to the CMOS image sensor 110.

(C) In the above embodiment, the left-eye optical system OL was used to adjust vertical relative offset, but the adjustment of vertical relative offset may instead be performed using the right-eye optical system OR. Also, the right-eye optical system OR was used to adjust the convergence angle, but the adjustment of the convergence angle may instead be performed using the left-eye optical system OL.

(D) In the above embodiment, the main body frame 2 rotated in the X axis direction and the Z axis direction around the rotational axis R3 and the rotational axis R4, but the positions of the rotational axis R3 and the rotational axis R4 are not limited to those in the above embodiment. Also, the method for moving the main body frame 2 in the X axis direction and the Z axis direction with respect to the exterior casing 101 may be parallel movement (vertical movement and horizontal movement) rather than rotation.

(E) The left-eye negative lens group G1L was used for adjusting the vertical relative offset, but another lens group of the left-eye optical system OL may be used to adjust the vertical relative offset. Also, the right-eye negative lens group G1R was used for adjusting the convergence angle, but another lens group of the right-eye optical system OR may be used to adjust the convergence angle.

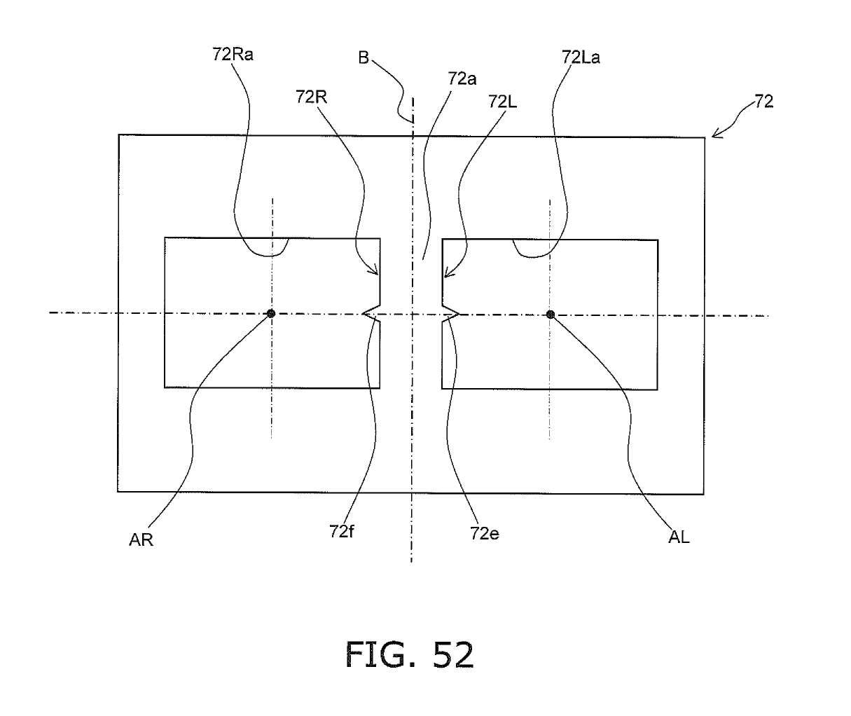

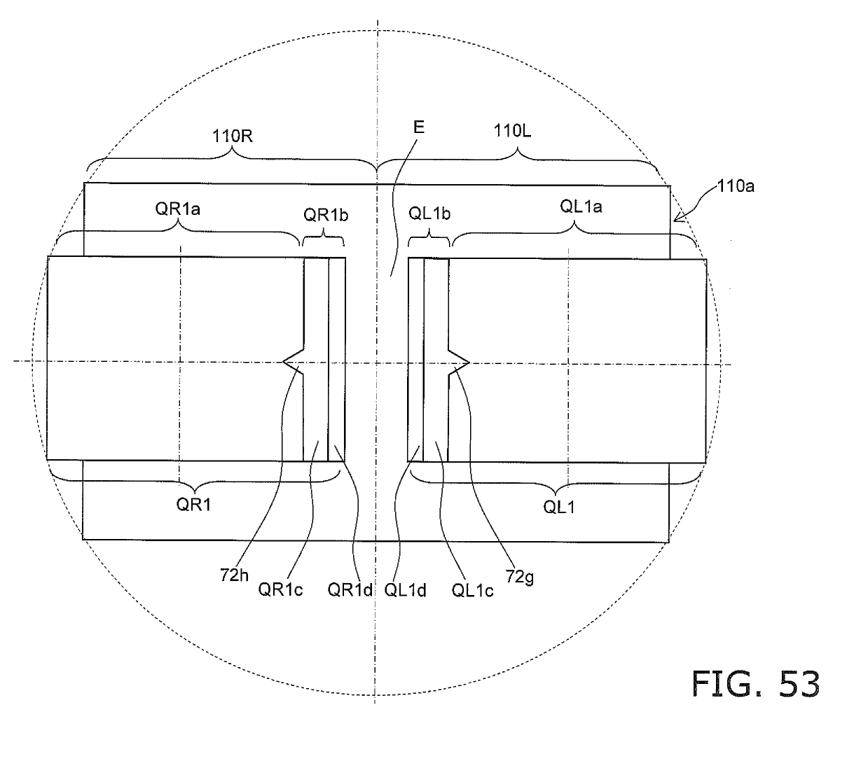

(F) As shown in FIG. 52, a vertical relative offset adjustment gauge may be provided to the intermediate light blocker 72a. FIG. 52 is a front view of the light blocking sheet 72 as seen from the subject side. As shown in FIG. 52, a pair of gauges 72e and 72f is provided to the intermediate light blocker 72a, and when the intermediate light blocker 72a is in focus, the gauges 72e and 72f are shown as gauge images 72g and 72h on the camera monitor 120 (see FIG. 53). Relative offset can be more accurately adjusted by matching the positions of the gauge images 72g and 72h in the vertical direction. The gauge images 72g and 72h can also be utilized to adjust the positions of the left-eye optical image QL1 and the right-eye optical image QR1 in the vertical direction.

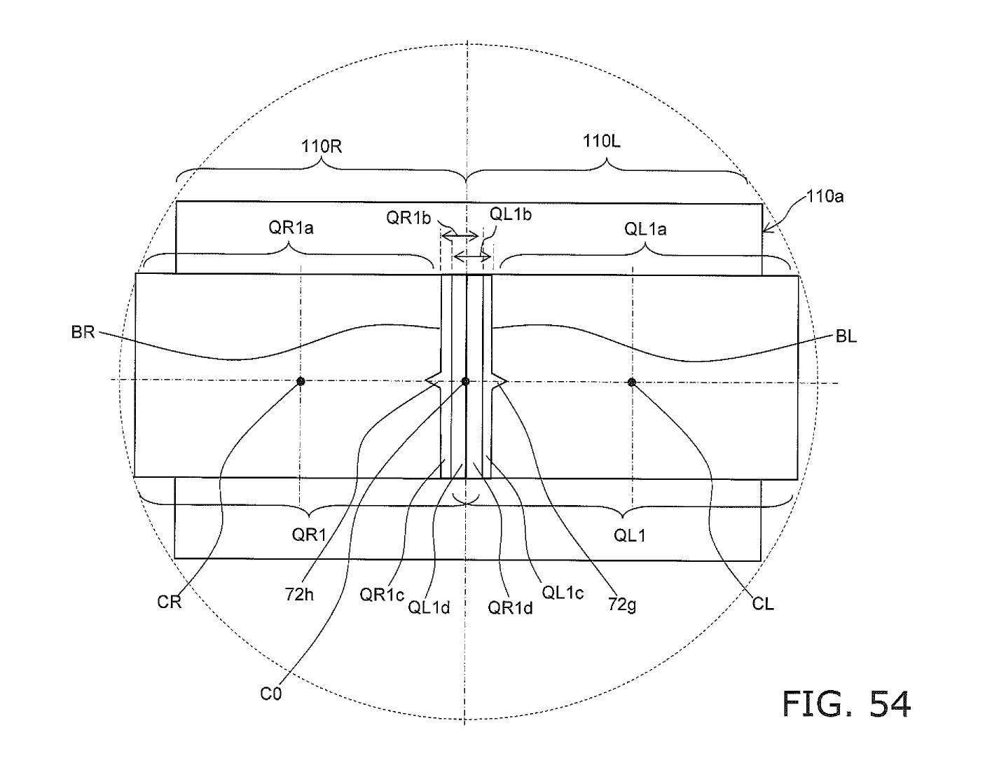

As shown in FIG. 54, during normal imaging the left-eye shaded region QL1b and the right-eye shaded region QR1b overlap, but in this case the gauge images 72g and 72h are disposed close to the first boundary BL and the second boundary BR, respectively. Also, in some cases, the gauge image 72g can be disposed more to the right-eye optical image QR1 side than the first boundary BL, and the gauge image 72h more to the left-eye optical image QL1 side than the second boundary BR. Therefore, the gauges 72e and 72f will have almost no effect on the extraction of the left-eye image data and right-eye image data.

The pair of gauges 72e and 72f may have any shape so long as the relative positions of the left-eye optical image QL1 and the right-eye optical image QR1 can be easily determined. Similarly, the pair of gauges 72e and 72f may have any shape so long as the positions of the left-eye optical image QL1 and the right-eye optical image QR1 in the vertical direction can be easily determined. The gauges 72e and 72f may also have mutually different shapes.

Also, the intermediate light blocker 72a or the gauges 72e and 72f may be provided to the cap 9.

(G) In the above embodiment, the vertical relative offset was adjusted by adjusting the orientation of the left-eye optical axis AL with respect to the exterior casing 101 by moving the left-eye negative lens group G1L substantially in the Z axis direction with respect to the main body frame 2. However, the vertical relative offset may instead be adjusted by adjusting the orientation of the left-eye optical system OL or the right-eye optical system OR with respect to the main body frame 2.

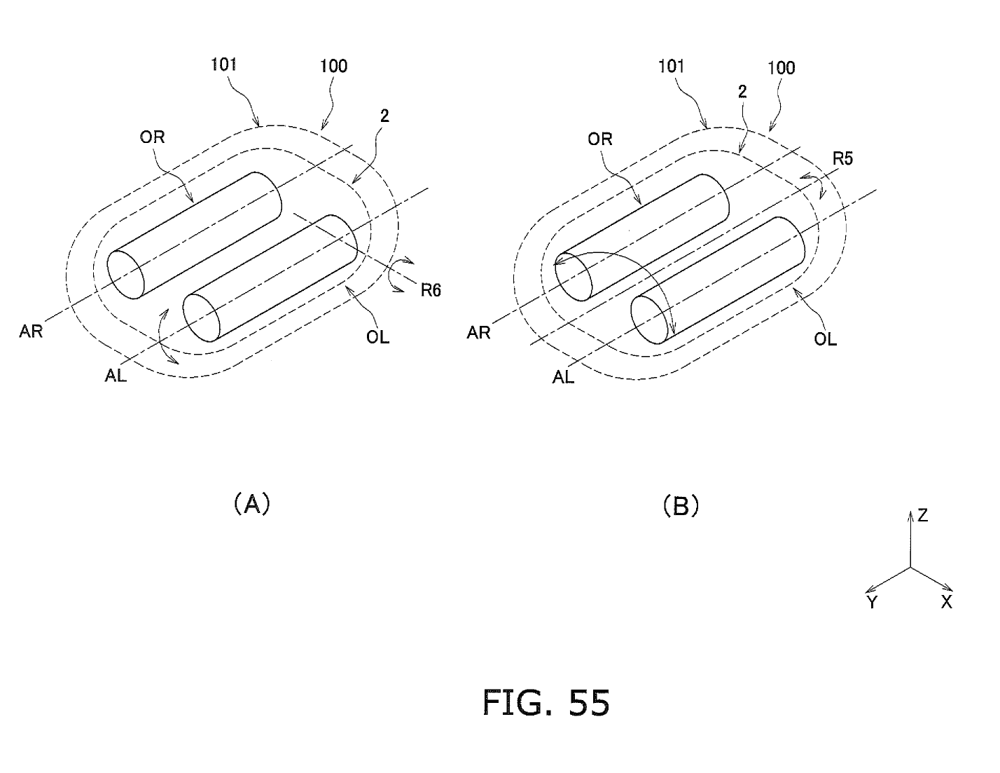

For example, as shown in FIG. 55A, the vertical relative offset may be adjusted by adjusting the orientation of the entire left-eye optical system OL with respect to the main body frame 2 (or the exterior casing 101). More precisely, the left-eye optical system OL is rotated with respect to the main body frame 2 (or the exterior casing 101) and around a rotational axis R6. When the orientation of the entire left-eye optical system OL is thus changed with respect to the main body frame 2 (or the exterior casing 101), the inclination of the left-eye optical axis AL with respect to the main body frame 2 (or the exterior casing 101) changes, and the position of the left-eye optical image QL1 on the CMOS image sensor 110 changes up or down. The same applies when the orientation of the entire right-eye optical system OR is changed. This configuration also allows the vertical relative offset to be adjusted.

The mechanism for adjusting the orientation of the entire left-eye optical system OL may, for example, be the components of the above-mentioned third adjusting mechanism 5 (such as the first elastic support 51L and the second elastic support 51R of the first linking plate 51). When the left-eye optical system OL is linked to the main body frame 2 by a member that corresponds to the first linking plate 51, the orientation of the entire left-eye optical system OL with respect to the main body frame 2 can be changed with a simple configuration.

Also, as shown in FIG. 55B, for example, the vertical relative offset may be adjusted by rotating the left-eye optical system OL and the right-eye optical system OR with respect to the main body frame 2 (or the exterior casing 101) and around a rotational axis R5. In this case, the rotational axis R5 is defined between the left-eye optical system OL and the right-eye optical system OR, and is an imaginary line included in the intermediate reference face B, for example. When the left-eye optical system OL and the right-eye optical system OR rotate around the rotational axis R5, the up and down positional relation between the left-eye optical image QL1 and the right-eye optical image QR1 changes. This configuration also allows the vertical relative offset to be adjusted.

The mechanism for rotating the left-eye optical system OL and the right-eye optical system OR may, for example, be the components of the above-mentioned first adjusting mechanism 3 and second adjusting mechanism 4 (such as the first adjustment frame 30 and the first rotary shaft 31, or the second adjustment frame 40 and the second rotary shaft 41). The vertical relative offset can be adjusted by a simple configuration by using a rotary shaft for rotatably supporting the frame that supports the left-eye optical system OL and the right-eye optical system OR.

(H) In the above embodiment, the convergence angle was adjusted by moving the right-eye negative lens group G1R substantially in the X axis direction with respect to the main body frame 2. That is, in the above embodiment, the vertical relative offset was adjusted by adjusting the position of the right-eye negative lens group G1R with respect to the main body frame 2. However, the convergence angle may be adjusted by adjusting the orientation of the left-eye optical system OL or the right-eye optical system OR with respect to the main body frame 2.

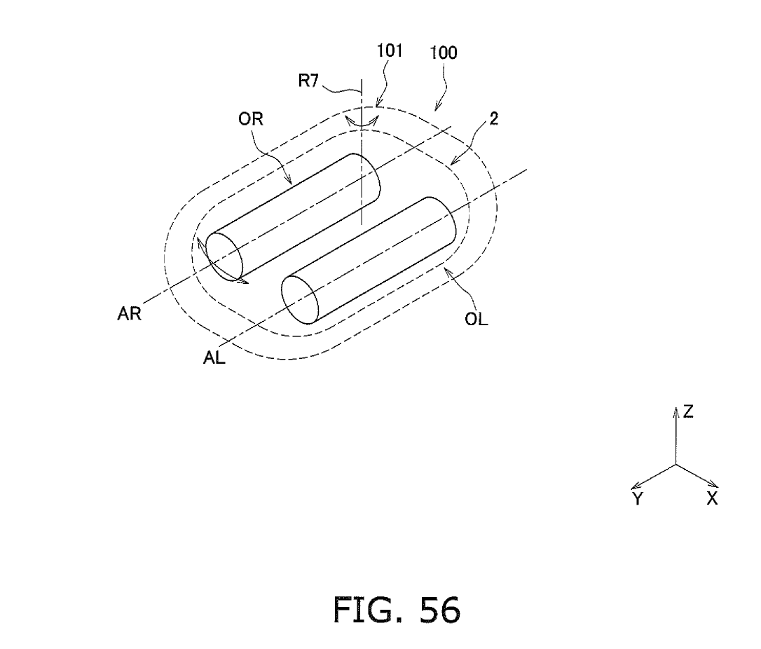

For example, as shown in FIG. 56, the convergence angle may be adjusted by adjusting the orientation of the entire right-eye optical system OR with respect to the main body frame 2 (or the exterior casing 101). More precisely, the right-eye optical system OR is rotated around a rotational axis R7 and with respect to the main body frame 2 (or the exterior casing 101). When the orientation of the entire right-eye optical system OR with respect to the main body frame 2 (or the exterior casing 101) is thus changed, the inclination of the right-eye optical axis AR with respect to the main body frame 2 (or the exterior casing 101) changes, and the convergence angle formed by the left-eye optical axis AL and the right-eye optical axis AR changes. The same applies to when the orientation of the entire left-eye optical system OL is changed. This configuration also allows the convergence angle to be adjusted.

The mechanism for adjusting the orientation of the entire right-eye optical system OR may, for example, be the components of the above-mentioned third adjusting mechanism 5 (such as the first linking plate 51 and the second linking plate 52). The orientation of the entire right-eye optical system OR with respect to the main body frame 2 can be varied by a simple configuration by linking the right-eye optical system OR to the main body frame 2 rotatably around the rotational axis R7 with members corresponding to the first linking plate 51 and the second linking plate 52.

### Features of 3D Adapter 100 (2)

(1) With this lens unit, since the left-eye optical system OL has the left-eye negative lens group G1L that functions as a relative offset adjusting optical system, the position of the left-eye optical image QL1 in the vertical direction can be adjusted by moving the left-eye negative lens group G1L in the Z axis direction with respect to the main body frame 2. This reduces the vertical relative offset of the left-eye optical image QL1 and the right-eye optical image QR1, and also reduces the effect that individual differences between products have on the stereo image.

Also, since the left-eye optical system OL and the right-eye optical system OR are housed in the main body frame 2, the 3D adapter 100 can be made more compact.

With the above configuration, it is possible to provide a 3D adapter 100 that is more compact and with which the effect that individual differences between products have on a stereo image can be reduced.

(2) Since the first adjustment frame 30 is rotatably linked to the main body frame 2 by the first rotary shaft 31, the left-eye negative lens group G1L can be moved in the Z axis direction by a simple structure. Also, since the first rotary shaft 31 is aligned with the left-eye optical system OL and the right-eye optical system OR, the amount of offset of the left-eye negative lens group G1L in the X axis direction can be reduced.

Modification Examples from the Viewpoint of Features (2)

Modification examples of the above embodiment that are conceivable from the viewpoint of the Features (2) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD (charge coupled device) image sensor, for instance.

(B) In the above embodiment, the left-eye optical system OL was used to adjust vertical relative offset, but the adjustment of vertical relative offset may instead be performed using the right-eye optical system OR.

(C) In the above embodiment, the first adjusting mechanism 3 was described as an example of a relative offset adjusting mechanism, but the configuration of the relative offset adjusting mechanism is not limited to the above embodiment. For example, the left-eye negative lens group G1L is moved substantially in the Z axis direction by rotating the left-eye negative lens group G1L around the first rotational axis R1, but the left-eye negative lens group G1L may be moved parallel to the Z axis direction.

(D) In the above embodiment, the first rotary shaft 31 was disposed aligned with the left-eye optical system OL and the right-eye optical system OR, but as long as vertical relative offset adjustment can be performed, the disposition of the first rotary shaft 31 may be different from that in the above embodiment. The left-eye optical system OL was disposed between the first rotary shaft 31 and the right-eye optical system OR, but the layout of the first rotary shaft 31 is not limited to this.

(E) The left-eye negative lens group G1L was disposed closest to the subject side in the left-eye optical system OL, but the vertical relative offset may be adjusted using a lens group disposed somewhere along the optical path of the left-eye optical system OL. Also, the vertical relative offset may be adjusted using the right-eye optical system OR.

(F) In the above embodiment, the vertical relative offset was adjusted by adjusting the orientation of the left-eye optical axis AL with respect to the exterior casing 101 by moving the left-eye negative lens group G1L substantially in the Z axis direction with respect to the main body frame 2. However, as described in (G) of Modification Examples from the Viewpoint of Features (1), the vertical relative offset may be adjusted by adjusting the orientation of either the left-eye optical system OL or the right-eye optical system OR with respect to the main body frame 2.

Features of 3D Adapter 100 (3)

(1) With the 3D adapter 100, since the right-eye optical image QR1 has the right-eye negative lens group G1R that functions as a convergence angle adjusting optical system, the convergence angle formed by the left-eye optical axis AL and the right-eye optical axis AR can be adjusted, and the effect that individual differences between products have on the stereo image can be reduced, by moving the right-eye negative lens group G1R in the X axis direction with respect to the main body frame 2.

Also, since the left-eye optical image QL1 and the right-eye optical image QR1 are housed in the main body frame 2, it is easier to obtain a more compact 3D adapter 100. With the above configuration, it is possible to provide a 3D adapter 100 that is more compact and with which the effect that individual differences between products have on a stereo image can be reduced.

(2) Since the second adjustment frame 40 is rotatably linked to the main body frame 2 by the second rotary shaft 41, the right-eye negative lens group G1R can be moved in the Z axis direction by a simple structure. Also, since the second rotary shaft 41 is aligned with the right-eye optical system OR in the Z axis direction, the amount of offset of the right-eye negative lens group G1R in the Z axis direction can be reduced.

Modification Examples from the Viewpoint of Features (3)

Modification examples of the above embodiment that are conceivable from the viewpoint of the Features (3) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD (charge coupled device) image sensor, for instance.

(B) In the above embodiment, the right-eye optical system OR was used to adjust the convergence angle, but the left-eye optical system OL may be used instead to adjust the convergence angle.

(C) In the above embodiment, the second adjusting mechanism 4 was described as an example of a convergence angle adjusting mechanism, but the configuration of the convergence angle adjusting mechanism is not limited to the above embodiment. For example, the right-eye negative lens group G1R was moved substantially in the X axis direction by rotating the right-eye negative lens group G1R around the second rotational axis R2, but the right-eye negative lens group G1R may be moved parallel to the X axis direction.

(D) In the above embodiment, the second rotary shaft 41 was disposed aligned with the right-eye optical system OR in the Z axis direction, but as long as convergence angle adjustment can be performed, the disposition of the second rotary shaft 41 may be different from that in the above embodiment.

(E) The right-eye negative lens group G1R was disposed closest to the subject side in the right-eye optical system OR, but the vertical relative offset may be adjusted using a lens group disposed somewhere along the optical path of the right-eye optical system OR. Also, the vertical relative offset may be adjusted using the left-eye optical system OL.

(F) In the above embodiment, the convergence angle was adjusted by adjusting the orientation of the right-eye optical axis AR with respect to the 2 by moving the right-eye negative lens group G1R moved substantially in the Z axis direction with respect to the main body frame 2. However, as described in (H) of Modification Examples from the Viewpoint of Features (1), the convergence angle may be adjusted by adjusting the orientation of either the left-eye optical system OL or the right-eye optical system OR with respect to the main body frame 2.

### Features of 3D Adapter 100 (4)

(1) With the 3D adapter 100, since the right-eye optical system OR has the right-eye negative lens group G1R that functions as a focus adjusting optical system, the focal state of the right-eye optical image QR1 can be matched to the focal state of the left-eye optical image QL1, and the effect that individual differences between products have on the stereo image can be reduced, by moving the right-eye negative lens group G1R along the right-eye optical axis AR.

Also, since the left-eye optical system OL and the right-eye optical system OR are housed in the main body frame 2, it is easier to obtain a more compact 3D adapter 100.

With the above configuration, it is possible to provide a 3D adapter 100 that is more compact and with which the effect that individual differences between products have on a stereo image can be reduced.

Modification Examples from the Viewpoint of Features (4)

Modification examples of the above embodiment that are conceivable from the viewpoint of the Features (4) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD (charge coupled device) image sensor, for instance.

(B) In the above embodiment, the second adjusting mechanism 4 was described as an example of a focus adjusting mechanism, but the configuration of the focus adjusting mechanism is not limited to the above embodiment. For example, the focus was adjusted by moving the right-eye negative lens group G1R in the Y axis direction, but the focus may be adjusted by moving another lens group.

### Features of 3D Adapter 100 (5)

With this 3D adapter 100, since the main body frame 2 that supports the left-eye optical image QL1 and the right-eye optical image QR1 is disposed movably substantially in the Z axis direction with respect to the exterior casing 101, the positions of the left-eye optical image QL1 and the right-eye optical image QR1 in the vertical direction can be adjusted with respect to the CMOS image sensor 110, and the capture range of the stereo image in the vertical direction can be adjusted to the specified design position, by moving the main body frame 2 in the Z axis direction with respect to the exterior casing 101.

Also, since the left-eye optical image QL1 and the right-eye optical image QR1 are disposed inside the exterior casing 101, it is easier to obtain a compact 3D adapter 100.

With the above configuration, it is possible to provide a 3D adapter 100 that is more compact and with which the effect that individual differences between products have on a stereo image can be reduced.

Modification Examples from the Viewpoint of Features (5)

Modification examples of the above embodiment that are conceivable from the viewpoint of the Features (5) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD (charge coupled device) image sensor, for instance.

(B) In the above embodiment, the third adjusting mechanism 5 was described as an example of a main body frame adjusting mechanism, but the main body frame adjusting mechanism is not limited to the above embodiment. As long as the capture range of the stereo image in the vertical direction can be adjusted, the main body frame adjusting mechanism may have some other configuration.

For example, in the above embodiment, the main body frame 2 was rotated around the rotational axis R4 by the first elastic support 51L and the second elastic support 51R, but the main body frame 2 may be rotatably linked to the exterior casing 101 by a rotary shaft.

Modification Examples from the Viewpoint of Features (6)

With this 3D adapter 100, since the main body frame 2 that supports the left-eye optical image QL1 and the right-eye optical image QR1 is disposed movably substantially in the X axis direction with respect to the exterior casing 101, the positions of the left-eye optical image QL1 and the right-eye optical image QR1 in the horizontal direction can be adjusted with respect to the CMOS image sensor 110, and the capture range of the stereo image in the horizontal direction can be adjusted to the specified design position, by moving the main body frame 2 in the X axis direction with respect to the exterior casing 101.

Also, since the left-eye optical image QL1 and the right-eye optical image QR1 are disposed inside the exterior casing 101, it is easier to obtain a compact 3D adapter 100.

With the above configuration, it is possible to provide a 3D adapter 100 that is more compact and with which the effect that individual differences between products have on a stereo image can be reduced.

Modification Examples from the Viewpoint of Features (6)

Modification examples of the above embodiment that are conceivable from the viewpoint of the Features (6) mentioned above are compiled below.

(A) In the above embodiment, the 3D adapter 100 was described as an example of a lens unit, but the lens unit is not limited to the 3D adapter 100. The lens unit may, for example, be an interchangeable lens unit used in a single-lens camera.

Also, the video camera 200 was described as an example of an imaging device, but the imaging device is not limited to the video camera 200. The imaging device may be a device that is capable of capturing only still pictures, or a device that is capable of capturing only moving pictures.

The imaging element may be any element with which light can be converted into an electrical signal. Possible imaging elements other than the CMOS image sensor 110 include a CCD (charge coupled device) image sensor, for instance.

(B) In the above embodiment, the third adjusting mechanism 5 was described as an example of a main body frame adjusting mechanism, but the main body frame adjusting mechanism is not limited to the above embodiment. As long as the capture range of the stereo image in the horizontal direction can be adjusted, the main body frame adjusting mechanism may have some other configuration.

### INDUSTRIAL APPLICABILITY

The technology discussed above can be applied to lens units and imaging devices.

### REFERENCE SIGNS LIST

1 video camera unit
2 main body frame (an example of a main body frame)
3 first adjusting mechanism (an example of a relative offset adjustment frame)
30 first adjustment frame (an example of a relative offset adjustment frame)
31 first rotary shaft (an example of a rotary support shaft)
37 first restricting mechanism (an example of a rotation restricting mechanism)
38 adjustment spring (an example of an adjustment elastic member, and an example of an elastic pressing member)
4 second adjusting mechanism (an example of a convergence angle adjusting mechanism)
40 second adjustment frame (an example of a convergence angle adjusting frame, and an example of a focus adjustment frame)
41 second rotary shaft (an example of an adjusting rotary shaft, and an example of a guide shaft)
44 focus adjusting spring (an example of a pressing member)
47 second restricting mechanism (an example of a positioning mechanism)
5 third adjusting mechanism (an example of a main body frame adjusting mechanism, and an example of a position adjusting mechanism)
57 vertical position adjustment dial (an example of a position manipulation member)
59A elastic linking mechanism (an example of an elastic linking mechanism)
59B first movement restricting mechanism (an example of a first movement restricting mechanism)
59C second movement restricting mechanism (an example of a second movement restricting mechanism)
6 manipulation mechanism
61 relative offset adjustment dial (an example of a relative offset manipulation member)
62 horizontal position adjustment dial (an example of a position manipulation member)
63 support frame
64 first joint shaft (an example of a relative offset manipulation transmission component)
65 second joint shaft (an example of a position manipulation transmission component)
100 3D adapter (an example of a lens unit)
101 exterior casing (an example of a housing)
200 video camera (an example of an imaging device)
OL left-eye optical system (an example of a first optical system or a second optical system)
OR right-eye optical system (an example of a first optical system or a second optical system)
AL left-eye optical axis (an example of a first optical axis or a second optical axis)
AR right-eye optical axis (an example of a first optical axis or a second optical axis)
QL1 left-eye optical image (an example of a first optical image or a second optical image)
QR1 right-eye optical image (an example of a first optical image or a second optical image)

G1L left-eye negative lens group (an example of a relative offset adjusting optical system)

G2L left-eye positive lens group (an example of a first positive lens group or a second positive lens group)

G3L left-eye prism group (an example of a first prism group or a second prism group)

G1R right-eye negative lens group (an example of a convergence angle adjusting optical system, and an example of a focus adjusting optical system)
G2R right-eye positive lens group (an example of a first positive lens group or a second positive lens group)

G3R right-eye prism group (an example of a first prism group or a second prism group)

R1 first rotational axis

R2 second rotational axis

R3 rotational axis (an example of an optical system rotational axis)
R4 rotational axis (an example of a main body rotational axis)

V optical system

1. A lens unit for guiding light to an imaging element of an imaging device, said lens unit comprising:
a first optical system that is used to form a first optical image seen from a first viewpoint, and that has a first optical axis;
a second optical system that is used to form a second optical image seen from a second viewpoint that is different from the first viewpoint, and that has a second optical axis;
a support unit that has a housing that can be mounted to the imaging device, and a main body frame that is disposed inside the housing and supports the first and second optical systems; and
a position adjusting mechanism for adjusting the vertical and/or horizontal direction of the first and second optical images with respect to the imaging element by adjusting the position and/or the orientation of the main body frame with respect to the housing from outside the support unit.

2. (canceled)

3. (canceled)

4. (canceled)

5. (canceled)

6. (canceled)

7. (canceled)

8. (canceled)

9. The lens unit according to claim 1,
wherein the position adjusting mechanism has a position manipulation member that is manipulated by the user, and a position manipulation transmission component that transmits movement of the position manipulation member to the main body frame.

10. A lens unit, comprising:
a first optical system that is used to form a first optical image seen from a first viewpoint, and that has a first optical axis;
a second optical system that is used to form a second optical image seen from a second viewpoint that is different from the first viewpoint, and that has a second optical axis; and
a support unit that accommodates the first and second optical systems; and
a relative offset adjusting mechanism that moves a relative offset adjusting optical system, which is provided to the first optical axis, substantially in a first direction with respect to the support unit,
wherein
the first direction is perpendicular to a reference plane that is substantially parallel to the first and second optical axes in a state in which the first and second optical axes are intersecting, and
the relative offset adjusting mechanism includes:
a relative offset adjustment frame to which the relative offset adjusting optical system is fixed and which is supported by the support unit movably in substantially the first direction, and a rotary support shaft that rotatably links the relative offset adjustment frame to the support unit.

11. (canceled)

12. (canceled)

13. (canceled)

14. The lens unit according to claim 10,
wherein the first optical system is disposed between the second optical system and the rotary support shaft.

15. The lens unit according to claim 10,
wherein the relative offset adjusting mechanism has an adjustment elastic member that imparts to the relative offset adjustment frame a rotational force around the rotary support shaft, and a rotation restricting mechanism that restricts the rotation of the relative offset adjustment frame and adjusts the position of the relative offset adjusting optical system with respect to the support unit by changing the restriction position of the relative offset adjustment frame.

16. (canceled)

17. The lens unit according to any of claims 10,
wherein the support unit has a housing and a main body frame that supports the first and second optical systems and is disposed inside the housing and movably in the first direction with respect to the housing.

18. The lens unit according to claim 17,
further comprising a main body frame adjusting mechanism that moves the main body frame substantially in the first direction with respect to the housing.

19. The lens unit according to claim 18,
wherein the main body frame adjusting mechanism has a first elastic linking mechanism that imparts a force in the first direction to the main body frame, and a first movement restricting mechanism that restricts movement of the main body frame in the first direction with respect to the housing and adjusts the position of the main body frame with respect to the housing by changing the restriction position of the main body frame.

20. The lens unit according to claim 19,
wherein the first elastic linking mechanism links the main body frame to the housing rotatably around a main body rotational axis that is substantially parallel to a second direction, and
the second direction is substantially perpendicular to the first direction and the first optical axis.

21. A lens unit, comprising:
a first optical system that is used to form a first optical image seen from a first viewpoint, and that has a first optical axis;
a second optical system that is used to form a second optical image seen from a second viewpoint that is different from the first viewpoint, and that has a second optical axis; and
a support unit that accommodates the first and second optical systems; and
a convergence angle adjusting mechanism that moves a convergence angle adjusting optical system, which is provided to the second optical system, substantially in a first adjustment direction with respect to the support unit,
wherein
the first adjustment direction is substantially perpendicular to the second optical axis and parallel to a reference plane that is substantially parallel to the first and second optical axes in a state in which the first and second optical axes are intersecting, and
the convergence angle adjusting mechanism includes:
a convergence angle adjustment frame to which the convergence angle adjusting optical system is fixed and which is supported by the support unit movably in substantially the first adjustment direction, and an adjusting rotary shaft that links the convergence angle adjustment frame rotatably to the support unit.

22. (canceled)

23. (canceled)

24. (canceled)

25. The lens unit according to claim 21,
wherein the convergence angle adjusting mechanism has an elastic pressing member that imparts to the convergence angle adjustment frame a rotational force around the adjusting rotary shaft, and a positioning mechanism that restricts the rotation of the convergence angle adjustment frame and adjusts the position of the convergence angle adjusting optical system with respect to the support unit by changing the restriction position of the convergence angle adjustment frame.

26. The lens unit according to any of claims 21,
wherein the support unit has a housing and a main body frame that supports the first and second optical systems and is disposed inside the housing and movably in the first adjustment direction with respect to the housing.

27. The lens unit according to claim 26,
further comprising a main body frame adjusting mechanism that moves the main body frame substantially in the first adjustment direction with respect to the housing.

28. The lens unit according to claim 27,
wherein the main body frame adjusting mechanism has an elastic linking mechanism that imparts a force in the first adjustment direction to the main body frame, and a second movement restricting mechanism that restricts movement of the main body frame in the first adjustment direction with respect to the housing and adjusts the position of the main body frame with respect to the housing by changing the restriction position of the main body frame.

29. The lens unit according to claim 28,
wherein the elastic linking mechanism links the main body frame to the housing rotatably around an optical system rotational axis that is substantially perpendicular to the reference plane.

30. The lens unit according to any of claims 21,
further comprising a focus adjusting mechanism that moves the focus adjusting optical system in the focus adjustment direction with respect to the support unit,
wherein the second optical system has a focus adjusting optical system disposed movably with respect to the support unit in a focus adjustment direction that is substantially parallel to the second optical axis, and
the focus adjusting mechanism has:
a focus adjustment frame to which the focus adjusting optical system is fixed and which is supported by the support unit and movably in the focus adjustment direction, and a guide shaft that links the focus adjustment frame movably with respect to the support unit in the focus adjustment direction.

31. (canceled)

32. (canceled)

33. (canceled)

34. The lens unit according to claim 30,
wherein the focus adjusting mechanism has a pressing member that imparts a force in the focus adjustment direction to the focus adjustment frame, and a position adjusting mechanism that restricts movement of the focus adjustment frame and adjusts the position of the focus adjustment frame with respect to the support unit by changing the restriction position of the focus adjustment frame.

35. (canceled)

36. A lens unit, comprising:
a first optical system that is used to form a first optical image seen from a first viewpoint, and that has a first optical axis;
a second optical system that is used to form a second optical image seen from a second viewpoint that is different from the first viewpoint, and that has a second optical axis; and
a support unit that accommodates the first and second optical systems; and
a focus adjusting mechanism that moves a focus adjusting optical system provided to the second optical system with respect to the support unit in a focus adjustment direction that is substantially parallel to the second optical axis,
wherein the focus adjusting mechanism includes:
a focus adjustment frame to which the focus adjusting optical system is fixed and which is supported by the support unit and movably in the focus adjustment direction, and a guide shaft that links the focus adjustment frame movably with respect to the support unit in the focus adjustment direction.

37. (canceled)

38. (canceled)

39. (canceled)

40. The lens unit according to claim 36,
wherein the focus adjusting mechanism has a pressing member that imparts a force in the focus adjustment direction to the focus adjustment frame, and a focus position adjusting mechanism that restricts movement of the focus adjustment frame and adjusts the position of the focus adjustment frame with respect to the support unit by changing the restriction position of the focus adjustment frame.

41. (canceled)

42. A lens unit, comprising:
a housing;
a first optical system that is used to form a first optical image seen from a first viewpoint, and that has a first optical axis and is disposed inside the housing;
a second optical system that is used to form a second optical image seen from a second viewpoint that is different from the first viewpoint, and that has a second optical axis and is disposed inside the housing; and
a main body frame that supports the first optical system and the second optical system and that is disposed inside the housing and movably substantially in a first direction with respect to the housing,
wherein the first direction is perpendicular to a reference plane that is substantially parallel to the first and second optical axes.

43. The lens unit according to claim 42,
further comprising a main body frame adjusting mechanism that moves the main body frame substantially in the first direction with respect to the housing.

44. The lens unit according to claim 43,
wherein the main body frame adjusting mechanism has a first elastic linking mechanism that imparts a force in the first direction to the main body frame, and a first movement restricting mechanism that restricts movement of the main body frame in the first direction with respect to the housing and adjusts the position of the main body frame with respect to the housing by changing the restriction position of the main body frame.

45. The lens unit according to claim 44,
wherein the first elastic linking mechanism links the main body frame to the housing rotatably around a main body rotational axis that is substantially parallel to a second direction, and
the second direction is substantially perpendicular to the first direction and the first optical axis.

46. The lens unit according to claim 45,
wherein the main body frame adjusting mechanism moves the main body frame substantially in the second direction with respect to the housing.

47. The lens unit according to claim 46,
wherein the main body frame adjusting mechanism has a second elastic linking mechanism that imparts a force in the second direction to the main body frame, and a second movement restricting mechanism that restricts movement of the main body frame in the second direction with respect to the housing and adjusts the position of the main body frame with respect to the housing by changing the restriction position of the main body frame.

48. The lens unit according to claim 47,
wherein the second elastic linking mechanism links the main body frame to the housing rotatably around an optical system rotational axis that is substantially parallel to the first direction.

49. A lens unit, comprising:
a housing;
a first optical system that is used to form a first optical image seen from a first viewpoint, and that has a first optical axis and is disposed inside the housing;
a second optical system that is used to form a second optical image seen from a second viewpoint that is different from the first viewpoint, and that has a second optical axis and is disposed inside the housing; and
a main body frame that supports the first optical system and the second optical system and that is disposed inside the housing and movably substantially in a first adjustment direction with respect to the housing,
wherein the first adjustment direction is perpendicular to the second optical axis and parallel to a reference plane that is substantially parallel to the first and second optical axes in a state in which the first and second optical axes are intersecting.

50. The lens unit according to claim 49,
further comprising a main body frame adjusting mechanism that moves the main body frame substantially in the first adjustment direction with respect to the housing.

51. The lens unit according to claim 50,
wherein the main body frame adjusting mechanism has an elastic linking mechanism that imparts a force in the first adjustment direction to the main body frame, and a movement restricting mechanism that restricts movement of the main body frame in the first adjustment direction with respect to the housing and adjusts the position of the main body frame with respect to the housing by changing the restriction position of the main body frame.

52. The lens unit according to claim 51,
wherein the elastic linking mechanism links the main body frame to the housing rotatably around an optical system rotational axis that is substantially perpendicular to the reference plane.
